(19) United States
(12) Patent Application Publication
(10) Pub. No.: US 2015/0112705 A1
(43) Pub. Date: Apr. 23, 2015

(54) DYNAMIC ANALYSIS AND DYNAMIC SCREENING

(71) Applicant: SOAR BIODYNAMICS, LTD., Incline Village, NV (US)

(72) Inventor: Thomas NEVILLE, Incline Village, NV (US)

(21) Appl. No.: 14/516,722

(22) Filed: Oct. 17, 2014

Related U.S. Application Data
(60) Provisional application No. 61/892,868, filed on Oct. 18, 2013.

(51) Int. Cl. G06F 19/00

(52) U.S. Cl. CPC G06F 19/3431; G06F 19/345
USPC 705/2

(57) ABSTRACT

Systems and methods for screening and monitoring of cancer, such as prostate cancer, are described. These systems and methods are suitable for selecting appropriate medical actions for screening, diagnosis, or treatment of prostate cancer and for interpreting the results of those medical actions.

### CROSS-REFERENCE

This application claims the benefit of U.S. Provisional Application No. 61/892,868 (Attorney Docket No. 35716-713.101), filed Oct. 18, 2013 and entitled “Dynamic Analysis and Dynamic Screening,” which application is incorporated herein by reference.

### BACKGROUND

Prostate cancer screening using the prostate-specific antigen (PSA) biomarker is controversial. The current practice of comparing a single PSA test value to a threshold, such as 3 or 4, can lead to excessive numbers of biopsies and treatment. The risk of side effects from treatment such as surgical removal of the prostate can be serious, with impotence and incontinence possible. The U.S. Preventative Services Task Force has recommended not using PSA screening for prostate cancer because they believe the harm from unwarranted biopsies and over-treatment is not justified by the number of lives saved from early detection.

### SUMMARY

The present disclosure provides methods for one or more of identifying the most deadly cancers, for identifying cancers early for more effective treatment, or for reducing the harmful effects of screening practices. Methods disclosed herein may be applicable and useful for one or more of Active Monitoring or Active Screening through the crucial decision to biopsy, then for Active Surveillance through treatment for men with diagnosed cancer who choose monitoring over immediate treatment, or then for Active Monitoring for men who choose focal therapies that treat only the tumor and leave most of the prostate unharmed in order to reduce side effects. The benefits of the methods disclosed herein can be substantial. For example, our simulations suggest that widespread adoption of the methods disclosed herein for the medical condition of prostate cancer could reduce by 90% the number of prostate biopsies that do not find cancer; reduce by 50% the numbers of deaths from prostate cancer, reduce by 50% the amount of treatment given for prostate cancer, and provide health care savings of more than $6 billion a year in the U.S. alone, and more than $12 billion globally.

An aspect of the present disclosure provides a method for treating cancer. A risk for a patient, such as a risk for cancer (typically but not limited to prostate cancer), may be calculated in response the patient's patient information. A cost of performing one or more medical actions may be determined in response to the calculated risk. A benefit of performing the medical action(s) may be determined. The determined cost and the determined benefit may be compared. And, the medical action(s) or a wait period may be recommended in response to the comparison. The risk for cancer may be calculated by obtaining a series of test result values for the patient in response to a plurality of first tests and calculating one or more fitted result trends in response to the obtained series. One or more of the cost or benefit of performing the one or medical actions may be determined in response to the calculated fitted test result.

The one or more fitted test result trends may be calculated from the obtained series in many ways. For example, a first fitted result trend may be calculated in response to the obtained series, one or more test result values may be removed from the series of test result values to form a second series of test results values, and a second fitted result trend may be calculated in response to the second series. The removed test result value(s) may be selected in response to a variance from the first fitted result of the test result values. Alternatively or in combination, the removed test result value(s) may be selected in response to results of one or more second tests. The second test(s) may be different in type from the plurality of first tests.

The plurality of first and/or second test results may be selected from one or more of a biomarker test, a PSA test, an fPSA test, a pPSA test, a proPSA test, a tPSA test, a PAA test, a PSAV test, an EPCA test, an EPCA-2 test, an AMACR test, a methylated GSTP1 test, an imaging test or scan, an MRI scan, a CAT scan, an infrared image, an ultrasound image, a molecular image, a genetic test, a cell count, a protein test, a nucleic acid test, a prostate size measurement, a prostate volume measurement, a digital prostate exam, a biopsy, a tumor variable measurement, or a tumor volume measurement.

The cost of performing the medical action(s) may be determined in response to the calculated risk by determining a present cost of presently performing the medical action(s). The benefit of performing the medical action(s) may be determined in response to the calculated risk by determining a present benefit of presently performing the medical action(s). The fitted test value trend may be projected through the wait period and a characteristic of the projected trend may be calculated. The cost of performing the medical action(s) may be determined in response to the calculated risk by determining in response to the calculated characteristic a future cost of performing the medical action(s) and comparing the present cost with the future cost. And, the benefit of performing the medical action(s) may be determined in response the calculated risk by determining a future benefit of performing the medical action(s) in response to the calculated characteristic and comparing the present benefit with the future benefit.

The medical action(s) or the wait period may be recommended in response to the comparison by one or more of recommending the one or more medical actions if the present cost is less than the future cost in comparison, or recommending the one or more medical actions if the present benefit is more than the future benefit in comparison. The medical action(s) or the wait period may be recommended in response to the comparison by one or more of recommending the wait period if the present cost is more than the future cost in comparison, or recommending the wait period if the present benefit is less than the future benefit in comparison. The wait period may be selected from the group consisting of: 1 month, 2 months, 3 months, 6 months, 9 months, 12 months, 18 months, and 24 months.

The medical action(s) may comprise one or more of a prostate size measurement, a prostate volume measurement, digital prostate exam, biopsy, focal treatment, surgery, radiation therapy, hormone therapy, or chemotherapy. Once recommended, the recommended medical action(s) may be performed to treat the patient.

The cost of performing the medical action(s) may comprise one or more of decreased life expectancy decreased financial outcome, increased death risk, increased cancer or cancer treatment side effects, metastasis of cancer, recurrence of cancer, lost time, or side effects of the one or more medical actions. The benefit of performing the medical action(s) may comprise one or more of increased life expectancy, increased financial outcome, decreased death risk, decreased cancer or cancer treatment side effects, non-metastasis of cancer, non-recurrence of cancer, gained time, or lack of side effects from the one or more medical actions. The comparison between the determined cost and determined benefit may be adjusted for a rate of progression of the cancer.

The medical action(s) may be recommended by providing the recommendation in an electronic format. The recommendation in the electronic format may be displayed.

Another aspect of the disclosure provides a method of treating cancer. A patient may be screened for cancer. One or more medical actions may be selected in response to the screening. The selected medical action(s) may be performed. One or more results of the performed medical action(s) may be obtained. The obtained one or more results may be analyzed in response to one or more of personal information, personal history, or personal preferences of the patient. These steps may be repeated as needed in response to the analysis. The analysis may comprise one or more of calculating one or more of life expectancy changes, cancer death risk, cancer side effect risk, or financial outcome changes, performing a cost-benefit analysis of performing one or more medical actions, or recommending one or more medical actions or a wait period in response to the calculation or the performed cost-benefit analysis.

Another aspect of the disclosure provides a method for treating cancer. Data relating to one or more of personal information, personal history, personal risk preference, or prior medical actions taken of a patient may be obtained. A plurality of life scenarios and corresponding probabilities may be generated in response to the obtained data. The generated plurality of life scenarios may be aggregated to generate a cost-benefit analysis. A course of action may be recommended in response to a generated cost-benefit analysis.

Further aspects of the disclosure provide systems for treating cancer such as by performing one or more of the steps, elements, or instructions of the methods described above. Such systems may comprise a processor and machine readable media embodying instructions for the processor to perform one or more of the steps, elements, or instructions described above.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 is a table of cancer categories, in accordance with many embodiments.

FIG. 2 is a graph of PSA history of a man who has died from prostate cancer which showed a strong PSA signal, in accordance with many embodiments.

FIG. 3A is a graph of PSA for a fast growing cancer, in accordance with many embodiments.

FIG. 3B is a graph of PSA for a slow growing cancer, in accordance with many embodiments.

FIG. 4 is a flow chart of a method of screening, monitoring, and treatment for one or more medical actions, in accordance with many embodiments.

FIG. 5 is a flow chart of a method for performing cost-benefit analysis in regards to one or more medical actions, in accordance with many embodiments.

FIG. 6 is a flow chart of a method for performing cost-benefit analysis to decide whether to perform an immediate biopsy or performing Active Monitoring for a year, in accordance with many embodiments.

FIG. 7A is a graph of cancer specific death risks for different PSAgr ranges as a function of PSAc, in accordance with many embodiments.

FIG. 7B is a graph of a cancer-specific death function of years after diagnosis, in accordance with many embodiments.

FIG. 8 is a chart of many factors that affect cost-benefit analysis to decide whether to perform an immediate biopsy or performing Active Monitoring for a year, in accordance with many embodiments.

FIG. 9 is a chart of factors that affect cost-benefit to decide whether to perform an immediate treatment or performing Active Monitoring for a year, in accordance with many embodiments.

FIG. 10A is a graph of the diluted risk of cancer death for a number of years after immediate biopsy and treatment, in accordance with many embodiments.

FIG. 10B is a graph of the diluted risk of cancer death for a number of years after a first initial year of Active Monitoring instead of biopsy and treatment as in FIG. 10A, in accordance with many embodiments.

FIG. 10C is graph of the cost in terms of death risk of implementing a first initial year of Active Monitoring instead of performing an immediate biopsy and treatment, in accordance with many embodiments.

FIG. 11 is a graph of prostate volume measurements and possible corresponding PSA levels in the case of prostate enlargement, in accordance with many embodiments.

FIG. 12A shows key elements of a PSA trend and projections, in accordance with many embodiments.

FIG. 12B shows a flat PSA trend when cancer is not present, in accordance with many embodiments.

FIG. 12C shows a relationship between PSA in a prostate without cancer and prostate volume, in accordance with many embodiments.

FIG. 12D shows an increasing PSA trend without cancer, in accordance with many embodiments.

FIG. 12E shows a typical PSA trend by progressing cancer and the trend's calculated projection, in accordance with many embodiments.

FIG. 12F shows a typical annual rate of change in PSA or PSA Velocity (PSAV), in accordance with many embodiments.

FIG. 12G shows a best-fit PSA trend for a “perfect” set of PSA tests, in accordance with many embodiments.

FIG. 12H shows a fitted trend generated from a hypothetical set of PSA test results, in accordance with many embodiments.

FIG. 12I shows a PSA trend consistent with an anomalously high previous PSA test results, in accordance with many embodiments.

FIG. 12J shows a PSA trend and the trend's calculated projection, in accordance with many embodiments, in accordance with many embodiments.

FIG. 12K shows a PSA trend having variability, in accordance with many embodiments.

FIG. 12L shows graphs of PSA trend projections including drops and jumps from a trend, in accordance with many embodiments.

FIG. 12M shows a graph of a consistent PSA trend and corresponding graph of PSAgr over time, in accordance with many embodiments.

FIG. 12N shows a graph of a consistent PSA trend followed by a decrease in PSA below the projected trend and a corresponding graph of PSAgr over time, in accordance with many embodiments.

FIG. 12O shows a graph of an exponentially growing PSA trend followed by a jump in PSA above the projected trend and a corresponding graph of PSAgr over time, in accordance with many embodiments.

FIG. 13 shows a model of a cancerous tumor and the prostate organ, in accordance with many embodiments.

FIG. 14 shows a schematic of various inputs applied to generate the model of FIG. 14, in accordance with many embodiments.

FIG. 15A shows a graph of estimated tumor volume, in accordance with many embodiments.

FIG. 15B shows a graph of estimated tumor margin, in accordance with many embodiments.

FIG. 16 shows graphs of exemplary PSA trends in response to Differential Treatment, in accordance with many embodiments.

FIG. 17 shows graphs of exemplary PSA trends of a high risk patient with high PSAgr compared to a low risk patient with lower PSAgr, in accordance with many embodiments.

FIG. 18 shows graphs of exemplary PSA trends and the timing of a variety of possible medical actions, in accordance with many embodiments.

FIG. 19 shows an exemplary chart of a cost-benefit analysis, in accordance with many embodiments.

FIG. 20A is an exemplary graph of a cancer-specific death rate for high and lower PSAgr as a function of PSA, in accordance with many embodiments.

FIG. 20B is another exemplary graph of a cancer-specific death rate for high and lower PSAgr as a function of PSA, in accordance with many embodiments.

FIG. 21 is an exemplary graph of a cancer-specific death rate as a function of time referenced in terms of years from now, in accordance with many embodiments.

FIG. 22A is an exemplary graph of an increase in cancer-specific death rate for high and lower PSAgr as a function of PSA, in accordance with many embodiments.

FIG. 22B is another exemplary graph of an increase in cancer-specific death rate for high and lower PSAgr as a function of PSA, in accordance with many embodiments.

FIG. 23 shows a chart of PSA thresholds for various risk groups, in accordance with many embodiments.

FIG. 24 shows a graph of the cumulative probability of differential deceleration for biopsy PSA ranges as a function of the amount of differential deceleration (DD %), in accordance with many embodiments.

FIG. 25 shows a graph of sensitivity and specificity for an exemplary PSA screening, in accordance with many embodiments.

FIG. 26 shows a graph of an exemplary estimated PSA trends, in accordance with many embodiments.

FIG. 27 shows graphs of exemplary probabilities of being alive or dead without prostate cancer and in response to prostate cancer with or without treatment, in accordance with many embodiments.

FIG. 28 shows a table of treatment scenarios and life expectancies, in accordance with many embodiments.

FIG. 29 shows another table of treatment scenarios and life expectancies, in accordance with many embodiments.

FIG. 30 shows various charts for treatment scenarios and life expectancies, in accordance with many embodiments.

FIG. 31 shows a chart for various treatment scenarios and life expectancy, in accordance with many embodiments.

FIG. 32 shows an exemplary chart and a table for life expectancies in response to no cancer, immediate treatment, and cancer with no treatment, in accordance with many embodiments.

FIG. 33 shows an exemplary chart and a table for risk of death in response to no cancer, immediate treatment, and cancer with no treatment, in accordance with many embodiments.

FIG. 34 shows an exemplary method of generating a personalized prostate cancer decision report, in accordance with many embodiments.

FIG. 35 shows another exemplary method of generating a personalized prostate cancer decision report, in accordance with many embodiments.

FIG. 36A shows an exemplary graph of cancer tempo as it relates to PSA growth rate for an exemplary subject, in accordance with many embodiments.

FIG. 36B shows an exemplary graph of prostate cancer death risk projected and estimated over a period of time for the exemplary subject of FIG. 36A, in accordance with many embodiments.

FIG. 37 shows an exemplary graph of prostate cancer death risk projected and estimated over a period of time for an exemplary subject different than that of FIG. 36A, in accordance with many embodiments.

FIG. 38 shows an exemplary flowchart of a computer-implemented process of synthesizing MRI analysis with PSA trends, in accordance with many embodiments.

FIG. 39 shows an exemplary flowchart of a computer-implemented process of synthesizing MRI analysis with PSA trends, in accordance with many embodiments.

FIG. 39A shows exemplary PSA trends for a population of subjects, in accordance with many embodiments.

FIG. 39B shows a chart of organ-cancer death risk estimated from PSA from cancer, in accordance with many embodiments.

FIG. 39C shows a chart of conditional death risk gradient estimated from PSA from cancer, in accordance with many embodiments.

### DETAILED DESCRIPTION

The methods and systems described herein can be used for applications including but not limited to detection, diagnosis, analysis, screening, prognosis for various types of cancers and other medical conditions, and for the analysis and suggestion of medical actions. The methods and systems described herein can be used for a variety of cancers and conditions in patients, particularly cancers for which quantitative tests may be available. In a preferred embodiment, the disclosed methods and systems are used for prostate cancer. In some embodiments, the methods and systems described herein can be used to detect, diagnose, analyze, screen, or prognose a cancer or other medical condition based on a time series of test results. In some embodiments, those test results can be biomarker values. For example, such biomarkers may include PSA, free PSA (fPSA), tPSA, PAP, proPSA, PSAV, PSADT, EPCA, EPCA-2, AMACR, methylated GSTP1, and the like. In some embodiments, those test results can be the results of imaging or imaging tests, including MRI, CAT scans, infrared imaging, ultrasound imaging, and molecular imaging. In some embodiments, the test results can be the results of genetic tests, cell counting, protein tests, nucleic acid tests, and the like. In some embodiments, the test results can be the result of prostate measurements, including but not limited to prostate imaging, prostate volume measurements; digital prostate exams, biopsies, tumor volume measurements, other tumor variables, and the like. In some embodiments, the costs and benefits of possible medical actions are analyzed. In some embodiments, analysis results are compared to population data, where population data can refer to raw population data, processed or analyzed population data, synthetic population data that may be adjusted in some way, combined population data that integrates data from more than one population, and simulated population data using Monte Carlo or other simulation methods.

### I. Prostate Cancer

Doctors often implicitly use reference frames for prostate cancer that may be useful for the cancer stage and decisions they may be dealing with. For Dynamic Screening, we have found it can be useful to define a biomarker reference frame to categorize prostate cancer that differs from the conventional medical reference frames used by most doctors.

For example, medical reference frames can be used to categorize prostate cancer based on the information available to the doctor and the decisions being considered. For example, a biopsy reference frame may include Gleason Score and clinical stage. It increasingly may be supplemented using a genetic reference frame. Alternatively or in combination, a metastatic reference frame can be used to categorize metastatic prostate cancer.

In contrast, a biomarker reference frame may be appropriate for prostate cancer screening that primarily depends on biomarkers such as PSA. We find it useful to categorize prostate cancer based on the PSA it produces because PSA can be measured prior to a biopsy and/or treatment.

A. Biomarker Reference Frame

There will typically be four cancer types in the Biomarker Reference Frame: No Cancer, Silent (Signal) Cancer, Weak (Signal) Cancer (Undetected and Detected) and Strong (Signal) Cancer.

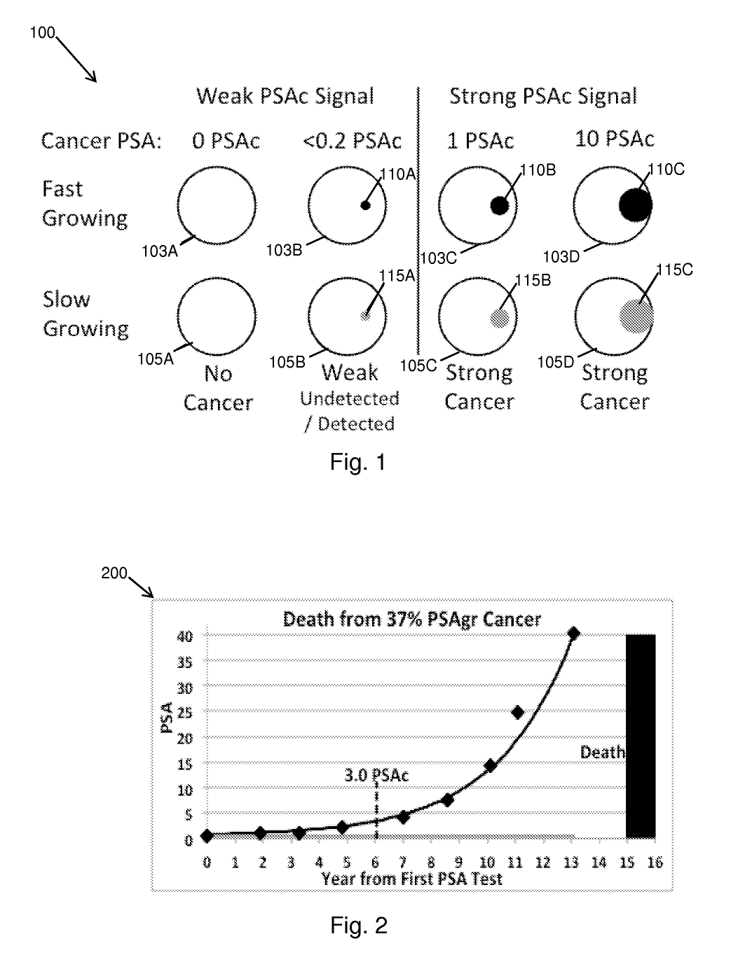

FIG. 1 provides a table 100 of the No, Weak, and Strong cancer categories with each large black circle 103A, 103B, 103C, 103D, 105A, 105B, 105C, and 105D representing a prostate and the smaller shaded circles 110A, 110B, 110C, 115A, 115B, and 115C representing cancer. The left pair of circles 103A, 105A are empty to show no cancer in the prostate. The second pair of circles 103B, 104B show small, often indolent, cancers that produce little PSA and that we label Weak (Signal) Cancers where “weak” refers to the PSA signal. We use the language: Weak PSAc signal (<0.2 PSAc), where PSAc is the term for PSA produced by progressing cancer. The third pair of circles 103C, 105C shows Strong (Signal) Cancers that produce a strong PSAc signal of 1. The third pair of circles 103C, 105C shows Strong Cancers that produce a strong PSAc signal of 1. The fourth pair of circles 103D, 105D shows Strong Cancers that produce a very strong PSAc signal of 10. The top row of circles 103A, 103B, 103C, and 103D shows fast growing cancers 110A (for circle 103B), 110B (for circle 103C), and 110C (for circle 103D) that produce fast growing PSA. The bottom row of circles 105A, 105B, 105C, and 105D shows slow growing cancers 115A (for circle 105B), 115B (for circle 105C), and 115C (for circle 105D) that produce slow growing PSA.

i. No Cancer

No Cancer means that there is no cancer in the prostate. The chance of No Cancer decreases as men get older. For example, men aged 70 may have a roughly 70% chance of cancer in their prostate and only a 30% chance of No Cancer. A biopsy that does not find cancer does not necessarily mean that No Cancer is present. A biopsy only samples a small percentage of prostate tissue and is very likely to miss most of the small prostate cancers in men. For men with No Cancer, biopsies are often triggered by a no-cancer prostate condition that elevates PSA, such as benign prostatic hyperplasia (BPH) and/or prostatitis.

ii. Silent (Signal) Cancer

Silent (Signal) Cancer is the term we use to describe the rare cancer that becomes very deadly while producing little or no PSA. It can be deadly like Strong (Signal) Cancer without the strong PSA signal. Silent Cancer differs from Weak (Signal) Cancer that produces little PSA and is small and often indolent and, therefore, seldom deadly. Silent Cancer can be unusual because it becomes deadly while producing little PSA. Based on analysis of population data, we estimate that only a very small percentage of cancers are Silent—perhaps one or two percent.

PSA methods, including Dynamic Analysis of PSA, may not in at least some cases provide early detection of Silent Cancers because there is little or no cancer PSA to help detect the cancers. Therefore, other methods may be needed to detect the small number of Silent Cancers.

iii. Weak (Signal) Cancer

The vast majority of prostate cancers are Weak (Signal) Cancers, or Weak Cancers for short, that are small, often indolent, and produce little PSA. In terms of PSA, Weak Cancers are almost identical to No Cancers. In both cases, biopsies are often triggered by elevated PSA caused by a no-cancer prostate condition, such as BPH and/or prostatitis, with very little or no PSA contributed by prostate cancer. However, for the large number of men with Weak Cancer a biopsy may be like playing “Russian roulette”. If they are lucky, Weak Cancer will remain undetected by biopsy and if they are unlucky the biopsy will detect Weak Cancer with all the consequences of a cancer diagnosis, including the risk of over-treatment.

a. Undetected Weak Cancer

Fortunately, the vast majority of Weak Cancers remain undetected, or we would have a prostate cancer epidemic with enormous amounts of over-treatment. Most men with Weak Cancers do not undergo a biopsy, and most biopsies miss Weak Cancers that fall between the biopsy needles. Of course, the more needles used for the biopsy the harder it may be for Weak Cancers to remain undetected and the worse the odds for biopsy “Russian roulette”.

b. Detected Weak Cancer

A biopsy triggered by a no-cancer condition can have some chance of inadvertently finding Weak Cancer that triggers a whole range of bad outcomes including high pressure for often unwarranted treatment and the risk of side effects. Moreover, the more thorough the biopsy (with more needles) the more likely Weak Cancers can be detected. Over-treatment of Weak Cancers inadvertently detected by biopsies triggered by PSA elevated by a no-cancer condition may very well to be the primary reason the U.S. Preventative Services Task Force recommended against PSA screening for prostate cancer.

iv. Strong (Signal) Cancer

A small minority of prostate cancers may be Strong (Signal) Cancers, or Strong Cancers for short, that produce a strong PSA signal that can be identified by either Dynamic Screening or conventional static PSA screening methods. A strong PSA signal allows Dynamic Analysis of the PSA from cancer (PSAc) and its growth rate (PSAgr), which provides valuable information about the deadliness of the cancer and its ability to be cured.

B. Strong (Signal) Cancer Insights

Extensive new research has confirmed insights about Strong (Signal) Cancer discovered on smaller populations of men, including: Baltimore Longitudinal Study of Aging, Innsbruck (Tyrol, AU) screening and treatment population and surgery (RP) data from UCSF and CaPSURE. The new research includes analysis of national U.S. Veterans Affairs population data for roughly 33 million PSA tests and 14 million men.

i. Speed Kills

FIG. 2 shows a graph 200 of PSA history typical of a man who died from Strong (Signal) Cancer of the prostate. (Source: Baltimore Longitudinal Study of Aging) Key Dynamic Analysis findings may include: 1) Smooth fast exponential growth in PSA above a no-cancer baseline is generally characteristic of Strong (Signal) Cancer; and 2) Faster exponential growth is generally characteristic of deadlier cancer. The implications include: 1) Smooth, fast exponential growth in PSA above a baseline can justify early detection at very low PSA levels for effective treatment; 2) Variable, slow growth in PSA to moderate levels may not be primarily caused by Strong (Signal) Cancer and a biopsy may not be justified; and 3) (Possibly variable) Moderate growth in PSA may justify a biopsy for some men if PSA eventually reaches relatively high levels.

A strong PSA signal allows Dynamic Analysis of the PSA from cancer (PSAc) and its growth rate (PSAgr), which provides valuable information about the deadliness of the cancer and its ability to be cured.

ii. Exponential PSA Growth Above a No Cancer Baseline

The central insight of Dynamic Analysis of PSA is that a man's PSA history may contain valuable information about what may be occurring in his prostate that can be interpreted using appropriate methods. Dynamic Analysis of PSA starts with the estimation of a consistent trend using a functional form that may vary depending on the information available and the circumstances of the man. Often the best combination of power and simplicity is an exponential plus constant functional form, as discussed in Section VI. Dynamic Analysis below.

iii. Fast Growing Strong Cancer

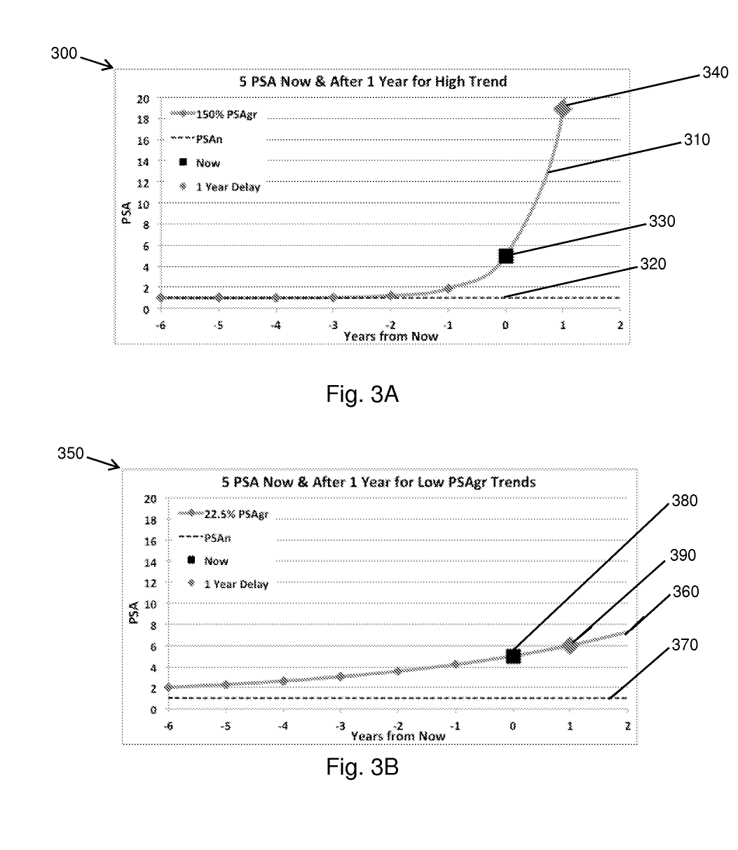

Fast growing cancer is shown at two stages on the graph 300 of FIG. 3A. Fast growth in PSA from cancer (PSAc) can be a valuable indicator of fast growth in cancer deadliness. The increasing curve 310 shows fast growing PSAc above a no-cancer baseline, shown by the flat line 320 at PSA 1.0. The square 330 shows 5 PSA now. After one year of Active Monitoring the projected trend 310 reaches a very high 19 PSA for a frightening increase of 14 PSA in one year, shown by the large diamond 340 at the right. Dynamic Screening may suggest escalating medical actions culminating in a suggestion to biopsy at a low PSA level of 2, for example.

iv. Slow Growing Strong Cancer

Slow growing cancer is shown at two stages on the graph 350 of FIG. 3B. Slow growth in PSA from cancer (PSAc) can be a valuable indicator of slow growth in cancer deadliness. The increasing curve 360 shows slow growing PSAc above a no-cancer baseline, shown by the flat line 370 at PSA 1.0. The square 380 shows 5 PSA now. After one year of Active Monitoring the projected trend reaches only 6 PSA for a small increase of 1 PSA in one year, shown by the large diamond 390 at the right. Dynamic Screening would suggest deliberate escalation in medical actions culminating in a suggestion to biopsy at a high PSA level of 9, for example.

### II. Dynamic Screening

“Dynamic Screening” as described herein is a new approach to screening for prostate cancer. It can be applicable and useful through the crucial decision to biopsy and then for Active Surveillance through treatment for men with diagnosed cancer who choose monitoring over immediate treatment. Focal therapy can include a range of new technologies that attempt to treat only the tumors and leave most of the prostate unharmed in order to reduce side effects. Methods disclosed herein can also be applicable and useful for monitoring the remaining untreated prostate after focal therapy.

Dynamic Screening and “Dynamic Analysis” are used herein as terms of art to help distinguish two important parts of the methods described herein. Dynamic Analysis comprises a subordinate component of Dynamic Screening.

Dynamic Screening refers to the overall method or system that uses the results of Dynamic Analysis and additional inputs in a process that produces output that includes a cancer prognosis, often expressed as probabilities, and suggested medical actions that might range from monitoring PSA to major actions, such as a biopsy or treatment for prostate cancer. Dynamic Screening calculates probabilities (often by comparing personal results with population results), performs a cost-benefit analysis (including for projected and what-if scenarios), and suggests next actions.

Dynamic Analysis is a series of methods for analyzing information over time that produces results that are used as inputs to Dynamic Screening (but are not the only inputs). Dynamic Analysis methods can be applied to any time series data and then can incorporate other data that may not be time series in nature. PSA is often the tip of the iceberg for Dynamic Analysis of biomarkers. Dynamic Analysis of Free PSA and other biomarkers can be considered part of our methods. For Dynamic Screening for prostate cancer, Dynamic Analysis may be applied to other variables, including: prostate volume, imaging results including molecular imaging results and biopsy pathology, perhaps using the Artemis biopsy device. Dynamic Differential Analysis may comprise a form of Dynamic Analysis designed to help determine the presence of various conditions, including cancer and prostate cancer. For example, for prostate cancer screening Differential Treatment of prostatitis with anti-inflammatory medications and antibiotics with analysis of subsequent PSA tests for deceleration in the growth rate, or even a decrease in PSA, can help determine if progressing cancer or prostatitis is the primary cause of previously increasing PSA-Strong (Signal) Cancer.

The U.S. Preventative Services Task Force (USPSTF) has recommended against prostate cancer screening that uses a single PSA test compared to a PSA threshold because, in their opinion, it does more harm than good. They believe that, for the single PSA test screening method, excessive numbers of biopsies and treatment do not justify the limited number of lives saved. They implicitly accept an increased number of U.S. prostate cancer deaths as the cost of their recommendation. In comparison, the methods and systems described herein dramatically improve the benefit-cost tradeoff of screening for many men. However, Dynamic Screening and other aspects of the disclosure may not be appropriate for men with very short life expectancies and/or with limited ability to pay for treatment, at least in part because Dynamic Screening may recommend against treatment for them in most cases.

In some embodiments, a method that can identify the most deadly cancers early is provided. In some embodiments, a method that can identify prostate cancer at low PSA levels for effective treatment is provided. In some embodiments, a method that can identify a cancer while minimizing the harm done by existing screening practice, including but not limited to over-diagnosis, side effects of diagnostic tests, and side effects of unnecessary treatment, is provided. In some embodiments, a clinical decision support system for one or more of the methods described herein is provided. Typically, the Dynamic Analysis and/or Dynamic Screening analysis are sufficiently complex that a computer or other automated processing system is required to perform the analysis.

In some embodiments, methods described herein use the results of Dynamic Analysis and additional inputs in a process that produces output that comprises a cancer prognosis, often expressed as probabilities, and/or a suggested medical action, which might range from monitoring PSA to major actions, such as a biopsy or treatment for prostate cancer. In some embodiments, Dynamic Screening calculates probabilities (often by comparing personal results with population results), performs a cost-benefit analysis (including for projected and what-if scenarios), and suggests next actions.

In some embodiments, a method comprises a first step of determining whether to screen or not to screen. If Dynamic Screening determines not to screen, the Dynamic Screening method may recommend waiting until symptoms or other indicators suggest that further action may be appropriate. In cases where the method determines that screening may be appropriate, some embodiments of the method then determine whether to Actively Monitor the patient or to perform a biopsy. In some embodiments, the method determines whether to Actively Monitor the patient or to perform a medical action other than biopsy.

A. Escalating Medical Actions

In some embodiments, the medical actions considered by the Dynamic Screening process can be in an ordered hierarchy. The hierarchy of medical actions can be arranged based on characteristics of the medical actions, including but not limited to: invasiveness of the medical action, the sensitivity or accuracy of a test (e.g. the rate of false negatives or false positives), the cost or cost-effectiveness of the medical action, whether cancer has been diagnosed in the patient, the patient's prognosis, the patient's medical history, or some combination of factors. In general, lower cost and more cost-effective medical actions will be used first and more frequently during Dynamic Screening, while higher cost or less cost-effective decisions will be used later in Dynamic Screening, when justified by the observation of a higher risk of progressing cancer. In one non-limiting example, the hierarchy of escalating medical actions may be: biomarker measurement, digital rectal exam, prostate volume measurement, Differential Treatment of non-cancer conditions, imaging including molecular imaging, biopsy, genetic profiling of a tumor, focal therapy, primary treatment (e.g. surgical prostatectomy), hormone therapy, and secondary treatment. A practitioner skilled in the art would recognize that the order of medical actions can be rearranged based on the patient and the circumstances, and that medical actions can be added to or removed from the list. For example, if cancer has been previously definitively diagnosed, in some embodiments the invention may skip earlier medical actions (e.g. Differential Treatment) in favor of medical actions that treat for cancer. In some cases, the invention as described herein may continue to recommend traditionally diagnostic tests, such as biomarker measurement, to monitor the growth, aggressiveness, or treatment of an already-diagnosed cancer.

B. Active Monitoring or Active Screening

Generally, “Active Monitoring” (or “Active Screening”) as described herein delays side effects and gathers valuable information that allows increasingly better-informed decisions. Active Monitoring describes gathering information prior to the diagnosis of a condition when it may be called “Active Screening”, after diagnosis but prior to treatment when it may be called “Active Surveillance” and after focal therapy that attempts to treat a targeted region within an organ when it may be called Active Monitoring (or Active Screening or Active Surveillance). Often, increasing risk of prostate cancer death may be a cost of Active Monitoring that should be balanced against the benefits. During Active Monitoring, Dynamic Screening may analyze and suggest a series of escalating medical actions to gather additional information. For example, during Active Monitoring, Dynamic Screening may recommend a time for a next biomarker test, such as a PSA test. The time for a next biomarker test includes but is not limited to 1 day, 1 week, 2 weeks, 3 weeks, 4 weeks, 1 month, 2 months, 3 months, 4 months, 5 months, 6 months, 7 months, 8 months, 9 months, 10 months, 11 months, 12 months, 13 months, 14 months, 15 months, 16 months, 17 months, 18 months, 19 months, 20 months, 21 months, 22 months, 23 months, or 24 months. The suggested frequency of PSA testing will generally increase if the risk of progressing cancer increases over time. Other biomarkers, such as free PSA, can provide additional information that may be valuable. In some embodiments, during Active Monitoring, Dynamic Screening may recommend a time for another medical test, including but not limited to prostate volume measurements, prostate imaging, or other medical actions as described herein.

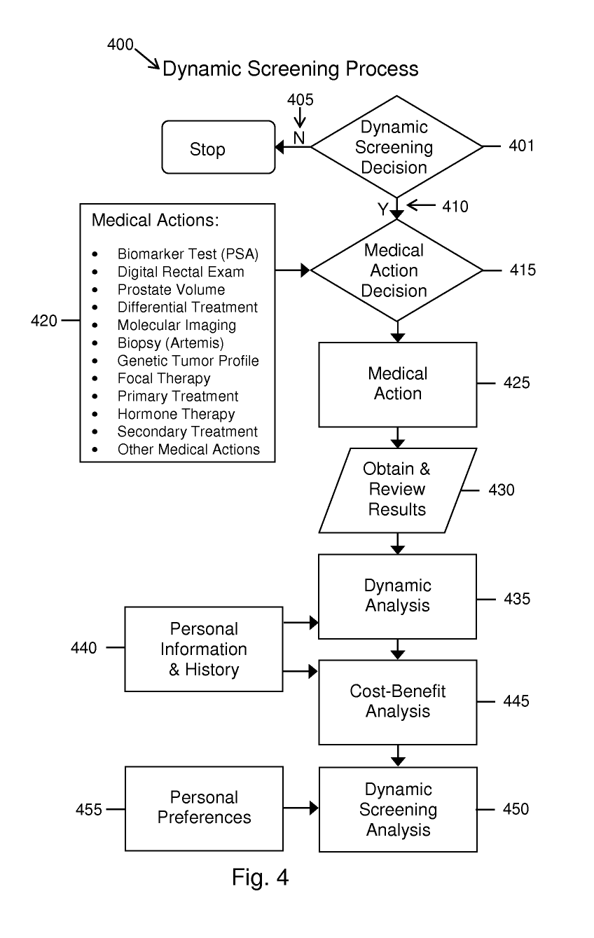

In some embodiments, the workflow of a method according to many embodiments is as described in the flow chart 400 of FIG. 4. In this nonlimiting example, the Dynamic Screening process comprises an iterative process in which a Dynamic Screening decision loop may be performed until the method determines that further Dynamic Screening decisions 401 are not required (the “N”/Stop branch 405). When the Dynamic Screening decision determines that screening is necessary (the “Y” branch 410), the process decides in a step 415 on one or more courses of medical action 420. Examples of such medical actions are further described elsewhere herein. Appropriate medical actions include but are not limited to screening, imaging and diagnostic tests, as well as treatment. Appropriate treatment includes but is not limited to treatment for the medical condition that is the target for Dynamic Screening, and treatment for a medical condition that may be related to the medical condition targeted by Dynamic Screening. Appropriate treatment can be directed at an entire organ or at the tumor growing in that organ, which may sometimes be called focal therapy. The selected medical action may then be performed in a step 425 on the patient, and the results of the medical action are obtained and reviewed in a step 430. In some embodiments, the method then performs Dynamic Analysis 435 on the results of the medical action, which may be combined with the patient's personal information and history 440. In some embodiments, the patient will have a history of results of the same medical action over time, which can be analyzed by Dynamic Analysis. Dynamic Analysis methods are described elsewhere in the specification, and also can encompass Dynamic Analysis as described in co-assigned U.S. patent application Ser. No. 11/431,119, filed May 9, 2006, Ser. No. 11/431,157, filed May 9, 2006, Ser. No. 11/431,156, filed May 9, 2006, Ser. No. 11/581,226, filed Oct. 13, 2006, Ser. No. 12/109,757, filed Apr. 25, 2008, Ser. No. 12/109,832, filed Apr. 25, 2008, Ser. No. 12/466,684, filed May 15, 2009, Ser. No. 12/645,005, filed Dec. 22, 2009, Ser. No. 13/429,641, filed May 25, 2012, Ser. No. 13/442,648, filed Apr. 9, 2012, Ser. No. 13/454,058, filed Apr. 23, 2012, and Ser. No. 13/772,527, filed Feb. 21, 2013. The results of Dynamic Analysis are then weighed by cost-benefit analysis in a step 445, which can also incorporate the patient's personal information and history. Cost-benefit analysis is described further herein. The results of the cost-benefit analysis can be subjected to further Dynamic Screening Analysis 450, which can incorporate the patient's personal preferences 455. Dynamic Screening Analysis is described further herein. The results of the Dynamic Screening Analysis may then used to determine whether further Dynamic Screening is recommended.

In some embodiments, the Dynamic Screening process can end when the Dynamic Screening process has reached a recommendation, when all possible medical actions have been performed, when all screening actions have been performed, when a user or care provider has determined that the Dynamic Screening process is sufficiently complete, or based on other factors. In one non-limiting example, the Dynamic Screening process can reach an end decision when the Dynamic Screening process has determined that further tests at that time are unnecessary. The Dynamic Screening process can recommend Active Monitoring of the patient and recommend a time for the next round of Dynamic Screening. Active Monitoring is described further herein. In some embodiments, the Dynamic Screening decision loop is performed 1, 2, 3, 4, 5, 6, 7, 8, 9, 10, 11, 12, 13, 14, 15, 16, 17, 18, 19, or 20 times. In some embodiments, the number of decision loops varies with each individual. In some embodiments, the number of decision loops varies with each performance of Dynamic Screening, including but not limited to two separate screening events for the same individual.

In some embodiments, the Dynamic Screening process can determine the rate of progression for the medical condition. In the case of cancers, some embodiments of the Dynamic Screening process can calculate the rate of growth of a tumor. In some embodiments, the Dynamic Screening process accounts for the personal characteristics, history, and/or preferences of the patient.

In some embodiments, a device or system that performs all or part of the screening process as described herein is provided. For example, a device or system may perform Dynamic Screening decisions, perform medical action decisions, review results of a medical action, perform Dynamic Analysis, perform cost-benefit analysis, and/or perform Dynamic Screening analysis. A device or system may also be configured for a user to input the results of one or more medical actions, a patient's personal information, a patient's medical or personal history, and/or a patient's personal preferences, such as the patient's risk tolerance or risk preferences. In some embodiments, a device or system comprises a database comprising the patient's prior history, including but not limited to the results of previous Dynamic Screenings. In some embodiments, a device or system comprises or is connected to a database comprising population data, including but not limited to the histories of multiple patients who have or were screened for the same medical condition.

In some embodiments, Active Monitoring is performed when no cancer is detected. In some embodiments, Active Monitoring is performed when cancer is detected. Active Monitoring of a cancer may also be referred to as “Active Surveillance” and “Active Screening.”

If cancer is detected, e.g. by biopsy, by Dynamic Analysis, or by any other method as described herein or practiced in the art, the patient may undergo Active Surveillance instead of treatment. Active Surveillance defers treatment and monitors the cancer, generally assisted by Dynamic Screening, with a full range of information available, including but not limited to follow-up imaging, follow-up biomarker tests, follow-up biopsies, preferably biopsies directed to the location of previously detected tumors (e.g. with Artemis for prostate tumors), pathology results, and even genetic evaluation of the tumors. The invention as described herein provides analysis methods suitable for deciding between Active Surveillance and treatment. Dynamic Screening can help assess the risks and benefits after incorporating all available information, including but not limited to the pathology results of a positive biopsy and evaluation of the tumor genes, if available. For example, if Dynamic Screening finds a positive biopsy with indications of a small, indolent (e.g. low Gleason) cancer, Dynamic Screening will likely recommend Active Surveillance. In some embodiments, Active Surveillance includes periodic monitoring of the cancer, e.g. through re-imaging or follow-up biopsies, as well as continuing PSA testing.

In some embodiments, Active Surveillance comprises two parts: Dynamic Analysis of biomarkers for trends that justify treatment due to an increasingly high risk of death from delaying treatment, and directed monitoring (e.g. by biopsy or imaging) of the cancer tumor. In some embodiments, Dynamic Analysis of biomarkers can help monitor the progress of cancer discovered by biopsy and any potentially faster-growing, newly mutated cancer cells. For small, indolent cancers, there can be a good chance that the cancer found, e.g. by a positive biopsy, is too small and too slow growing to ever be a threat to a patient's life. The real threat may be a cell elsewhere in the prostate or other organ that mutates into an aggressive, fast-growing cancer. In some embodiments, Dynamic Screening is designed to use biomarker, e.g. PSA, trends to catch most of these aggressive cancers early enough for effective treatment.

In some embodiments, Active Monitoring is performed in addition to treatment, for example after a prostatectomy, to detect recurrence.

Method 400 and the related steps and procedures described above, including the steps and sub-steps thereof, can be implemented by a processor or a computer system comprising a processor and a tangible medium embodying machine-readable code including instructions for performing the methods and procedures described herein.

Also, although the steps of the method 400 and the related steps and procedures are described with reference to specific embodiments herein, one skilled in the art can recognize many variations based on the teachings herein. The steps may be completed in different orders. One or more of the steps may be added or omitted. One or more of the steps may comprise one or more sub-steps. One or more of the steps may be repeated.

C. Medical Actions for Active Monitoring

Methods and systems described herein can be capable of incorporating the results of a wide variety of medical actions into a single decision process. In some embodiments, erroneous (e.g., false positive or false negative) results can be accounted for. For example, a traditional biopsy test samples only one or a few sections the target tissue. If a small, aggressive tumor is present elsewhere in the organ, the biopsy may provide a dangerous false negative. With the methods disclosed, the Dynamic Screening process may, for example, note that a biomarker for the screened cancer has been rapidly increasing over the past screenings, and recommend additional tests despite the negative biopsy.

The medical actions performed during the Dynamic Screening process are not limited to screening or diagnostic tests. Medical actions suitable for the Dynamic Screening process may also include treatment for cancer or non-cancer conditions, including but not limited to treatment for prostate cancer, infection or inflammation prostatitis, and benign prostate hyperplasia (BPH). Appropriate treatment can be directed at an entire organ or at the tumor growing in that organ, which may sometimes be called focal therapy. Medical actions include but are not limited to biomarker tests, digital rectal exam, prostate volume measurements, Differential Treatment, imaging (including medical imaging with or without molecular agents, ultrasound, MRI, x-ray, sonography, CT scans, positron emission tomography (PET) scans, and other imaging technologies), tumor volume measurements, biopsies, genetic tests, tumor profiling tests, primary treatment for cancer, focal therapy, hormone therapy, radiation, surgery, chemotherapy, secondary treatment, other treatments, and other suitable medical actions as are known to one of skill in the art.

i. Biomarkers

In some embodiments, Dynamic Screening incorporates Dynamic Analysis of a biomarker. In some embodiments, Dynamic Analysis is used to analyze one biomarker or combinations of more than one biomarker where interrelationships among the biomarkers can be analyzed. Biomarkers suitable for use in Dynamic Analysis include but are not limited to PSA, free PSA (fPSA), tPSA, PAP, proPSA, PSAV, PSADT, EPCA, EPCA-2, AMACR, methylated GSTP1, and the like. Due to the low cost of biomarker-based Dynamic Analysis, it is one of the first, early steps in mass screening in some embodiments of the invention.

In some embodiments, a biomarker value may be calibrated, or multiplied by a factor, in order to adjust for differences among commercial brands of biomarker analysis provided by different companies.

ii. Digital Rectal Exam

In some embodiments, Dynamic Screening incorporates the results of a digital rectal exam (DRE). Prior to the PSA era, a DRE was the primary means of screening for prostate cancer before symptoms appeared. Sometimes a tumor in the prostate can be felt as a hard lump. However, the false positive rate can be even higher than the simple use of PSA rejected by the USPSTF and others. A DRE has become less effective in the PSA era because progressing prostate cancer may likely produce detectable levels of PSA before it produces hard lumps in the prostate that are detectable by DRE. Some doctors may be inclined to propose a biopsy upon any hint of the possibility of prostate cancer from a positive DRE, due to their training, their desire to catch prostate cancer early, their practice of defensive medicine, financial reasons, or other incentives. Therefore, conventional DREs will lead to many unwarranted biopsies and inadvertent discovery of small, often indolent, cancers that produce little PSA and lead to over-treatment. Even conventional use of a single PSA test compared to a threshold may generally be superior to conventional DRE.

Nonetheless, DRE may be suitable for use with some embodiments of the invention as described herein. Using conventional DRE guidelines, many men with a positive DRE (suspected hard lump) will have a Dynamic Screening suggestion to continue Active Monitoring. Generally, Dynamic Screening will not recommend a biopsy based on a positive DRE alone. However, Dynamic Analysis may trigger a biopsy when input suggests that cancer may be a highly probable cause of a hard spot detected by DRE. In some embodiments, Dynamic Screening may include a “Safety-Net DRE” that requires a strong indication of prostate cancer before a biopsy or treatment is proposed on DRE evidence alone, or when a biopsy or treatment is proposed in conflict with Dynamic Screening analysis based on population evidence.

iii. Prostate Volume Measurement

In some embodiments, Dynamic Screening incorporates one or more prostate volume measurements over time. Prostate volume is often the most cost-effective escalation of medical actions after increasing frequency of PSA testing. Methods for measuring prostate volume include but are not limited to low-cost methods such as ultrasound and higher-cost methods such as MRI. Prostate volume may be measured specifically by a test, or be derived from a separate test. For example, ultrasound guided biopsies can provide ultrasound images needed to estimate prostate volume. In some embodiments, prostate volume measurements can inform estimates of the no-cancer baseline PSA (PSAn) and estimates of the probability that progressing cancer is the likely cause of increasing PSA. In some embodiments, multiple prostate volume measurements are utilized for Dynamic Analysis or Dynamic Screening.

iv. Differential Treatment and Follow-Up

In some embodiments, Dynamic Screening incorporates the results of Differential Treatment. For example, increasing PSA can be the result of increasingly severe prostatitis caused by inflammation and/or infection. Differential Treatment with anti-inflammatory meds and/or antibiotics can reduce the severity of prostatitis and, with follow-up testing, decelerate a biomarker (e.g. PSA) trend or even decrease observed biomarker levels.

v. Imaging

In some embodiments, Dynamic Screening incorporates one or more imaging results, including molecular imaging. Images of the prostate, or characteristics of the tumor derived from images, can be analyzed by the methods described herein, such as through Dynamic Analysis, or combined with biomarker trends or other information to increase the effectiveness of Dynamic Screening. In some embodiments, images of the prostate, or characteristics of the tumor derived from images, can be used to improve estimates of the probability or severity of progressing cancer and better assess possible next medical actions. Imaging can be used to derive tumor variables, such as, for example, tumor image strength, tumor volume, tumor location, tumor margin, tumor aggressiveness, tumor environment and tumor growth. Some embodiments incorporate one or more tumor characteristics, derived from imaging, in the methods described herein to determine cancer deadliness.

Molecular imaging allows physicians to see how the body may be functioning or to measure chemical and biological processes. In some embodiments, molecular imaging can be used to identify cancer tumor locations, their extent, and/or their activity. Generally, molecular imaging is performed by introducing an imaging agent into the patient's body. The imaging agent may be a molecule or other composition naturally present or not natural to the body, including but not limited to a sugar, protein, protein fragment, nucleic acid, small molecule, hormone, metabolite, recombinant antibody, biomimic, lipid, lipid vesicle, micro or nano-bubble, or some combination thereof. In some embodiments, the imaging agent is labeled, such as by a radioactive, fluorescent, colored, magnetic, reflective, or high-density label. Generally, the imaging agent is targetable—e.g., it accumulates in or specifically attaches to a specific tissue or type of cell, such as cancer cells. The imaging agent can be detected by a molecular imaging method, including but not limited to ultrasound, radioactive imaging (such as positron emission tomography/PET scans), optical imaging, CT scanning, magnetic resonance imaging, or spectroscopy, such as magnetic resonance spectroscopy.

vi. Biopsy

In some embodiments, Dynamic Screening determines whether a biopsy is warranted. A biopsy is generally a major decision because it is uncomfortable, costly, and can inadvertently discover indolent cancer, which often leads to unwarranted treatment. An inadvertent discovery of prostate cancer often generates fear in the man and his family, makes life insurance expensive and/or difficult to obtain, creates a pre-existing condition for health insurance that may encourage unnecessary treatment, and leads to treatment with possible negative side effects that can include impotence and incontinence. Generally, a biopsy should be avoided if not warranted.

Biopsy can be performed as known in the art. In traditional biopsies, such as a core needle biopsy, one or more needles may be inserted into the patient's prostate gland to remove tissue samples for examination. Other biopsy methods may also be suitable for use with the methods described herein. For example, the biopsy can be informed or guided by one or more imaging methods, where the imaging methods provide information on potential tumor locations in the target organ. Such methods may be particularly useful to reduce or avoid biopsies of the wrong, non-cancerous part of an organ, which could result in a false negative biopsy result. For prostate cancer, one non-limiting example of guided biopsy is the Artemis biopsy device (Eigen, Calif.).

In some embodiments, biopsy samples can be examined visually for pathology or otherwise analyzed to determine whether the sample tissue comprises cancer cells. For example, biopsy tissues can be tested for genetic abnormalities, gene expression, protein expression, metabolic activity, drug sensitivity, or other characteristics.

vii. Genetic Tests

In some embodiments, Dynamic Screening uses genetic tests after detecting cancer. In some embodiments, genetic testing is recommended as a precursor for determining appropriate treatments for the cancer or Active Surveillance. In some embodiments, genetic testing is recommended as part of Active Surveillance of the cancer. In some embodiments, genetic testing is recommended to determine risk profiles for the cancer, which can help inform a decision on whether surveillance or treatment should be recommended for the cancer. If tumor genetics are evaluated, they can be incorporated into Dynamic Screening or Dynamic Analysis. In some embodiments, a sequence of multiple genetic tests from multiple biopsies can be analyzed using Dynamic Analysis methods. For example, trends in tumor genetics can be estimated and combined with other information in the Dynamic Screening process.

There may be three general categories that may be discovered by genetic tests: safe results, dangerous results, and moderate results. Each category includes alleles, mutations, copy number variations, transpositions, and other genetic variations that may affect genes. Safe results indicate the prostate cancer detected by biopsy is relatively low risk. Safe results from genetic tests can help support a decision for surveillance rather than treatment. Dangerous results indicate the prostate cancer detected by biopsy is relatively high risk. Dangerous results from genetic tests can help support a decision for treatment rather than surveillance. Moderate results indicate the prostate cancer detected by biopsy is neither particularly high nor low risk. Examples of dangerous results include detection of sequences associated with early cancer-specific mortality, or with cancer-specific mortality subsequent to prostatectomy or other treatment. A non-limiting list of dangerous results for prostate cancer include: increased copy number of MYC, ADAR, or TPD52; decreased copy number of SERPIN5, USP10, TP53, or PTEN (phosphatase and tensin homolog). As additional genetic risk factors may be discovered, genetic testing for those new risk factors may also be appropriate for use with the invention. Future research and/or development of new treatment methods may also shift the categorization of various genetic results—in a nonlimiting example, discovery of a new treatment targeting tumors that overexpress a specific oncogene may drastically decrease mortality rates, which could lead to a recategorization of that oncogene from a dangerous result to a moderate result.

In some embodiments, Dynamic Screening incorporates genetic risk testing without specifically categorizing each gene tested. In some embodiments, each potential result is associated with a risk factor without separating risk factors into different categories. In some embodiments, genetic testing encompasses testing for gene activity or expression. For example, genetic testing suitable for use with the invention includes but is not limited to the Oncotype DX (Genomic Health, California) and the Prolaris test (Myriad Genetics, Utah). The Prolaris test examines expression levels for genes associated with cell cycle progression.

viii. Other Medical Actions

It is anticipated that as medical technology advances, new medical actions will become available that can be incorporated in the methods as described herein. It is also anticipated that the cost-effectiveness, accuracy, and sensitivity, among other characteristics, of some of the medical actions as described herein may improve with advances in the field, which may change any hierarchy of medical actions as used herein.

D. Treatments for Cancer

If cancer is detected, e.g. by biopsy, by Dynamic Analysis, or by any other method as described herein or practiced in the art, the patient may undergo treatment instead of Active Surveillance. Types of treatment include but are not limited to focal therapy, primary treatment including surgery and radiation therapy, hormone therapy and secondary treatment including chemotherapy. In some embodiments, treatment is performed in addition to Active Surveillance, such as hormone therapy with Active Surveillance.

i. Focal Therapy

In some embodiments, focal therapy of a detected cancer is performed, and the cancer monitored through Dynamic Screening.

Men who have cancer confined to one small area may sometimes be treated with focal therapy. For prostate cancer, focal therapy is generally also known as partial gland therapy or a prostate ‘lumpectomy’. The goal of focal therapy may be to ablate only the small area of the prostate that is cancerous, rather than removing or ablating the entire gland. Focal therapy is sometimes recommended because low-risk (e.g. indolent) prostate cancer is sometimes over-treated, in the sense that some of low-risk cancers are unlikely to cause harm. In these cases, a less invasive procedure will cause fewer unnecessary complications and other side effects. There may be, however, many small cancers that are not indolent, or can threaten the well-being of younger men. The aim of focal therapy is to destroy all of the biologically active cancer tissue while reducing the risk of side effects that may be associated with removal or destruction of the entire prostate gland. Focal treatment for prostate cancer can be accomplished, for example, using cryotherapy, high-intensity focused ultrasound (HIFU), lasers, photodynamic approaches, ultrasonic delivery of therapeutics, or other methods known in the art. Both cryotherapy and HIFU give the surgeon the ability to target specific regions of the prostate for treatment. Focal therapy can be followed by Active Monitoring to check for recurrence.

In focal cryoablation, a needle-thin probe delivers a solution that surrounds the tumor and kills it by freezing it to a very low temperature. The goal may be to destroy only the tumor while sparing most of the prostate. Preliminary evidence suggests that focal cryoablation may provide an effective alternative to radical prostatectomy for small, localized tumors. Because focal cryoablation targets only a small area within the prostate, it also has fewer side effects than other cryoablation techniques, which freeze the entire prostate gland.

High-intensity focused ultrasound, or HIFU, comprises a minimally invasive treatment option for localized prostate cancer that may offer a balance between eliminating cancer and maintaining quality of life. HIFU uses the energy of sound waves, generally directed to the tumor with the help of MRI scans, to superheat and eliminate small tumors. HIFU can be an attractive focal therapy approach because it may be relatively noninvasive. The effectiveness of this treatment can be monitored in real time, using MRI to measure the temperature within the prostate during therapy. Some surgeons believe that HIFU is more precise and non-invasive than cryotherapy.

Laser therapy typically uses a laser to deliver energy to the tumor location. For example, in interstitial laser therapy, a thin, flexible laser fiber may be placed directly into the tumor, and MRI scans are used to guide the delivery of laser energy to the tumor with pinpoint precision. The laser superheats and destroys small prostate tumors.

Photodynamic therapy typically relies on a targeted drug or other molecule that is light-activated. The activating light can be targeted to the tumor site to specifically activate only the drug molecules at the correct location. In vascular targeted photodynamic therapy (VTP), a drug that destroys tumor cells or the blood vessels that support them is given intravenously and moves to the inside of the tumor. The drug can be activated by exposing it to light of a specific wavelength, which is delivered to the tumor site using specially designed fibers placed within the prostate.

Ultrasound therapeutic delivery is typically performed by incorporating a therapeutic, such as a drug or protein, into a membrane-bound vesicle or microbubble. The vesicle or microbubble may then be injected into the patient, e.g. intravenously or transdermally. Targeted pressure waves, e.g. those generated by sound pressure, can then be used to cavitate the microbubbles at tumor sites, which releases the therapeutic and can aid insertion of the therapeutic into target cells.

ii. Primary Treatment

In some embodiments, primary treatment of a cancer or tumor is performed, and the cancer monitored through Dynamic Screening.

Primary treatment is often performed with the intent of “curing” the cancer—i.e., reducing the cancer to undetectable levels and with no recurrence. Primary treatment is typically more invasive than focal therapy. The type of primary treatment for a tumor depends on the aggressiveness, location, and size of the tumor. In some embodiments, Dynamic Analysis results are used to supplement biopsy results to determine a cancer risk profile and recommendations for subsequent decisions, including a choice of primary treatment. In one non-limiting example for prostate cancer, Dynamic Analysis of PSA that finds fast exponential growth above a baseline can suggest a high risk, even where the biopsy results find only a low-risk tumor, e.g. one with a small size or low Gleason score. An overall finding of high risk by the methods described herein may suggest a more aggressive primary treatment plan, non-limiting examples of which include: a combination of hormone therapy and surgery, accompanied by aggressive monitoring to quickly treat any signs of recurrence with radiation therapy; or combined seed and external beam radiation, supplemented by hormone therapy.

Other examples of primary treatment include but are not limited to surgery, including radical prostatectomy, which generally removes the entire prostate gland and some of the surrounding tissue. Radical prostatectomy is often viewed as the most effective primary treatment of prostate cancer, especially for organ-confined tumors. In some embodiments, radical prostatectomy is recommended when tests and analysis suggest a low risk that the tumor has spread beyond the prostate. Surgery can be performed through open surgery, laparoscopic surgery, or robotic surgery, among others.

Primary treatment can include radiation therapy. Radiation therapy is the use of high-energy beams or radioactive seeds to eliminate tumors. Advances in technology have made it possible to eliminate prostate tumors while also avoiding injury to healthy tissue. Radiation of the tumor is often considered for older and/or unhealthy men, for extra-capsular cancers, and for men concerned about the potential side effects of surgery. A range of radiation options may be available, including but not limited to: internal therapy (also known as brachytherapy), external therapy, and combinations of the two.

There are generally two types of brachytherapy—low-dose-rate brachytherapy (including radioactive seed implantation) and high-dose-rate brachytherapy. In low-dose-rate (LDR) brachytherapy, tiny, usually titanium, seeds are inserted in or near the tumor. The seeds contain a radioactive isotope, such as iodine-125 or palladium-103. Generally, the seeds remain permanently in the patient, and become biologically inert after several months. High-dose-rate (HDR) brachytherapy is a form of radiation therapy that delivers ultra-high doses of radiation in a short amount of time. A number of catheters may be placed into or near the tumor. The catheters may be attached to a machine that contains precise doses of radiation in the form of radioactive pellets, usually containing iridium-192. The pellets may be released into the catheters for five to fifteen-minute sessions, which deliver radiation directly to the tumor. HDR brachytherapy is generally repeated two to five times over the course of several days. For both LDR and HDR brachytherapy, ultrasound or other imaging methods can be used to aid placement of the radiation delivery device. Brachytherapy can be combined with external radiation therapy or other therapies to treat a cancer.

In external radiation therapy, radiation is generally directed to the prostate from a source located outside the body, such as by a particle accelerator in proton beam therapy. Radiation can be a particle beam, such as a proton or electron beam, or by photon beams, including X-rays and gamma rays. External radiation therapy can be used alone to treat localized tumors, or can be combined with internal radiation therapy or other therapies to treat a cancer. For prostate cancer, there are two primary types of external radiation therapy for treatment: image-guided radiation therapy and stereotactic radiosurgery. Image-guided radiation therapy (IGRT) uses imaging taken during the course of radiation treatment to target radiation beams to the contours of the tumor. Stereotactic radiosurgery uses advanced imaging technologies pinpoint the exact location of the tumor target, and delivers very high doses of radiation to tumors with an accuracy of under a millimeter. Other radiation therapies that may be used include intensity-modulated radiation therapy (IMRT), tomotherapy, stereotactic body radiation therapy, proton therapy, and electron beam therapy. External radiation therapy is generally repeated once a day, up to five days a week, and usually lasts two to ten weeks. In some cases, external therapy can be repeated more than once a day, with lower doses of radiation.

iii. Hormone Therapy

In some embodiments, hormone therapy is performed, and the cancer monitored through Dynamic Screening. Hormone therapy is sometimes used alone as a form of primary treatment that does not intend to cure the prostate cancer and is sometimes used in conjunction with other treatments such as surgery and/or radiation.

For some cancers, such as breast or prostate cancer, hormone therapy can be an effective treatment. Hormone therapy is sometimes continued after other treatments to help reduce the risk of recurrence. Hormone therapy for prostate cancer includes androgen deprivation therapy. Most prostate cancer cells rely on testosterone to help them grow. Hormone therapy for prostate cancer cuts off the supply of testosterone or stops testosterone from reaching the cancer cells, causing cancer cells to die or to grow more slowly. Hormone therapy for prostate cancer may involve medication, for example to block testosterone production or to block testosterone receptors, or surgery to remove the testicles.

iv. Salvage Treatment

Salvage treatment is a term used to describe follow-up primary treatment after prostate cancer recurrence following initial primary treatment. For example, radiation can be used as salvage treatment after surgery and surgery can be used as salvage treatment after radiation.

v. Secondary Treatment

Secondary treatment for advanced prostate cancer include: hormone therapy; new targeted therapies, including: Taxotere (sometimes with prednisone), Jevtana, Provenge, Zytiga, Xtandi, and Alpharadin—individually or in combination; and chemotherapy.

vi. Other Treatment

Further therapies and therapeutic agents to help men cope with advanced prostate cancer include Denosumab (Xgeva) and Ipilimumab (Yervoy). In addition, there may be treatments to help men cope with pain and preserve skeletal health.

It is anticipated that as medical technology advances, new treatments will become available that can be incorporated in the methods as described herein. It is also anticipated that the cost-effectiveness, accuracy, and ability to cure, among other characteristics, of some of the treatments as described herein may improve with advances in the field, which may change any hierarchy of medical actions and treatments as used herein.

### III. Cost-Benefit Analysis

At the simplest level, the Dynamic Analysis and Dynamic Screening process is designed to help answer two questions:
Is Strong (Signal) Cancer the primary cause of increasing PSA?
How much will cancer PSA (PSAc) increase during Active Monitoring?

Strong Cancer can become increasingly deadly during Active Monitoring, which delays a biopsy and subsequent treatment in order to gather more information and defer side effects. However, Weak Cancer leads to little or no increase in deadliness during Active Monitoring. Therefore, estimating the probability that increasing PSA is caused by Strong Cancer may be a primary job of Dynamic Screening using Dynamic Analysis.

The deadliness of Strong Cancer increases faster for faster growth in PSA from cancer (high PSAgr) and increases slower for slower growth in PSA from cancer (low PSAgr). Therefore, estimating the current level of cancer PSA (PSAc) and its growth rate (PSAgr) and then projecting the increase in PSAc during Active Monitoring may be a primary job of Dynamic Screening using Dynamic Analysis.

A. Right Decision, Right Question, Right Analysis

In some embodiments, Dynamic Screening focuses on what can be labeled: Right Decision, Right Question and Right Analysis. For prostate cancer screening, it is crucial to focus on the Right Decision, the Right Question and the Right Analysis. We use the terms Right Decision, Right Question and Right Analysis to label a preferred embodiment that does not limit the scope of the methods disclosed. For example, the highly regarded PCPT Risk Calculator (http://deb.uthscsa.edu/URORiskCalc/Pages/uroriskcalc.jsp) provides individualized calculations of the probability that a biopsy finds cancer. However, this probability may not be the right analysis to answer the right question to help a man make the right prostate cancer screening decision about a biopsy. For example, it is not a cost-benefit analysis and does not even address the deadliness of the cancer, much less the increase in deadliness from a delay in a biopsy in order to Actively Monitor potentially progressing cancer.

i. Threshold Decision: Screen or Not Screen

The threshold decision can be whether to screen for prostate cancer or not screen and wait until symptoms or other indicators suggest that a biopsy may be appropriate. The U.S. Preventative Services Task Force has recommended against screening using a single PSA test compared to a threshold because it does more harm than good, in their opinion.

ii. Right Decision: Actively Monitor or Biopsy Now

For men who choose to screen, the primary decision is whether to Actively Monitor or Biopsy Now. Dynamic Screening can also help inform the subsequent decision between Active Surveillance and Treatment Now.

Biopsy Now—A Biopsy can be a major decision because it is uncomfortable and costly and can inadvertently discover indolent cancer that often leads to unwarranted treatment. An inadvertent discovery of prostate cancer often generates fear in the man and his family and can make life insurance expensive and/or difficult to obtain, can create a pre-existing condition for health insurance that may encourage treatment, and may lead to treatment with possible side effects that can include impotence and incontinence. A biopsy often should be avoided unless warranted by cost-benefit analysis that considers the risk of subsequent treatment and side effects.

Actively Monitor—Active Monitoring delays a biopsy, subsequent treatment and side effects and gathers valuable information that allows increasingly well informed decisions. Increasing risk of prostate cancer death is the cost of Active Monitoring that should be balanced against the benefits. During Active Monitoring, Dynamic Screening analyzes and may suggest a series of escalating medical actions to gather additional information that may include one of the following examples:
Next PSA Test
Digital Rectal Exam (DRE)
Prostate Volume Measurement
Differential Treatment for Prostatitis followed By Monitoring of PSA
Molecular Imaging

iii. Alternative Decisions for Men Who Choose to Screen

For men who have elected to screen for prostate cancer, it may be difficult to articulate a reasonable alternative decision to Actively Monitor or Biopsy Now.

Biopsy Now or Never Biopsy—Logically, a man could decide between a Biopsy Now and Never Biopsy. However, the Never Biopsy choice may be inconsistent with the assumed decision to screen for prostate cancer because it precludes the ultimate screening step. Moreover, it may make no sense for a man to arbitrarily exclude the option of choosing a biopsy in the future that may become a valuable step.

Implicit Decision for Risk Thresholds—In some discussions of prostate cancer screening, analysis may be presented without clear articulation of the decision choices or the subordinate question to be answered. For example, a risk calculator might provide an estimate of man's current probability of cancer detection by biopsy. The implication may be that the man might consider a biopsy when the probability reaches a risk threshold appropriate for him. A simple PSA threshold of 4.0, for example, is a crude example of this approach. However, the implicit decision is often not articulated. For risk thresholds, the implicit decision seems to be a choice between Biopsy Now if the risk is above the risk threshold and Active Monitoring if the risk is below risk threshold. If this is the implicit decision, then the risk threshold approach should answer the right question: Is the man better off to Actively Monitor rather than Biopsy Now.

iv. Right Question: Better Off to Actively Monitor?

If the right decision is between Active Monitoring and a Biopsy Now then the right question may be: Which choice makes the man better off? It may not be clear what alternative question is appropriate to answer for men who plan to decide between Active Monitoring and Biopsy Now.

v. Right Analysis: Costs Vs. Benefits of Active Monitoring

If the right question is: Which choice makes the man better off?, then the right analysis may be to compare the costs of Active Monitoring vs. a Biopsy Now with the benefits. It is not clear what alternative analysis is appropriate for men who want to know whether they will be better off to Actively Monitor rather than Biopsy Now.

a. Benefits of Active Monitoring

There are at least three primary benefits of Monitoring:
Deferral of Side Effects—Deferral of the effects of biopsy and subsequent treatment: One more year without side effects.
Avoidance of Side Effects through Health Reassessment—A Health Reassessment may avoid biopsy and treatment: Death, heart attack, other serious health setback during Active Monitoring makes a biopsy irrelevant.
Avoidance of Side Effects through Prostate Reassessment—A Prostate Reassessment may avoid biopsy and treatment: A drop in PSA during Active Monitoring suggests progressing cancer is unlikely and a biopsy may not be justified.

b. Costs of Active Monitoring

Active Monitoring delays biopsy, diagnosis and treatment of prostate cancer that increases the risk of recurrence after treatment, metastasis and death from prostate cancer.
Death from Prostate Cancer—The increased risk of death from prostate cancer from a delayed biopsy and subsequent treatment may be the primary cost of Active Monitoring. The increased risk often depends on the man's life expectancy. The longer the man expects to live the greater his risk of death from prostate cancer can be. Therefore, an appropriate estimate of a man's life expectancy would typically an important step in the analysis of the costs (and benefits) of Active Monitoring rather than a Biopsy Now. We will focus herein on the increased risk of prostate cancer death as the cost of Active Monitoring. However, there can be additional costs of increased risk of recurrence after treatment and metastasis that occur sooner than death.
Recurrence after Treatment—The increased risk of recurrence from a delayed biopsy and subsequent treatment may be an additional cost of Active Monitoring. The increased risk may depend on the man's life expectancy. Recurrence after treatment creates fear and leads to more treatment and increased risk of side effects. For example, a man may be treated with surgical removal of his prostate. If prostate cancer recurs (and is discovered by increasing PSA), he may be treated with “salvage” radiation and/or hormone therapy that increases the risk of side effects. Recurrence after salvage treatment may further increase the man's fear and his risk of side effects from subsequent treatment.
Metastasis—The increased risk of metastasis from a delayed biopsy and subsequent treatment may be an additional cost of Active Monitoring. The increased risk depends on the man's life expectancy. Metastasis creates fear and leads to pain and suffering, more treatment and increased risk of side effects.

B. Cost-Benefit Process

Generally, the decision between Active Monitoring/Surveillance and biopsy/treatment depends on determining whether the patient is better off monitoring or taking more aggressive action now. In some embodiments, answering this question comprises comparing the costs and benefits of aggressive action now compared to delayed action, with the increased risk of prostate cancer death being weighed against the deferral of side effects and possible avoidance through new information gathered during the monitoring. In some embodiments, estimating the costs and benefits of delay is performed by projecting cancer trends (e.g. from Dynamic Analysis) into the future. An example of how projecting a decision is used in Dynamic Screening is described in Example 1.

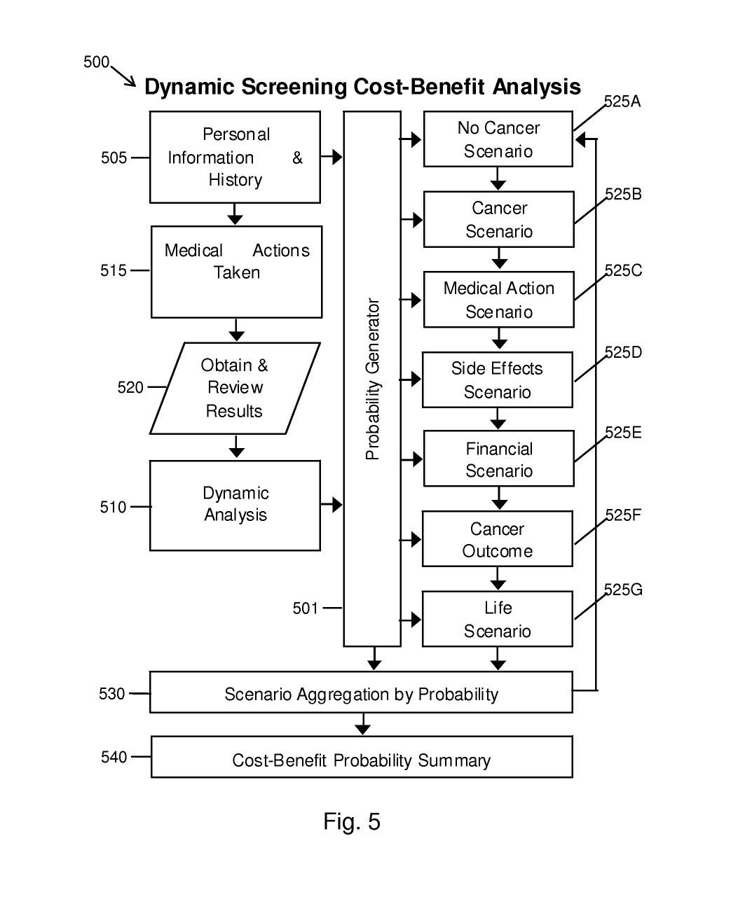

In some embodiments, for example as shown in the flow chart 500 of FIG. 5, the calculation of changes in the risk of cancer death can be a part of a more comprehensive, Dynamic Screening cost-benefit analysis. The systems and methods described herein may provide a death risk probability generator 501. The death risk probability generator 501 can calculate a risk of death due to progressing prostate cancer in response to information regarding personal information and history 505 (e.g., history of prior test, genetic history, risk tolerance, risk preference, etc.) and results of a Dynamic Analysis 510, which itself can be performed in response to personal information and history 505, information regarding medical actions taken 515, and information regarding the results of such medical actions 520. The death risk probability generator 501 can generate a plurality of scenarios regarding the patient's life, such as a no cancer scenario 525A, a cancer scenario 525B, a medical action scenario 525C, a side effects scenario 525D, a financial scenario 525E, a cancer outcome 525F, and other life scenarios 525G. The probability generator 501 can aggregate these scenarios by probability in a step 530 to generate a cost-benefit probability summary 540. A patient can select for Active Monitoring, biopsy, and/or treatment based on the cost-benefit probability summary 540.

Method 500 and the related steps and procedures described above, including the steps and sub-steps thereof, can be implemented by a processor or a computer system comprising a processor and a tangible medium embodying machine-readable code including instructions for performing the methods and procedures described herein.

Also, although the steps of the method 500 and the related steps and procedures are described with reference to specific embodiments herein, one skilled in the art can recognize many variations based on the teachings herein. The steps may be completed in different orders. One or more of the steps may be added or omitted. One or more of the steps may comprise one or more sub-steps. One or more of the steps may be repeated.

C. Comparing Costs and Benefits

For a man who has decided to screen for prostate cancer, choosing between continuing Active Monitoring and performing a biopsy may be a major decision point, because of the major implications of the biopsy decision. For a man who has been diagnosed with prostate cancer (with a positive biopsy), choosing between Active Monitoring, or Active Surveillance, of the tumor and starting treatment may be a major decision point, because of the major implications of the treatment decision. In some embodiments, the invention provides a method for choosing between Active Monitoring/Surveillance and biopsy/treatment.

i. Cost-Benefit Process

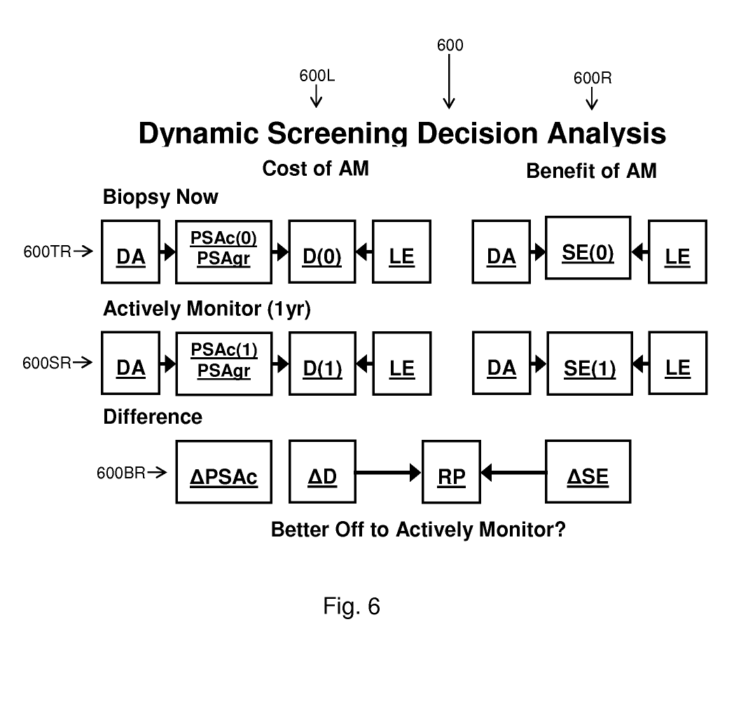

Some embodiments provide a system or method for calculating the costs and benefits of Active Monitoring instead of performing a biopsy or starting treatment. For example, Active Monitoring defers biopsy, and thus has a cost of potentially increasing the risk of cancer death (by deferring treatment of any cancer that might have been discovered). However, Active Monitoring may also defer, and may ultimately avoid, any negative side effects from biopsy or treatment. FIG. 6 depicts a chart 600 for the factors that affect the costs and benefits of Active Monitoring compared to biopsy. In this embodiment, it is assumed that cancer is found by a biopsy now or in the future. Other embodiments consider the probability that a biopsy will find cancer and consider the costs of the biopsy whether it finds cancer or not. The top row 600TR, left column 600L depicts an example flow chart from Dynamic Analysis (DA) of PSA, performing a biopsy now is chosen. Dynamic Analysis is used to calculate PSAc(0), the portion of the current PSA value due to cancer (PSAc=PSA−PSAn) and the PSAc growth rate (PSAgr). These values can be used to calculate a future risk of death from cancer at the current time, D(0), which is adjusted by life expectancy LE. The second row 600SR, left column 600L depicts an example flow chart from Dynamic Analysis of PSA, if Active Monitoring for a year is chosen. In the second row, left column, the PSA trend calculated from Dynamic Analysis DA is projected by a year to calculate the contribution of cancer to PSA in a year, PSAc(1), and PSAgr. PSAc(1), PSAgr, and LE can be used to calculate a projected future risk of death from cancer in one year—D(1). For the benefits (right column 600R), Dynamic Analysis (DA) can be used to calculate the risk of side effects of performing biopsy now (top row 600TR, right column 600R), SE(0), also adjusted for life expectancy. As shown in the second row 600SR, right column 600R, Dynamic Analysis (DA) can also be used to calculate a projected risk of side effects of Active Monitoring(AM) after one year, SE(1). The difference (bottom row 600BR) between PSAc(0) and PSAc(1) is ΔPSAc, the difference between D(0) and D(1) is ΔD, and the difference between SE(0) and SE(1) is ASE. The differences in PSAc, death, and side effects can be used to determine whether to biopsy now or monitor the patient for a year.

ii. Risk Preference

In some embodiments, costs and benefits are compared using a risk preference (RP). The risk preference may be obtained from the man and reflects personal tradeoffs between costs and benefits or, in FIG. 6, between increased death risk (ΔD) and decreased risk of side effects (ASE). In this embodiment, risk preference may be expressed in terms of the number of treatments needed to save a life or, equivalently, the percentage of the time treatment that is expected to save a life.

Some doctors suggest 10 treatments to save a life as sufficient justification for treatment (and implicitly for the screening used to detect the cancer that leads to treatment). 10 treatments to save a life translate to a 10% reduction in prostate cancer death risk at life expectancy for an individual man.

Some men may be more concerned about prostate cancer death than the risks of over-treatment. They should use a higher risk preference that makes it easier to justify early detection and treatment, such as 15 treatments to save a life (6.7% reduction in death risk). Other men may be more concerned about the risks of over-treatment than prostate cancer death. They should use a lower Risk Preference that makes it easier to justify later detection and treatment, such as 7 treatments to save a life (14.3% reduction in death risk).

D. Considering “What If” Scenarios

In some embodiments, Dynamic Screening considers “what if” scenarios in order to analyze the costs and benefits of a series of possible actions. For example, a biopsy and subsequent treatment may soon be justified under the “what if” scenario that a man's prostate volume is small to normal and his PSA trend does not decelerate after Differential Treatment for prostatitis. Together these “what if” results may suggest that a no-caner prostate condition is unlikely to be the cause of increasing PSA and prostate cancer is the more likely cause. Under this “what if” scenario Dynamic Screening may project that a biopsy may soon be justified. In this situation, a prostate volume measurement and subsequent Differential Treatment may be suggested because of the reasonable chance the results of those actions will lead to justification of a biopsy soon after.

i. Current and Potential Benefits

In some embodiments, Current Benefits are based on actual Differential Diagnosis results, if any. In some embodiments, Potential Benefits are a “what if” analysis that assumes a typical prostate volume (such as 30 cc) and continued PSA increase on trend for a year after Differential Treatment for prostatitis. Deferral and Health Reassessment benefits may be the same in both cases. However, Prostate Reassessment benefits may be much lower in the Potential case than in the Current case.

For example, no prostate volume measurement or Differential Treatment with PSA follow-up have occurred in an example Current case. Therefore, the estimated Dilution % is high (45% example) and the benefit of delay is high (18% example). In contrast, an example Current case asks “what if” a typical prostate volume measurement (such as 30 cc) has been obtained and PSA continues to increase on trend for one year after Differential Treatment. The “what if” Potential case helps doctors and their patients determine if it is time to consider escalating Differential Diagnosis actions.

ii. Current and Potential Costs

In some embodiments, Current Costs are based on actual Differential Diagnosis results, if any. In some embodiments, Potential Costs are a “what if” analysis that assumes a typical prostate volume (such as 30 cc) and continued PSA increase on trend for a year after Differential Treatment for prostatitis.

For example, Potential Costs may more than 50% greater than Current Costs. No prostate volume measurement or Differential Treatment with PSA follow-up have occurred in an example Current case. For Current Costs, maximum death risk (D %) is 18%, but a high 45% Dilution % has reduced the Diluted Death Risk (DD %) to 10%. In contrast, an example Potential case asks “what if” a typical prostate volume measurement (such as 30 cc) has been obtained and PSA continues to increase on trend for one year after Differential Treatment. The “what if” Potential case helps doctors and their patients determine if it is time to consider starting Differential Diagnosis actions. For Potential Costs, maximum death risk (D %) is 18%, but a much lower 12% Dilution % after Differential Diagnosis methods has increased the Diluted Death Risk (DD %) to 16%.

### IV. Benefits of Active Monitoring

There are at least three primary benefits of Active Monitoring: (i) deferral of side effects and subsequent treatment, e.g., one more year without side effects, (ii) avoidance of side effects through health reassessment, e.g., health reassessment may avoid biopsy and treatment such that death, heart attack, other serious health setback makes a biopsy irrelevant, and (iii) avoidance of side effects through prostate reassessment, e.g., prostate reassessment may avoid biopsy and treatment such that a drop in PSA suggests progressing cancer is unlikely and a biopsy is not justified.

In some embodiments, benefits of Active Monitoring include deferral or avoidance of side effects from biopsy or treatment. For example, a patient who elects to defer treatment may defer side effects until initiation of treatment is chosen. A patient who elects to defer treatment, then later discovers an independent health factor that significantly reduces their life expectancy may find that treatment is no longer warranted, and thus completely avoid side effects. In some embodiments, Active Monitoring can allow time for a health reassessment that might eliminate or reduce the appeal of a biopsy and/or treatment. For example, a patient might have a heart attack that shortens his life expectancy and shifts his risk preferences away from biopsy and treatment. In some embodiments, Active Monitoring can allow time for a prostate reassessment that might eliminate or reduce the appeal of a biopsy and/or treatment. For example, a man with an increasing PSA trend might undergo subsequent tests that show a drop in PSA values, which in some embodiments would substantially reduce the probability that progressing prostate cancer is the primary cause of the previously increasing PSA trend.

A. Defer Side Effects of Treatment

Side effect risks, inconvenience and monetary costs can be deferred a year by delaying a biopsy by a year. The risk of side effects from prostate cancer treatment is one of the primary reasons that the USPSTF recommended against prostate cancer screening using PSA. For example, delaying a biopsy a year for a man with a 10-year life expectancy reduces his lifetime incidence of side effects by 10% (1-year deferral/10-year life expectancy) and for a man with a 20-year life expectancy reduces his lifetime incidence of side effects by 5% (1-year deferral/20-year life expectancy). Some men may weight these deferral benefits even more heavily because they value near-term costs more than distant future costs. For example, some men may value avoiding the near-term risks of impotence and incontinence from prostate cancer surgery more than the risk in years farther in the future.

In one embodiment, we use the percentage calculated as one-year deferral divided by the man's life expectancy plus a near-term adjustment as a benefit of a one-year delay in biopsy.
7.5% One-Year Deferral Benefit—Example
   5% Base (1 yr Deferral/20 yr Life Expectancy
   2.5% Near-Term Adjustment (50% Increase for Emotional Reasons)

B. Health Reassessment

A health reassessment can be an important aspect of a one-year biopsy delay compared to a biopsy now. A lot can happen in a year. For example, nearly 5% of men with a 10-year life expectancy will die. An additional percentage of men will suffer a serious health setback that substantially reduces their life expectancy, such as a stroke, heart attack or diagnosis of other life threatening condition. Therefore, for any man a one-year delay in biopsy creates a non-trivial chance that a health reassessment in that year will eliminate the need for a biopsy in the future because of reduced life expectancy.

In one embodiment:
3.75% One-Year Deferral Benefit—Example
   2.5% Approximate Death Risk (1 yr/[2×20 yr Life Expectancy])
   1.25% Near-Term Adjustment (50% Increase for Health Setbacks)

C. Prostate Reassessment

A prostate reassessment can be an important aspect of a one-year biopsy delay compared to a biopsy now. A lot can happen in a year. For example, PSA could drop or jump enough from the trend to reduce substantially the probability that the trend may be caused by progressing cancer. The size of the prostate reassessment benefit depends on the estimated Dilution %, which reflects the risk of small, often indolent cancers that produce little PSA. The benefit of delay may be high if Dilution % is high because prostatitis may reveal itself over a year as the cause of the increasing PSA, especially if assisted by Differential Treatment for prostatitis. Preliminary results suggest that more than 50% of potential false positives (and corresponding dilution) over the course of up to a year after Differential Treatment.

In two embodiments:
Current Example: 18% One-Year Prostate Reassessment Benefit
   45% Dilution % (45% of detected cancers are small, often indolent cancers that produce little PSA)
   40% Reduction after One-Year Delay with Differential Treatment
Potential Example: 5% One-Year Prostate Reassessment Benefit
   12% Dilution % after Differential Diagnosis Methods (30 cc and PSA grows on trend after Differential Treatment.)
   40% Reduction after One-Year Delay

### V. Costs of Active Monitoring

Active Monitoring delays biopsy, diagnosis and treatment of prostate cancer that increases the risk of recurrence after treatment, metastasis and death from prostate cancer.

Death from Prostate Cancer: The increased risk of death from prostate cancer from a delayed biopsy and subsequent treatment is often the primary cost of Active Monitoring. The increased risk depends on the man's life expectancy. Often, the longer the man expects to live the greater his risk of death from prostate cancer. Therefore, an appropriate estimate of a man's life expectancy can be an important step in the analysis of the costs (and benefits) of Active Monitoring rather than a Biopsy Now.

We focus herein on the increased risk of prostate cancer death as the cost of Active Monitoring. However, there may be additional costs of increased risk of recurrence after treatment and metastasis that occur sooner than death.

Recurrence after Treatment: The increased risk of recurrence from a delayed biopsy and subsequent treatment can be an additional cost of Active Monitoring. The increased risk depends on the man's life expectancy. Recurrence after treatment creates fear and leads to more treatment and increased risk of side effects. For example, a man may be treated with surgical removal of his prostate. If prostate cancer recurs (and is discovered by increasing PSA), he may be treated with “salvage” radiation and/or hormone therapy that increases the risk of side effects. Recurrence after salvage treatment will further increase the man's fear and his risk of side effects from subsequent treatment.

Metastasis: The increased risk of metastasis from a delayed biopsy and subsequent treatment can be an additional cost of Active Monitoring. The increased risk depends on the man's life expectancy. Metastasis creates fear and leads to pain and suffering, more treatment and increased risk of side effects.

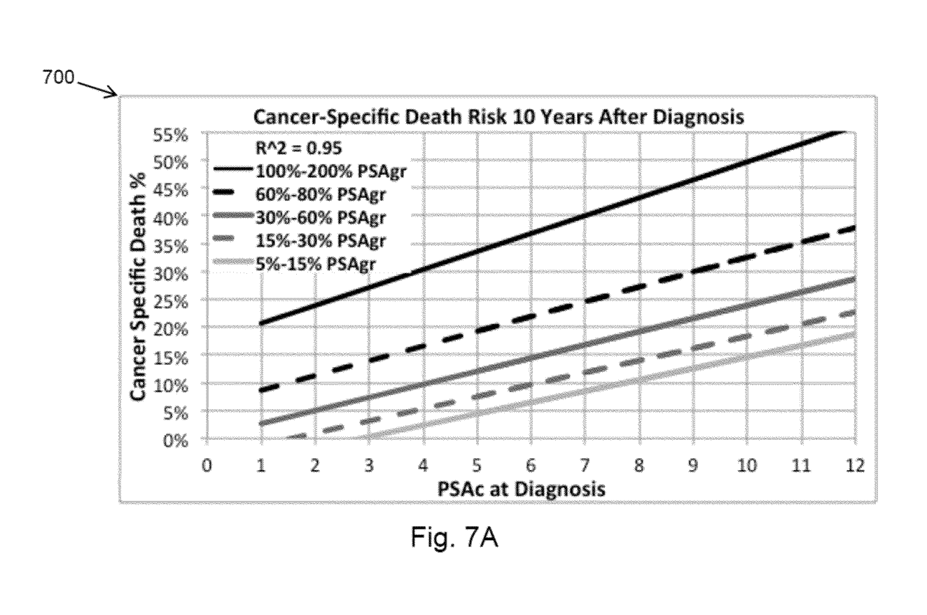

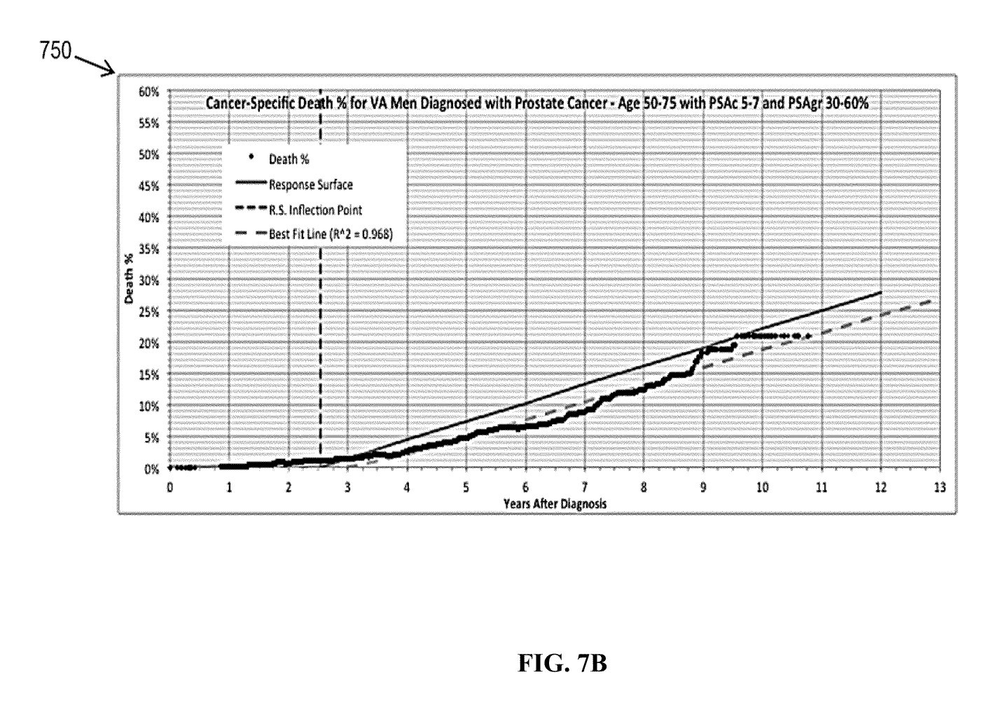

Prostate cancer patients' risk of death from prostate cancer varies with PSA and/or PSAc, PSAgr, age, and other factors. In some embodiments, the invention as described herein uses at least one characteristic of a trend generated by Dynamic Analysis to determine a patient's risk of death from cancer or other outcomes, such as: metastasis, local progression and recurrence after treatment. Examples of cancer specific death risks for different PSAgr ranges as a function of PSAc, the estimate of PSA from cancer, are shown in the graph 700 of FIG. 7A. These death risk functions were calculated from retrospective analysis of patient data, wherein each patient had at least four PSA tests over four years prior to diagnosis.

In some embodiments: Ten year after diagnosis cancer-specific death: CSD(10)=A*PSA*PSAgr+B*PSA+C*PSAgr+D. With possible Age adjustments: A=(a0+a1[Age-55]), B=(b0+b1[Age-55]), etc.

In some embodiments, a second response surface is used: Nine year after diagnosis cancer-specific death:

CSD(9)=A*PSA*PSAgr+B*PSA+C*PSAgr+D. With possible Age adjustments: A=(a0+a1[Age-55]), B=(b0+b1[Age-55]), etc.
Together, these response surfaces can be used to define a piece-wise linear cancer-specific death function vs. years after diagnosis for a man with a PSAc, PSAgr and Age, as shown in the graph 750 of FIG. 7B.
In some embodiments, cancer-specific death curves for a given ranges of PSAc, PSAgr and Age, as shown by the Death % curve on FIG. 7B, can be used as the starting point for estimating a piece-wise linear curve vs. the number of years after diagnosis. FIG. 7B shows the curve for underlying population data, the piece-wise linear best fit curve with zero initial CSD and the piece-wise linear response surface curve with zero initial CSD that is part of a best fit model for ranges of PSAc, PSAgr and Age. In some embodiments, the functional form of the piece-wise linear curve might be:

CSD(Yrs)=0 for Year after diagnosis from 0 to ZYr, and

Slope×(Yrs−ZYr) for Year after diagnosis greater than ZYr.

Parameters for CSD(Yrs) can be solved for using the CSD(10) and CSD(9) response surfaces from above based on estimates of PSAc, PSAgr and possibly Age.

A. Cost Analysis Process

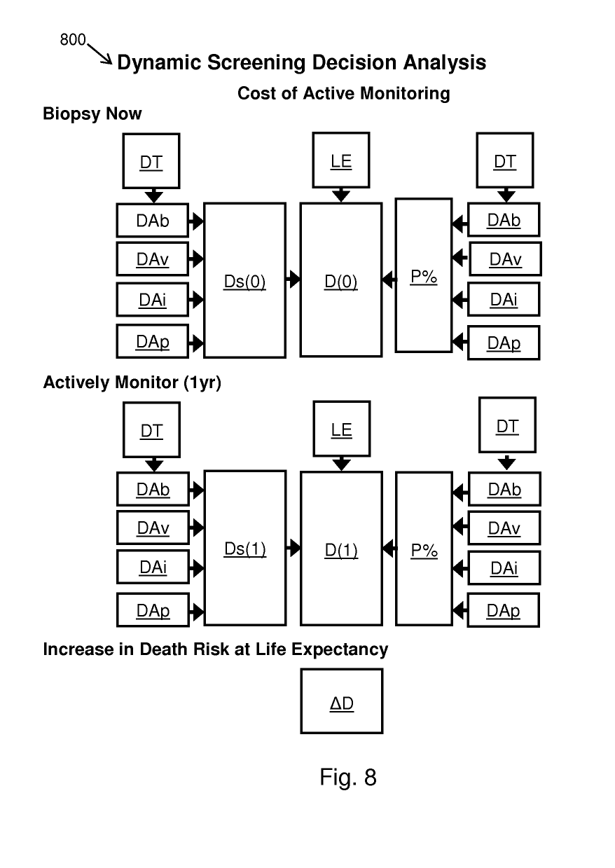

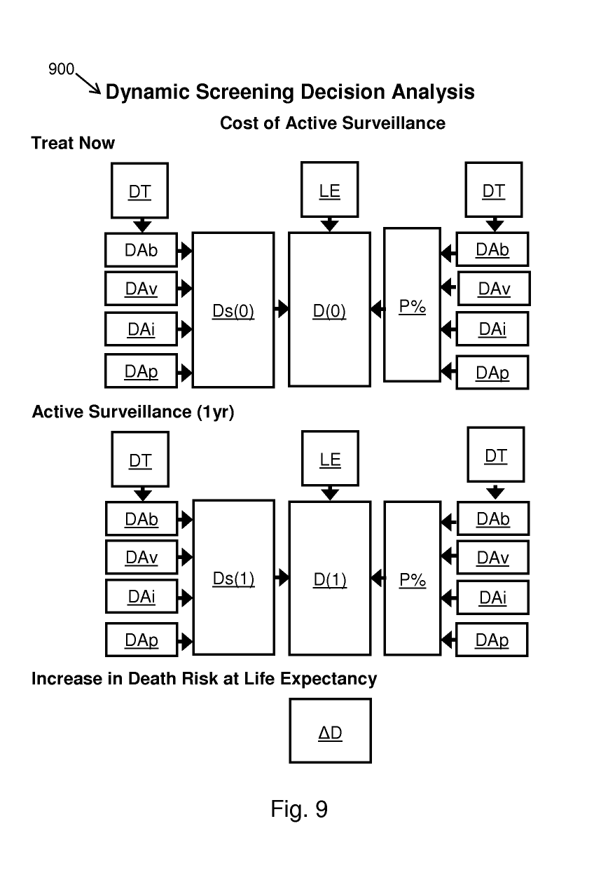

FIG. 8 depicts a chart 800 of the factors that affect the costs and benefits of Active Monitoring (Active Surveillance) compared to performing an immediate biopsy. DA refers to Dynamic Analysis, in this example for PSA. In both the treatment regime and the Active Monitoring (Active Surveillance) regime, Differential Treatments (DT) may include the Dynamic Analysis of biopsies (DAb), tumor volume (DAv), imaging (DAi), and/or prostate volume (DAp). The data for the analyses can be used to calculate Ds(0)—the death risk for 100% probability of progressing or Strong (Signal) Cancer with the treatment regime, P %—the probability of progressing or Strong (Signal) Cancer (as the primary cause of increasing PDA), and Ds(1)—the death risk for 100% probability of progressing or Strong (Signal) Cancer with 1 year of Active Monitoring. In some embodiments, P % can be defined as: PC %—the probability that a biopsy will detect any cancer; PS %—the probability that a biopsy will detect Strong (Signal) Cancer; and PSc %—the probability that cancer detected by a biopsy will be Strong (Signal) Cancer. In this example, P % uses the PSc % definition. As discussed above, D(0)—a risk of death from cancer at the current time—can be calculated using Ds(0), P %, and LE as inputs, and D(1)—a risk from cancer in one year—can be calculated using Ds(1), P %, and LE as inputs. FIG. 9 depicts a similar chart 900 of the factors that affect the costs and benefits of Active Monitoring (Active Surveillance) compared to treatment, for example, after the biopsy has been performed. ΔD—the difference between D(0) and D(1)—is therefore the additional death risk of Active Monitoring for a year instead of performing an immediate biopsy and optionally subsequently implementing a treatment regimen.

In many preferred embodiments, Dynamic Screening uses a four step process to estimate the increased risk of death from a delay in biopsy and subsequent treatment if progressing prostate cancer is the primary cause of increasing PSA and monitored variables. This process can be used even where cancer has not been definitively detected, as a risk of death from cancer can still be calculated from the information available. First, the current cancer state may be evaluated using Dynamic Analysis of PSA and optionally other available information, and the corresponding death risk is estimated. Second, a future cancer state after a delay (for example, after delaying biopsy or treatment for one year) may be projected using available Dynamic Analysis trends. Third, the projected future cancer state may be evaluated using Dynamic Analysis, and a corresponding death risk is estimated. Fourth and finally, the increase in prostate cancer death risk may be calculated as the difference between in death risk between the projected future cancer state and the current cancer state.

B. Diluted Risk of Death

Weak (Signal) Cancers are small, often indolent, cancers that produce little PSA. Weak Cancers can dilute (reduce) cancer death risk for a PSA trend estimated by Dynamic Analysis. Strong (Signal) Cancers that are the primary cause of increasing PSA can create substantial death risks, as shown above. In contrast, Weak Cancers create no death risk, or perhaps very little. If cancer will be discovered by biopsy there is some chance of Strong Cancer and some chance of Weak Cancer. The overall cancer death risk will be the weighted average of Strong Cancer death risk and Weak Cancer Death risk. The higher the probability of Weak Cancer, the greater the dilution (reduction) of the overall cancer death risk.

Computationally, the increase in cancer death risk is diluted (<100%) by the probability Strong Cancer is the cause of PSA.

In some embodiments, Dynamic Screening uses the results of analysis of population data to estimate the cancer-specific risk of death over time for a man assuming that progressing or Strong cancer may the cause of increasing PSA and then adjusts that risk for dilution using P %, as described above, to account for the chance that the increasing PSA is not caused by progressing or Strong cancer.

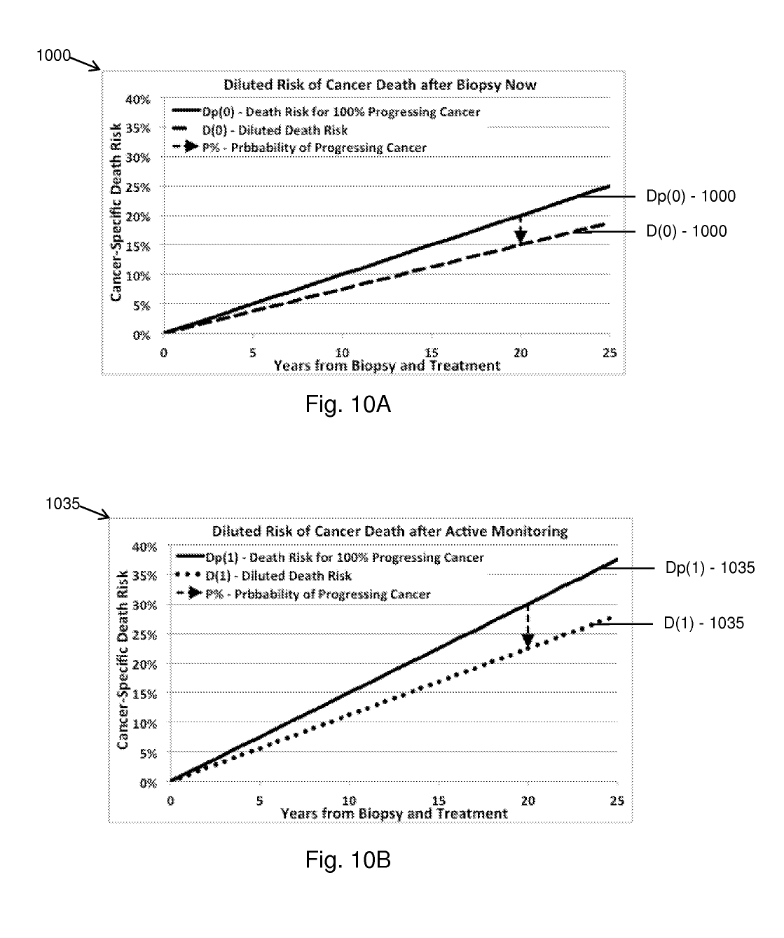

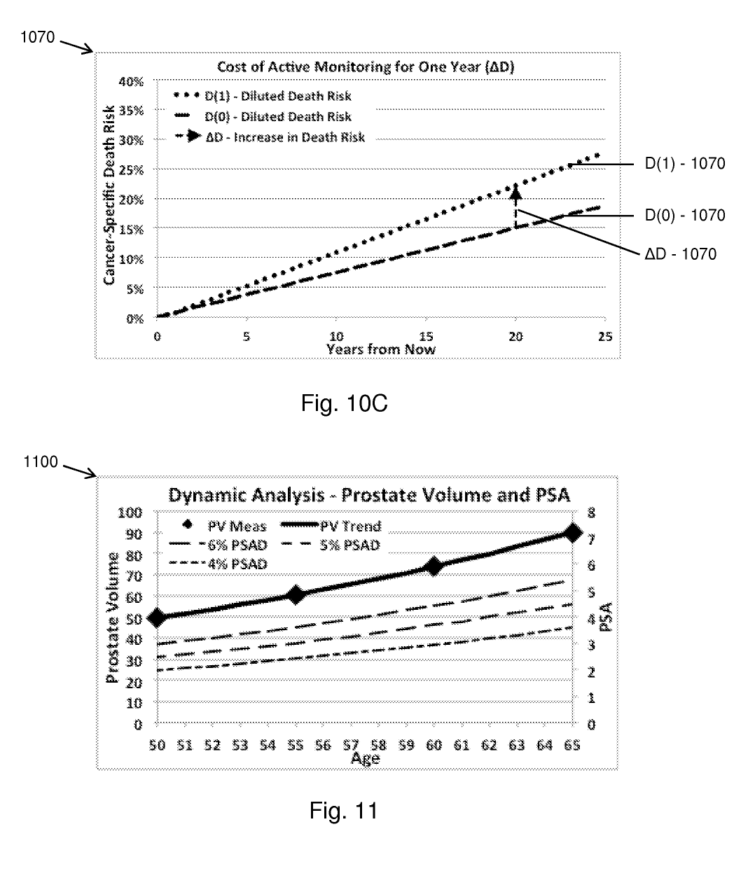

FIG. 10A shows an exemplary graph 1000 of the diluted risk of cancer death for a number of years after an immediate biopsy has been performed and a treatment regimen implemented as described above. The X-axis shows the number of years from biopsy and treatment, which occurs in year 0. The Y-axis shows cancer-specific death risk. The solid line Dp(0)-1000 shows the death risk for a 100% probability of progressing or Strong Cancer. The broken line D(0)-1000 shows a diluted death risk for a probability of progressing or Strong Cancer. The arrow P % shows a difference in the probability of progressing cancer as the primary cause of increasing PSA (the probability of Strong [Signal] Cancer). Dilution is the reduction in death risk caused by the possibility of Weak (Signal) Cancer that is small, often indolent, and creates little risk of cancer death. Cancer detected by biopsy might be Strong (Signal) Cancer that is likely to be deadly and Weak (Signal Cancer) that is not likely to be deadly. Diluted death risk, D, is the weighted probabilities of the two types of cancer. However, the probability of death from Weak (Signal) Cancer is very low and can be ignored. Therefore, the diluted risk of cancer death is the risk of death if Strong (Signal) Cancer multiplied by the probability (P %) that Strong Cancer is the primary cause of increasing PSA.

FIG. 10B shows an exemplary graph 1035 of the diluted risk of cancer death for a number of years after a first initial year of Active Monitoring has been implemented instead of immediate biopsy and treatment as described above. The X-axis shows the number of years from initial Active Monitoring, which starts at year 0. The Y-axis shows cancer-specific death risk. The solid line Dp(1)-1035 shows the death risk for a 100% probability of progressing cancer. The broken line D(1)-1035 shows a diluted death risk for a probability of progressing cancer. The arrow P % shows a difference in the probability of progressing cancer as the primary cause of increasing PSA (the probability of Strong [Signal] Cancer). See Example 1 discussed below.

FIG. 10C shows an exemplary graph 1070 of the costs in terms of death risk of implementing a first initial year of Active Monitoring instead performing an immediate biopsy and treatment. The X-axis shows the number of years from initial Active Monitoring or biopsy and treatment, which starts at year 0. The Y-axis shows cancer-specific death risk. The dotted line D(1)-1070 shows a diluted death risk for a probability of progressing cancer assuming biopsy and treatment after a year of Active Monitoring. The broken line D(0)-1070 shows a diluted death risk for a probability of progressing cancer assuming an initial biopsy and treatment at year 0. The ΔD-1070 shows a difference in cancer death risk caused by Active Monitoring for one year. While the graph 1070 in FIG. 10C shows a gradual increase in the death risk from implementing a first initial year of Active Monitoring instead of performing an immediate biopsy and treatment, there may be other instances where there is only a nominal increase in the death risk from implementing a first initial year of Active Monitoring (in which case, the cost-benefit analysis may conclude that initial Active Monitoring is preferred over biopsy and treatment) or other instances in which there may be a significant increase in the death risk from implementing a first initial year of Active Monitoring (in which case, the cost-benefit analysis may conclude that biopsy and treatment may be preferred over initial Active Monitoring).

In some embodiments, Dynamic Screening calculates a “net” increase in risk of cancer death if progressing cancer is the primary cause of increasing PSA. For example, each patient has a probability that a no-cancer condition is the primary cause of increasing PSA, any cancer found inadvertently by biopsy is likely to small, often indolent, that produces little PSA and contributes little or nothing to the risk of prostate cancer death. In some embodiments, the “net” increase in death risk is the increased risk of death if progressing cancer adjusted for the probability that some of the cancers are small and often indolent, which do not contribute substantially to the death risk. It is calculated by multiplying the probability of progressing cancer by the increased risk of death if progressing cancer.

An example of how dilution analysis is carried out is described below in Example 1.

C. Death Scenarios

A variety of death scenarios can be used by Dynamic Screening to characterize the cost of taking medical actions, including the cost of Active Monitoring.

i. Increased Risk at Life Expectancy

In some embodiments, Dynamic Screening considers the increase in risk of death at life expectancy as the cost of Active Monitoring or other medical actions, including their delay. For example, consider a man with a 20-year life expectancy. The graph 1070 of FIG. 10C can be used to estimate the increase in diluted death risk for one year of Active Monitoring, as shown by the upward arrow 20 years from now.

ii. Life and Death Simulations

In some embodiments, life and death risks from prostate cancer and other causes can be simulated using scenario analysis and possibly Monte Carlo analysis. An example of scenario analysis is presented in Example 3 discussed below. A variety of summary statistics may be possible results of scenario analysis, including: expected reduction in life expectancy and probability of death from prostate cancer.

### VI. Dynamic Analysis

Some embodiments as described herein comprise Dynamic Analysis. Dynamic Analysis is a method for analyzing information over time. In some embodiments, Dynamic Analysis produces results that may be used as inputs to Dynamic Screening (but may not necessarily be the only inputs). Dynamic Analysis methods can be applied to any time series data, such as a time series of test result values from a medical test. Dynamic Analysis can combine analysis of time series data and other data that is not time series in nature.

In some embodiments, Dynamic Analysis is used to analyze the results of one or more tests. Tests which can be included in Dynamic Analysis include but are not limited to biomarker tests genetic tests, gene expression tests, tissue tests, urine tests, blood tests, imaging, ultrasound, molecular imaging, prostate volume measurements, biopsies, pathology tests, and the like. In some embodiments, Dynamic Analysis is used to analyze one or more biomarkers. Biomarkers suitable for use in Dynamic Analysis include but are not limited to PSA, free PSA (fPSA), tPSA, PAP, proPSA, PSAV, PSADT, EPCA, EPCA-2, AMACR, methylated GSTP1, and the like. Genetic tests can be used to detect mutations, transversions, transpositions, deletions, single nucleotide polymorphisms, gene rearrangements, including a non-limiting list of dangerous results for prostate cancer include: increased copy number of MYC, ADAR, or TPD52; decreased copy number of SERPIN5, USP10, TP53, or PTEN (phosphatase and tensin homolog). Biopsy tests include but are not limited to traditional needle biopsies, multiple-needle biopsies, and biopsies informed by imaging or other diagnostic tests, including ultrasound-guided biopsies, such as those provided by Artemis.

In some embodiments, Dynamic Analysis uses imaging results, biopsy results, the results of any other medical action as described herein, or any combination thereof. For example, biopsy pathology results can be combined with imaging results to create a biopsy model of the prostate, including any tumors found through biopsy. This biopsy model can be quantified to estimate tumor variables, such as: tumor volume, tumor location, tumor margin, tumor environment and/or tumor aggressiveness. In another example, imaging results can be quantified to estimate tumor volume, tumor location, tumor margin, and/or tumor aggressiveness. In some embodiments, biopsy model and imaging results can be combined, for example to estimate tumor size, for Dynamic Analysis as described above. In some embodiments, Dynamic Analysis uses results from genetic testing of cancer cells, for example to estimate tumor aggressiveness. The results of Dynamic Analysis of genetic testing can be combined with other Dynamic Analyses.

In some embodiments, Dynamic Analysis uses measurements of prostate volume and/or tumor volume. Prostate volumes and tumor volumes can be measured, for example, at using ultrasound images, MRI images, or biopsy results combined with imaging results. In one nonlimiting example, two or more sets of test results allow Dynamic Analysis to calculate image tumor volume trends. Those trends can be used to help make better estimates of the probability of progressing cancer and better assess possible next medical actions.

In some embodiments, Dynamic Analysis uses measurements of tumor margin. Two or more test results can be used to calculate tumor margin trends. Those trends can be used to help make better estimates of the probability of cancer death, the probability of cure, and otherwise better assess possible next medical actions.

In some embodiments, Dynamic Analysis uses measurements of tumor aggressiveness. Two or more test results can be used to calculate tumor aggressiveness trends. Those trends can be used to help make better estimates of the probability of cancer death, the probability of cure, and otherwise better assess possible next medical actions.

Dynamic Analysis may take into account personal information and history, including but not limited to PSA test history, test subject profiles, and test subject medical information, as described in co-assigned U.S. patent application Ser. No. 13/442,648.

A. Dynamic Analysis of Prostate Volume

Prostate volume can be measured using low cost ultra-sound images or higher cost images, such as MRI or PET. Dynamic Analysis uses prostate volume measurements in two primary ways that are valuable parts of Dynamic Screening: Estimating a Man's No-Cancer Baseline PSA (PSAn) and Estimating the Probability of a No-Cancer Cause of Increasing PSA.

i. No-Cancer Baseline PSA (PSAn)

The Dynamic Analysis estimate of a man's no-cancer baseline PSA (PSAn) can be directly related to the estimate of his PSA from cancer (PSAc=PSA−PSAn).

One Prostate Volume Measurement—For most men with relatively short PSA test spans, Dynamic Analysis relies on prostate volume, primarily if available, and age to estimate PSAn. Median PSA increases with both age and prostate volume, however prostate volume explains most of the variation in PSA when both are considered together. Age alone can be used if prostate volume is not available, and prostate volume dominates the estimate if it is available.

Multiple Prostate Volume Measurements—Measurements over time allow Dynamic Analysis of a man's typically increasing PSA trend. An increasing prostate volume trend can be used to estimate an increasing PSA trend using a constant PSA density (PSAD=PSA/PV) or an increasing PSAD.

The graph 1100 of FIG. 11 shows four prostate volume measurements at five-year intervals for an extreme case of prostate enlargement. Prostate volume is shown on the left scale. Prostate volume starts at nearly 55 cc at age 50 and increases at a relatively fast 4% per year to 90 cc at age 65. PSA is shown on the right scale. The lowest dotted line shows the corresponding increasing PSA assuming a constant median PSA density of 4%. The middle dashed line shows the corresponding increasing PSA assuming a constant median PSA density of 5%. The top dashed line shows the corresponding increasing PSA assuming a constant median PSA density of 6%. The appropriate PSA density can be estimated at a relatively young age when PSA from progressing cancer is likely to be absent or small.

ii. Probability of a No-Cancer Cause of Increasing PSA

Dynamic Analysis of prostate volume can helps Dynamic Screening assess the probability that increasing PSA is caused by progressing cancer rather than a no-cancer condition. Substantially elevated PSA is a rare event, whether caused by progressing cancer or a no-cancer condition. The probability of elevated no-cancer PSA can increase with both age and prostate volume, however prostate volume explains most of the variation in elevated PSA when both are considered together. Dynamic Analysis uses one or more measurements of prostate volume, if available, and age to help estimate the probability that a no-cancer condition is the primary cause of increasing PSA. Age alone may be used if prostate volume is not available, and prostate volume dominates the estimate if it is available.

B. Dynamic Analysis of Biomarkers

In some embodiments, Dynamic Analysis uses the prostate-specific antigen (PSA), a biomarker commonly used to help identify prostate cancer. A central insight of Dynamic Analysis of PSA is that a man's PSA history contains valuable information about what may be occurring in his prostate that can be interpreted using appropriate methods. The graph in FIG. 2 shows PSA history typical of a man who died from prostate cancer, along with a fitted Dynamic Analysis trend. (Source of data: Baltimore Longitudinal Study of Aging.) Key Dynamic Analysis findings include that smooth, fast exponential growth in PSA above a no-cancer baseline may be a characteristic of progressing cancer; and that faster exponential growth may be characteristic of more deadly cancer. Thus, the method as described herein can use smooth, fast exponential growth in PSA above a baseline for early detection at very low PSA levels to allow effective treatment. Second, the invention as described herein may recommend no biopsy for patients with variable and/or slow growth in PSA to only moderate levels. In those cases, the increase in PSA may not be primarily caused by progressing cancer, so a biopsy may not be justified. Third, in patients with variable, moderate growth in PSA, the invention as described herein may justify a biopsy for some men if their PSA eventually reaches relatively high levels.

Dynamic Analysis of biomarkers depends on the accuracy of the biomarker test and the consistency among tests. Biomarker test results can vary because of the commercial brand used, the lab used to analyze the sample and other factors. In some embodiments, Dynamic Analysis calibrates or adjusts biomarker test results based on brand, lab or other information.

Retrospective dynamic analyses of PSA using a series of PSA test values from example patients are described in Example 1 discussed below.

Dynamic Analysis can be used to analyze multiple test result values, including multiple biomarkers, or one or more biomarkers combined with other test or treatment results.

Dynamic Analysis can be used to analyze for various characteristics including, but not limited to, PSA trends and PSA variation in order to estimate the probability of various prostate conditions as described in co-assigned U.S. patent application Ser. No. 13/442,648.

In one example, Dynamic Screening encompasses a method for estimating the probability of a prostate condition in a subject, comprising: a) obtaining a series of at least a first and a second PSA value from said subject, wherein the PSA values are measured in the subject at least a first and a second time; b) performing a Dynamic Analysis using a computer system, wherein said Dynamic Analysis comprises fitting said series of PSA values to a functional form equation to form a fitted trend over time and calculating a characteristic of said fitted trend, wherein said characteristic reflects PSA variation; and c) estimating the probability of said prostate condition by comparing said characteristic with results based on analysis of population data.

Performing said Dynamic Analysis may further comprise: calculating a tolerance range of said fitted trend; removing a PSA value from said series of PSA values that has a value outside said tolerance range, thereby forming a subseries of PSA values; and fitting said subseries of PSA values to a functional form equation to form a second fitted trend over time and calculating a characteristic of said second fitted trend; wherein estimating the probability of said prostate condition further comprises comparing said characteristic of said second fitted trend with results based on analysis of population data.

Calculating said characteristic of said fitted trend may comprise weighting the contribution of said first PSA value to said characteristic differently than the contribution of said second PSA value to said characteristic. Said first PSA value can be measured before said second PSA value, and said contribution of said first PSA value can be weighted less than said contribution of said second PSA value.

Calculating said characteristic of said fitted trend can comprise weighting the contribution of said first PSA value to said characteristic the same as the contribution of said second PSA value to said characteristic.

Dynamic Analysis may further comprise (d) selecting a target PSA value from said series of PSA values, wherein said target PSA value is measured at a target time; (e) calculating a trend PSA value based on said functional form equation for said target time; and (f) calculating a characteristic of said trend PSA value, wherein said characteristic reflects a comparison of said trend PSA value and said target PSA value, and wherein estimating the probability of said prostate condition further comprises comparing said characteristic of said trend PSA value with results based on analysis of population data. The characteristic of said trend PSA value may comprise a difference between said trend PSA value and said target PSA value. The characteristic of said trend PSA value may comprise the difference between said trend PSA value and said target PSA value, divided by said trend PSA value.

Dynamic Analysis may further comprises d) obtaining a third PSA value, wherein said third PSA value is measured in the subject at a third time, wherein said third time is subsequent to said at least first and second times; e) projecting said fitted trend using said computer system to said third time to calculate a projected PSA value at said third time; and f) calculating a characteristic of said projected PSA value, wherein said characteristic reflects a comparison of said projected PSA value and said third PSA value, and wherein estimating the probability of said prostate condition further comprises comparing said characteristic of said projected PSA value with results based on analysis of population data. The characteristic of said projected PSA value may comprise a difference between said projected PSA value and said third PSA value. The characteristic of said projected PSA value may comprise the difference between said projected PSA value and said third PSA value, divided by said projected PSA value.

In another example, Dynamic Analysis encompasses a method for estimating the probability of a prostate condition in a subject, comprising: a) obtaining a series of at least two PSA values from said subject, wherein the PSA values are measured in the subject at least two different times; b) performing a Dynamic Analysis using a computer system, wherein said Dynamic Analysis comprises fitting said series of PSA values to a functional form equation to form a fitted trend over time; c) selecting a target PSA value from said series of at least two PSA values, wherein said target PSA value was measured at a target time; d) calculating a trend PSA value based on said functional form equation for said target time; e) calculating a characteristic of said trend PSA value, wherein said characteristic reflects a comparison of said trend PSA value and said target PSA value; and f) estimating the probability of said prostate condition by comparing said characteristic of said trend PSA value with results based on analysis of population data. The characteristic of said trend PSA value may comprise a difference between said trend PSA value and said target PSA value. The characteristic of said trend PSA value may comprise the difference between said trend PSA value and said target PSA value, divided by said trend PSA value.

In another example, Dynamic Analysis encompasses a method for estimating the probability of a prostate condition in a subject, comprising: a) obtaining a series of at least a first and a second PSA value from said subject, wherein the PSA values are measured in the subject at least a first and a second time; b) performing a Dynamic Analysis using a computer system, wherein said Dynamic Analysis comprises fitting said series of PSA values to a functional form equation to form a fitted trend over time; c) obtaining a third PSA value, wherein said third PSA value may be measured in the subject at a third time, wherein said new time may be subsequent to said at least first and second times; d) projecting said fitted trend using said computer system to said third time to calculate a projected PSA value at said third time; e) calculating a characteristic of said projected PSA value, wherein said characteristic reflects a comparison of said projected PSA value and said third PSA value; and f) estimating the probability of said prostate condition by comparing said characteristic of said projected PSA value with results based on analysis of population data.

Performing said Dynamic Analysis may further comprise calculating a tolerance range of said fitted trend; removing a PSA value from said series of PSA values that has a value outside said tolerance range, thereby forming a subseries of PSA values; and fitting said subseries of PSA values to a functional form equation to form a second fitted trend over time and calculating a characteristic of said second fitted trend; wherein estimating the probability of said prostate condition further comprises comparing said characteristic of said second fitted trend with results based on analysis of population data.

The characteristic of said projected PSA value may comprise a difference between said projected PSA value and said new PSA value. The characteristic of said projected PSA value may comprise the difference between said projected PSA value and said new PSA value, divided by said projected PSA value.

Said prostate condition may be selected from the group consisting of: prostatitis, benign prostate hyperplasia, prostate cancer, and no prostate disease. Said subject may be a human. Said computer system may comprise a device for network communication, a storage unit, and a processor. The functional form equation may take the form of PSA(t)=PSAn+M*e (PSAgr*t), wherein t is the time, PSAn is a constant reflecting baseline PSA, M is a constant multiplier, and PSAgr is a constant reflecting the exponential growth rate of PSA due to cancer.

In another example, Dynamic Analysis may encompass a computer implemented method for analyzing the results of at least two PSA tests for a subject, comprising: a) obtaining a series of at least two PSA values from said subject, wherein the PSA values are measured in the subject at at least two different times; and b) performing a Dynamic Analysis using a computer system; wherein said Dynamic Analysis comprises fitting said series of PSA values to a functional form equation to form a fitted trend over time; wherein the functional form equation takes the form of PSA(t)=PSAn+M*e (PSAgr*t), and wherein t is the time, PSAn is a constant reflecting baseline PSA, M is a constant multiplier, and PSAgr is a constant reflecting the exponential growth rate of PSA due to cancer; and c) outputting the fitted trend on by an output device.

Said computer system may comprise a computer program product stored on a non-transient computer medium, wherein said computer program product comprises computer-readable instructions for performing said Dynamic Analysis. Obtaining said series of PSA values may comprise obtaining at least three PSA values from said subject, wherein the PSA values are measured in the subject at at least three different times. PSAn may be calculated based on analysis of population data.

i. Strength of PSA Evidence

The strength of a man's PSA evidence may depend on the Test Span, the Number of tests and the Distribution of those tests. Dynamic Analysis of Free PSA and other biomarkers can augment Dynamic Analysis of PSA tests.

a. Test Span

Test span may comprise a measure of the time period over which a man's PSA has been measured. Typically, it is measured from first the PSA test under consideration. For clinical use the PSA test under consideration is usually the most recent PSA test. For research, the PSA test under consideration can vary depending on the nature of the research, including the last test before diagnosis, the last test before a biopsy or any one of a man's past PSA tests.

Our research has shown that the longer the test span the stronger the results. A main reason for stronger results may be the increased stability of the trends estimated using longer test spans. The extreme example may be a pair of PSA tests drawn at the same time with the same result. No meaningful trend can be fit to the results. A trend can be fit through two tests a few days apart, but variation in each test can be large compared to the underlying long-term trend. Trends estimated using a short test span can vary dramatically from the underlying trend. Longer test spans allow larger changes in the underlying trend to appear through the noise of individual test variation. Longer test spans allow better estimation of a man's no-cancer baseline PSA (PSAn).

b. Number of Tests and Their Distribution

More tests and more evenly distributed tests can provide more information about underlying trends and produce stronger results. Of course, with annual testing the Number of PSA tests may be directly related to the Test Span and in general more tests are likely for longer Test Spans, but not always.

Every test may have the opportunity to provide information about the underlying trend that may reflect progressing cancer or provide information through variable PSA that may suggest prostatitis or other no-cancer condition rather than progressing cancer. Therefore, more tests may lead to stronger results used by Dynamic Screening.

PSA tests evenly distributed over a test span carry more information than the same number of tests that are not evenly distributed. Consider two men with four year Test Spans. The first has five evenly spaced annual tests. The second has one test and then no tests for almost four years with the final four tests over a three-month period prior to biopsy. Evenly distributed tests provide more valuable independent information than the same number of tests bunched together with less independent information. Closely bunched tests do not allow enough time to pass permit the substantial changes in PSA needed to estimate long-term trends accurately.

In some embodiments, average test period is the measure of the average time between tests, which may be a measure of the distribution of tests. Two tests over a one-year test span have an average test period (ATP) of 1 year or 12 months between tests. Three tests over a two-year test span also have an average test period (ATP) of 1 year or 12 months between tests.

In some embodiments, the formula is:

ATP=TS/(NT−1)

However, some men may have two or more PSA test very close together before the diagnosis of cancer. For example, many urologists will test quickly after a high PSA test to help confirm its repeatability. In this case average test period overstates the effective amount of PSA testing for Dynamic Screening.

In some embodiments, to compensate we calculate average adjusted test period (AATP). The formula is:

AATP=TS/(NT−1−Adj1−Adj2,etc.)

Where Adj1=(ATP−ActualTP)/ATP

Actual Time Period (ActualTP) is only calculated for time periods less than average (ATP). If ActualTP is zero (two tests on the same date) the Adj1=1.0 and (in effect) one test is removed from AATP. If all the ActualTP equal ATP then there may be no adjustments and AATP=ATP.

For tests 2 through n, Adj (n) is computed only if the time period since the previous test is less than the average test period, otherwise Adj(n) is zero.

ii. Dynamic Selection of Functional Forms

In some embodiments, Dynamic Analysis of PSA starts with the estimation of a consistent trend using a functional form that may vary depending on the information available and the circumstances of the subject. While many trend equations may be possible and different equations may be suitable for different situations, often the best combination of power and simplicity is an exponential plus constant functional form:

PSA(t)=PSAn+PSAc(t)

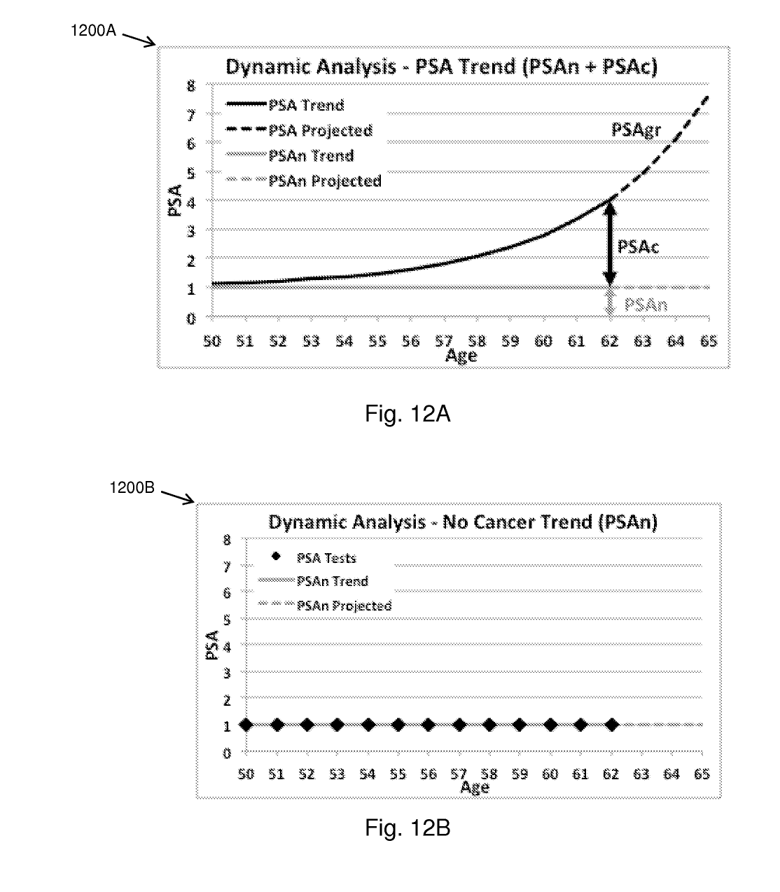

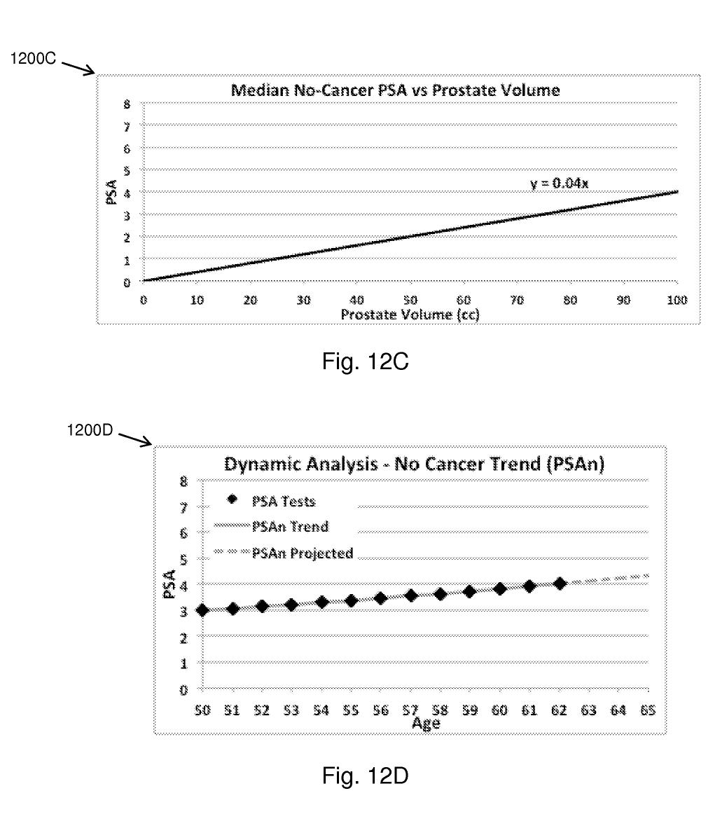

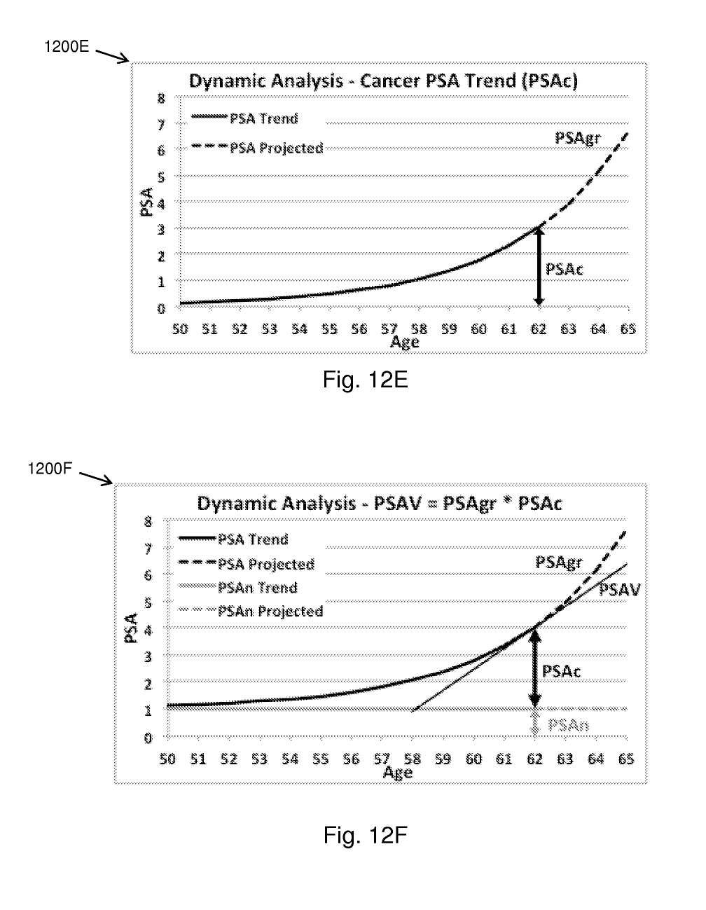

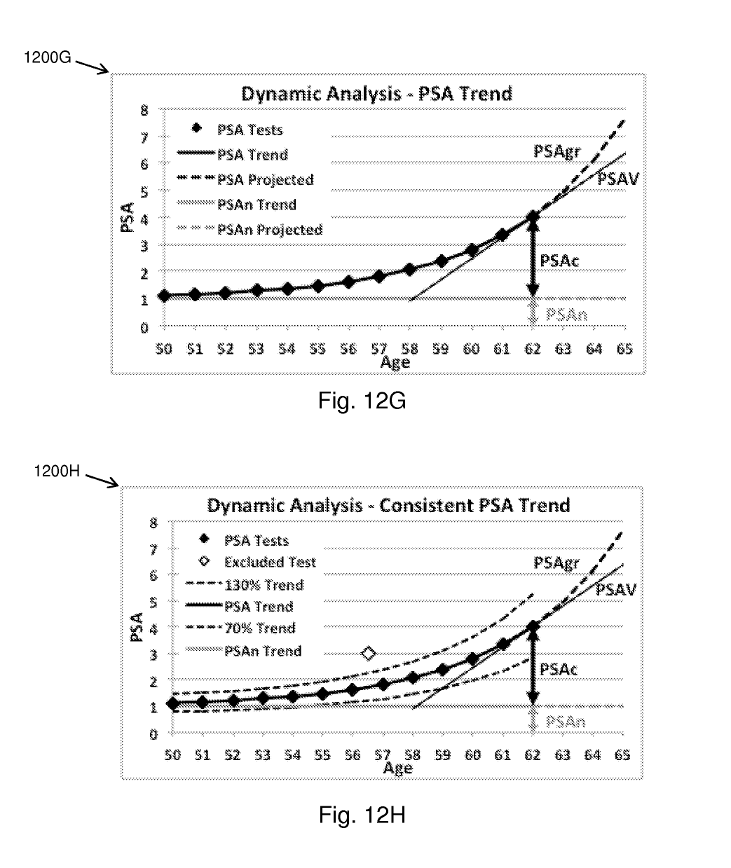

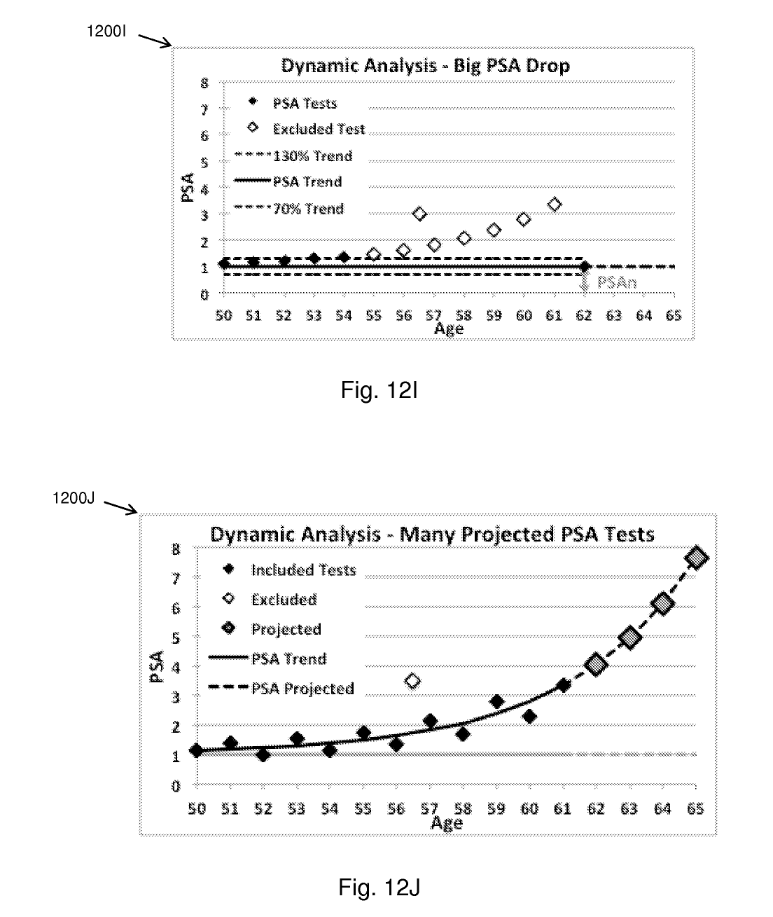

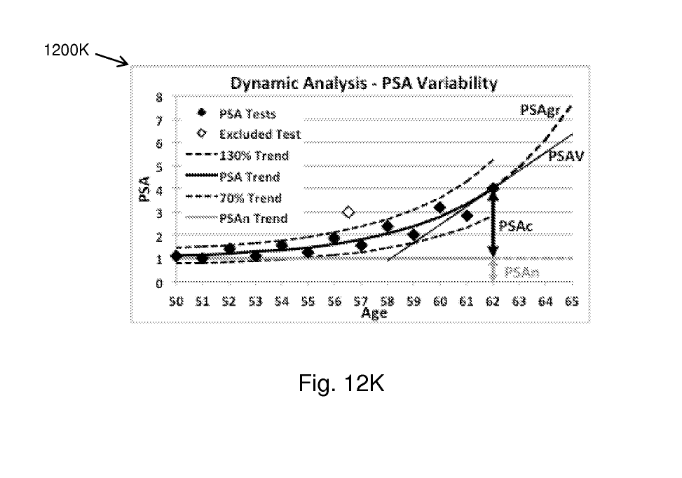

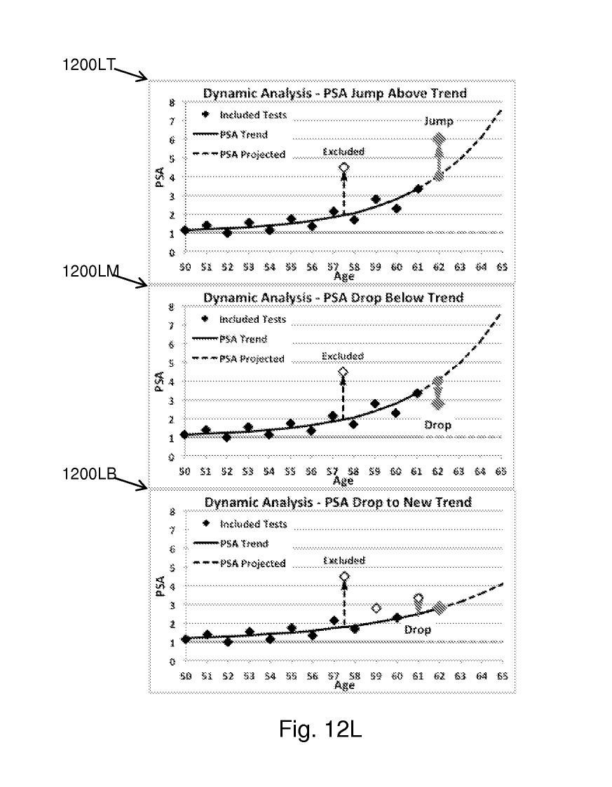

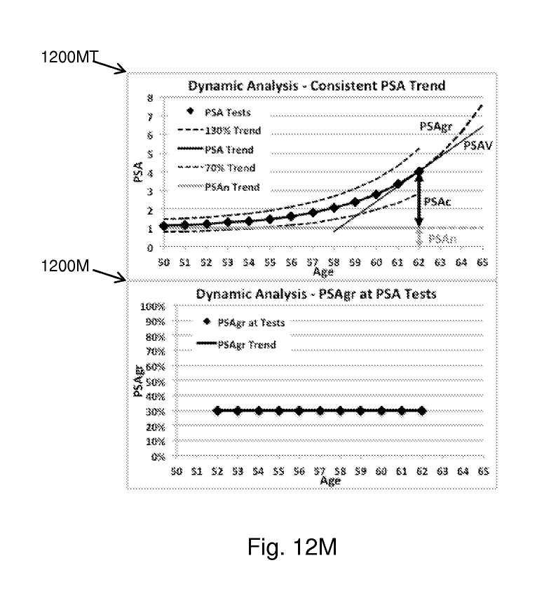

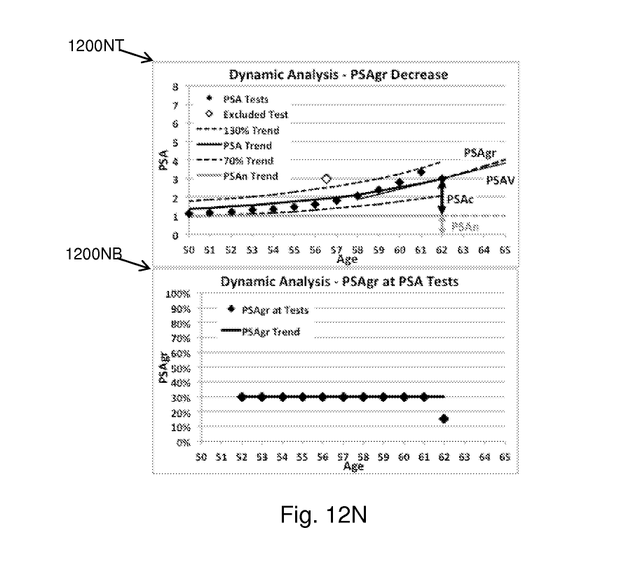

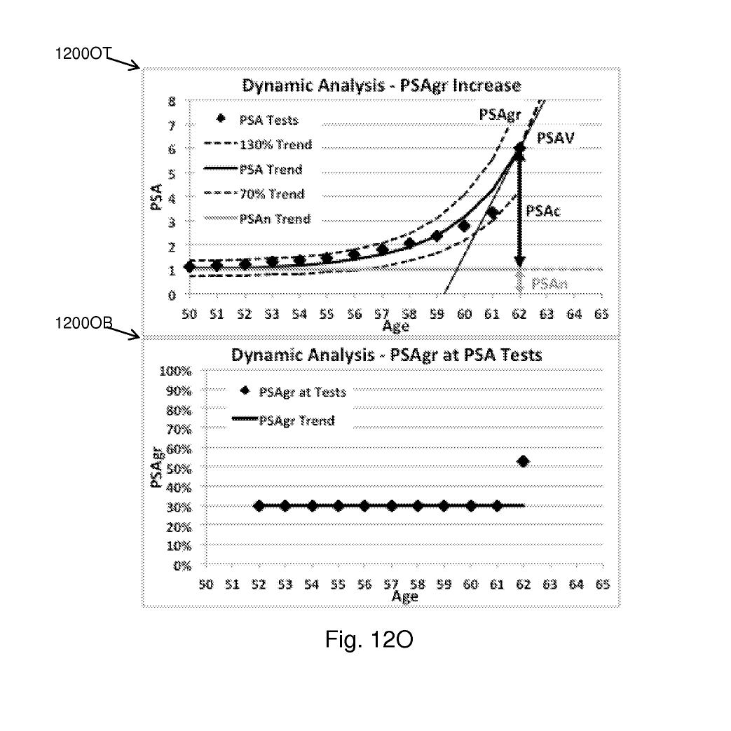

PSA(t)=PSAn+M*EXP(PSAgr*t)

where PSAn is an estimate of the no-cancer baseline, PSAc(t) is an estimate of exponential growth in PSA from cancer, M is a multiplier, and PSAgr is the annual exponential growth rate. PSA Velocity (PSAV) is the slope of PSA(t) or PSAc(t). Where PSAV(t)=dPSAc(t)/dt, PSAgr=PSAV(t)/PSAc(t) and PSAV(t)=PSAgr*PSAc(t). A consistent trend is solved for by iteratively excluding anomalous past tests. The graph 1200A of FIG. 12A shows the key elements of a PSA trend and projections.

a. Constant

In some embodiments, a constant functional form is appropriate for a single PSA test. It can be used when PSA drops from previous higher tests.

b. Line

In some embodiments, a linear functional form can be used for two tests, whether increasing or decreasing, and for multiple tests when PSA is constant or slowly increasing in a roughly linear pattern.

c. Exponential Plus Constant

In some embodiments, the best combination of power and simplicity can be an exponential plus constant functional form:

PSA(t)=PSAn+PSAc(t)

PSA(t)=PSAn+M*EXP(PSAgr*t)

Where PSAn is an estimate of the no-cancer baseline, PSAc(t) is an estimate of exponential growth in PSA from cancer, where M is a multiplier and PSAgr is the annual exponential growth rate. PSA Velocity (PSAV) is the slope of PSA(t) [and PSAc(t)], where PSAgr=PSAV/PSAc(t).

d. More Complex PSAn(Age, PV, Etc.)

In some embodiments, PSAn(Age, Prostate Volume) may be described by a functional form more complicated than a simple constant, including:
Line
Exponential
Exponential Plus Constant
Quadratic

Where PSAn(Age) varies by age as a function of other variables such as age, prostate volume and other variables. This functional form for PSAn(Age) must be combined with (or added to) the function form for PSA from cancer (PSAc), which is often exponential.

e. Discontinuous Functions

In some embodiments, Dynamic Analysis may choose to combine two discontinuous functional forms for use at one point in time for one man. For example, an exponential plus constant functional form may fit a man's data well up to Differential Treatment for prostatitis with anti-inflammatory meds and antibiotics. After Differential Treatment, a decreasing exponential function my fit the same man's data well. In a similar fashion, after a TURP or other treatment for BPH prostate enlargement a man's PSA trend may drop sharply to a new lower level. In this case, Dynamic Analysis may fit a different function to the before and after treatment PSA data, perhaps using a different functional form.

f. Decreasing Exponential

In some embodiments, Dynamic Analysis may fit a decreasing exponential function from a high previous test to a new lower baseline to a segment of a man's PSA history. This functional form may be appropriate during the time period of decreasing PSA after Differential Treatment for prostatitis using anti-inflammatory medication and antibiotics.

g. Other Functional Forms

In some embodiments, Dynamic Analysis can use other functional forms, where appropriate. For example, quadratic or other power functions can be used instead of the exponential function.

iii. No-Cancer Baseline PSA (PSAn)

In some embodiments, Dynamic Analysis uses a constant no-cancer baseline PSA (plus exponential for cancer) because it reflects the nearly flat median PSA for U.S. men and because it avoids the problem of distinguishing increasing PSA caused by progressing cancer from increasing PSA caused by no-cancer conditions such as prostatitis and BPH. See graph 1200B of FIG. 12B.

More advanced versions of Dynamic Analysis include learning or feed-back based systems that adapt the methods used to the increasing amount of information available over time. For example, a single prostate volume measurement can cause Dynamic Analysis to change from a no volume measurement mode and use the prostate volume measurement when estimating the no-cancer baseline PSA (PSAn) and the probability of a non-cancer cause of increasing PSA.

For example, the graph 1200C of FIG. 12C shows the Mayo Clinic's Olmsted County median no-cancer PSA vs. prostate volume. The linear equation can be used with estimates of the man's current prostate volume, or most recent measurement, or trends from a series of measurements to estimate an increasing PSAn trend, as shown in FIG. 12D.

iv. Estimated PSA from Cancer (PSAc)

In some embodiments, Dynamic Analysis uses an exponential function to estimate the increasing PSA from progressing cancer (PSAc) above the no-cancer baseline (PSAn). The primary reasons to choose a two parameter exponential function can be: 1) its relative simplicity; 2) its very good fit to the PSA data for most progressing cancers; and 3) the accuracy of exponential trend projections into the future. In contrast, an equally simple two parameter linear function that is often used to estimate PSA Velocity does not fit the PSA data as well for most progressing cancers and systematically under-forecasts future PSA levels, which can be a drawback for Dynamic Screening. Other more complex functions can be used to estimate PSAc, including quadratic and higher power functional forms.

a. PSAc Trend

In some embodiments, the graph of 1200D of FIG. 12E shows a typical trend for PSA produced by progressing cancer, and its projection. The functional form is:

PSAc(t)=M*EXP(PSAgr*t)

where M is a multiplier and PSAgr is the annual exponential growth rate.

b. PSA Velocity (PSAV)

PSA Velocity (PSAV) is commonly used to describe the annual rate of change in PSA. In some embodiments, as shown on the graph 1200E of FIG. 12F, Dynamic Analysis calculates PSAV as the slope of PSA(t) [and PSAc(t)]. Please note the relationships among PSAV, PSAgr and PSAc:

PSAV(t)=PSAgr*PSAc(t)

PSAgr=PSAV(t)/PSAc(t)

For Dynamic Analysis, PSAV may be the slope of the line tangent to the PSA trend at any given point in time. Trend PSAV can be based on the trend that considers all the PSA data and may not be the more simplistic change between two PSA tests.

It can be possible to think of PSAgr as PSAV normalized (or scaled) by PSAc (PSAgr=PSAV/PSAc). PSAgr may be valuable because it may consistently describes the characteristic rate of growth for the cancer at all points in time in contrast to PSAV(t) which increases over time. PSAgr and PSAc(t) can be thought of as “orthogonal” (with low correlation) and may be easier to distinguish statistically. In contrast, PSAV(t) increases as a function of time in proportion to PSAc(t) for a given PSAgr. Therefore, PSAV(t) can be much harder to distinguish statistically from PSAc(t) because of their high correlation.

c. Quadratic Functional Form for PSAc

In some embodiments, a quadratic functional form is an alternative to the exponential function. For example:

PSAc(t)=A*t̂2+B*t

The quadratic function does not fit the data as well as the exponential form, underestimates PSAgr (30% low) and under-projects the future PSAc trend. Other functional forms can be considered by Dynamic Analysis, including higher order power functions.

v. Estimated PSA Trend (PSAn+PSAc)

In some embodiments, Dynamic Analysis estimates the exponential plus constant function that best fits the PSA tests and typically includes the last PSA test. The overall PSA trend is the sum of PSAc and PSAn using the functional form:

PSA(t)=PSAn+PSAc(t)

PSA(t)=PSAn+M*EXP(PSAgr*t)

a. Best-Fit PSA Trend Estimation

In some embodiments, Dynamic Analysis uses standard “least-squared error” methods to minimize the sum of the squared errors (deviation of PSA tests from trend) to estimate the best-fit PSA trend. The graph 1200G of FIG. 12G shows the best-fit PSA trend for a “perfect” set of PSA tests. In this case, the sum of the squared errors is zero and the R̂2 measure of goodness of fit is 1.0 (or 100%). Other methods of best-fit estimation can be used by Dynamic Analysis.

b. PSA Trends that Include the Last PSA Test

In some embodiments, Dynamic Analysis includes the last PSA test in the PSA trend. This trend behavior may be imposed by constraining trend PSA to equal the last PSA test at the time of the last test. For a variety of reasons discussed below, we chose this constrained approach over an unconstrained approach where the value of the current trend PSA may be greater or less than the last PSA test. However, unconstrained PSA trends can be used by Dynamic Screening with two “current” PSA levels: actual and trend.

Projection accuracy may be the primary reason to include the last PSA test in the estimated trend. The last test may be the best starting point for accurate projections of exponentially growing PSA into the future, and accurate projections may be an important part of Dynamic Screening.

Simplicity and clarity of communication with doctors and men may be major reasons to fit the PSA trend through the last PSA test. It can be much easier to describe “current” PSA when trend PSA equals the last PSA test. When they differ, we must explain what each one means and the significance of the difference for decision-making Responsiveness to new information can be an important advantage of trends constrained to include the last PSA test. Unexpected increases or decreases in PSA may carry valuable information that should immediately affect the estimated trend. Trends through the last PSA test respond fully immediately, while unconstrained trends lag in terms of responsiveness. Most troubling, the lag in responsiveness increases with more past PSA tests over a longer period (trend response becomes more sluggish the more PSA history available).

vi. Consistent PSA Trend

In some embodiments, Dynamic Analysis estimates consistent PSA trends by iteratively excluding anomalously high PSA tests one at a time until all PSA tests included for estimation are within a tolerance range of the final trend.

In some embodiments, Dynamic Analysis is used to produce a consistent trend by removing aberrant data values. Some diagnostic tests have high variability due to variability in the severity of non-cancer conditions, including PSA tests, which can result in abnormally high PSA values. One of the advantages of Dynamic Analysis may be the ability to quantitatively identify outliers for exclusion. In the graph 1200H of FIG. 12H, a hypothetical set of PSA test results is used to generate a fitted trend, wherein all PSA results outside a 30% tolerance range are excluded from the final fitted trend.

a. Exclude Anomalously High PSA Tests

Typically, there is relatively modest variation in a man's PSA level from test to test. However, prostatitis caused by infection and/or inflammation can cause temporary increases in PSA that can sometimes be very large. Typically, these temporarily high PSA tests are followed by lower PSA tests. In an embodiment, Dynamic Analysis systematically excludes past temporarily high PSA tests from the estimation of consistent trends because they seldom reflect PSA from progressing cancer and distort the process of estimating the underlying PSA trends that might convey information about progressing cancer.

Sometimes there only one, or a few, isolated past anomalously high PSA tests. The graph 1200H of FIG. 12H shows a consistent trend through the (black diamond) PSA tests that are consistent with that trend. The high and low dashed curves show the +/−30% tolerance range around the consistent trend. In some embodiments, an appropriate tolerance range is probably in the +/−20% to +/−30% range that reflects normal variation in PSA. The first trend, not shown, is very similar to the consistent trend. The 3.0 PSA test at age 56.5, shown by the hollow diamond, was outside of the tolerance range and excluded from consideration for the second iteration of trend estimation. The second iteration trend is shown, and it is consistent because no PSA tests included in the estimation are outside the tolerance range for that trend.

Sometimes increasingly severe prostatitis causes an increasing pattern of PSA tests that appears to be a trend until discredited by a drop in PSA. The graph 1200I of FIG. 12I shows an extreme example of a low PSA test that “drags” the consistent trend down and forces the exclusion of all the recently increasing PSA tests, which have been revealed to have been caused by prostatitis and/or BPH with reasonably high confidence. In this case, the last PSA test “drags” the consistent trend down to it exactly because of the last test constraint. The tolerance range may be “dragged” down by the new flat trend and forces the iterative exclusion of each of the anomalously high past tests until a consistent trend is reached with all included test within the tolerance range.

b. Include All Low PSA Tests

Typically, low PSA tests are less influenced by prostatitis and more likely to reflect an underlying trend that may include PSA from progressing cancer. In some embodiments, Dynamic Analysis includes all low PSA tests in the estimation of consistent PSA trends.

vii. PSA Trend Projections

In some embodiments, Dynamic Analysis projects PSA trends into the future for use by Dynamic Screening to compare the benefits of continued Active Monitoring vs. Biopsy Now, to help determine the optimal timing of medical actions with lead times and to estimate the magnitude of unexpected Jumps and Drops.

a. 1 Year Projected PSA Test

In some embodiments, Dynamic Analysis projects PSA 1 year into the future (or other conveniently short time period) as a first step in estimating the risk of cancer death after 1 year of Active Monitoring.

b. Many Projected PSA Tests

In some embodiments, Dynamic Analysis projects PSA to one or more future times, as shown on the graph 1200J of FIG. 12J, as a first step to determining the optimal timing for a biopsy and the corresponding optimal time for other medical actions, such as more frequent PSA tests, a prostate volume measurement and Differential Treatment for prostatitis followed by sufficiently long Active Monitoring for subsequent PSA trend deceleration prior to biopsy. Benefit-cost analysis can be performed by Dynamic Screening at each future projected PSA test in order to help determine optimal timing of medical actions based on current information and “what if” scenarios, such as a “small” prostate volume and no deceleration in PSA after Differential Treatment.

The biggest medical action lead-time may be the roughly one year of monitoring of PSA for deceleration after Differential Treatment for prostatitis that should occur before a biopsy is considered. However, prostate volume and even PSA tests can have substantial lead-times from first appointment to scheduling the action to performing the action to getting the results to discussing the results and making a decision about the next medical action.

viii. PSA Variation Around the Trend

For increasing PSA primarily produced by progressing cancer, PSAc and PSAgr may be strong predictors of cancer death after diagnosis and treatment. For these deadly cancers, PSA typically increases with smooth exponential growth above a baseline. However, increasing PSA also can be primarily produced by no-cancer conditions with minimal risk of subsequent cancer death. These no-cancer conditions, primarily prostatitis and BPH, often cause increasing PSA with more variation than is typical of progressing cancer. Therefore, PSA variation around a PSA trend may be an indicator of the probability that progressing cancer may be the primary cause of increasing PSA. Smooth exponential growth in PSA above a baseline has the highest probability of progressing cancer as the cause. Greater variability around an increasing PSA trend may be associated with lower probability of progressing cancer as the cause (and higher probability of a no-cancer condition). A decelerating trend (or even a linear trend) can be also associated with lower probability of progressing cancer as the cause (and higher probability of a no-cancer condition).

The graph 1200K of FIG. 12K shows PSA variability around an exponential plus constant trend with one excluded test and moderate variability of other tests around the trend. There are multiple ways of measuring variability around the trend.

a. Average Absolute Percentage Deviation

Average absolute percentage deviation can be calculated in several ways.

In some embodiments, a simple average is used to calculate average absolute percentage deviation. The percentage deviation of each PSA test from the consistent trend may be calculated and then the sign may be removed by taking the absolute value of each deviation. Next the absolute percentage deviations may be summed and then divided by the number of tests to calculate average absolute percentage deviation. The last PSA test can be excluded from the calculation when the trend is constrained to go through that point.

In some embodiments, a weighted average is used to calculate average absolute percentage deviation. For example, the simple average can be modified by weighting recent history more heavily that more distant history—discounting the past, in effect.

In some embodiments, a simple or weighted average can be calculated over various time periods. For long PSA histories, average absolute percentage deviation can be calculated for various time periods that are short than the test span, including a most recent time period such as the last three years and most distant time period such as the first five years.

b. Other Measures of Deviation

A variety of other measures of (sometimes weighted) deviation can be considered, including:
Absolute percentage deviation (as noted).
Absolute deviation.
Squared deviation.
Any other measure of deviation known in the art.

ix. PSA Jumps and Drops

Dynamic Analysis may generate a trend such as for the variation of one or more PSA values, or PSA variability, as described herein and as further described in co-assigned U.S. patent application Ser. No. 13/442,648.

PSA variability can refer to the variation of a single PSA value from a trend, such as a Jump or Drop or a projected Jump or Drop. PSA variability can refer to PSA variation (PSAvar), which reflects variation of a PSA data set from the trend generated from that data set. Further analysis according to the methods of the invention described herein, the full contents of which is incorporated herein by reference, may find that PSA variability can help distinguish between increasing PSA caused by progressing cancer and by other causes. It may be suggested in at least some instances that PSA from cancer tends to grow exponentially more smoothly than PSA from prostatitis. The back and forth battle between infection and/or inflammation and a body's defenses may cause PSA to bounce up and down and often causes variability around an increasing trend. As used herein, smoothness refers to low variability. In some embodiments, smooth PSA growth refers to PSA values that increase with low variation with respect to a fitted trend. In some embodiments, smooth PSA growth refers to few or no significant Jumps or Drops in the data set with respect to a fitted trend.

In some embodiments, an unexpected jump or drop in the next PSA test value is incorporated into Dynamic Analysis or screening as an indication that the patient does not have cancer. For example, an unexpected jump in PSA value that is not consistent with the PSA trend generated by Dynamic Analysis of prior tests may likely be caused by a non-cancer condition, such as prostatitis. This may be similar to an inconsistently high PSA value measured previously, which Dynamic Analysis can exclude from the fitted trend. A hypothetical series of PSA values including both an excluded PSA value and an example PSA jump is depicted in FIG. 12L Top 1200LT.

a. Jump from Previous Trend

In some embodiments, the projection of the trend from the previous test to the time of the last test provides a reference from which an absolute and percentage Jump can be calculated, as shown on FIG. 12L Top 1200LT. A Jump in PSA above the previous trend should be viewed with caution in a clinical setting. It is often an indication of a no-cancer condition, such as prostatitis, suddenly increasing in severity. However, it can be an indication of accelerating PSA from cancer. In response, a doctor might order another PSA test to confirm the Jump or might order Differential Treatment for prostatitis with anti-inflammatory meds and antibiotics followed by Active Monitoring with subsequent PSA tests. Past PSA variability and past Jumps or Drops may affect the doctor's course of action. For example, substantial past variability and Jumps and Drops suggest a no-cancer condition may be the cause of the latest Jump and extra caution is warranted before considering a biopsy.

b. Drop from Previous Trend

In some embodiments, the projection of the trend from the previous test to the time of the last test provides a reference from which an absolute and percentage Drop can be calculated, as shown on FIG. 12L Middle 1200LM. However, there may be times when PSAgr and projected PSAc can be unreasonably high. A Drop in PSA can be a strong indicator that previously increasing PSA was caused by a no-cancer condition and a biopsy is not warranted. The doctor may consider follow-up PSA tests to confirm the drop and may even consider anti-inflammatory meds and/or antibiotics to try to drive PSA down further an minimize the possible infection and/or inflammation.

c. Trend Drop from Previous Test

There may be times when PSAgr and projected PSAc can be unreasonably high. For unreasonably high PSAgr trends, any reasonable last PSA test can appear to be a large drop from the trend projected from the previous PSA test, as shown on FIG. 12L Bottom 1200LB. In some embodiments, there is another way of measuring a Drop in the last PSA test that avoids this problem that uses the new PSA trend as the reference rather than the previous trend. The Drop measurement starts with the high penultimate test and measures the Drop down to the new trend, as shown on the graph. The Drop in the new trend can be calculated by subtracting the value of the new trend at the time of the previous PSA test from the value of that previous PSA test, as suggested by FIG. 12L Bottom 1200LB.

x. PSAgr Stability

For deadly cancers, PSA typically increases with smooth exponential growth above a baseline. The pattern of PSAgr over time carries information about the probability of progressing cancer and no-cancer conditions. In some embodiments, a stable (constant) PSAgr trend may be an indicator of progressing cancer. Variable PSAgr may be an indicator of a no-cancer condition. A drop in PSAgr may be an indicator of a no-cancer condition. A jump in PSAgr may be a reason to be cautious until the new, higher PSAgr may be confirmed by subsequent PSA tests and trends. High PSAgr trends may be somewhat unusual, and very high PSAgr trends may be very unusual with extremely high PSAgr trends likely to be false and not last to the next PSA test. Ideally, high PSAgr trends may be confirmed by one or more subsequent PSA tests before the newly stable trends are used for analysis, projections and decisions.

a. Stable PSAgr

In some embodiments, smooth exponential growth is characterized by stable PSAgr over time, where PSAgr(t)=PSAgr that is constant over time. FIG. 12M Top 1200MT shows smooth exponential growth in PSA over time, and FIG. 12M Bottom 1200MB shows the corresponding constant PSAgr. Unstable PSAgr(t) may be characterized by unexpected increases and decreases that may be the result of variation in a few PSA tests over a short period or may be an indicator of a no-cancer condition.

b. Drop in PSAgr

Often a drop in PSAgr after a long period of past PSAgr stability suggests that the past increases in PSA were caused by a no-cancer condition. FIG. 12N Top 1200NT shows smooth exponential growth in PSA over time followed by a Jump, and FIG. 12N Bottom 1200NB shows the corresponding constant PSAgr followed by a jump in PSAgr. In some embodiments, a drop in PSAgr can be a strong indicator that previously increasing PSA was caused by a no-cancer condition and a biopsy is not warranted. The doctor may consider follow-up PSA tests to confirm the drop and may even consider anti-inflammatory meds and/or antibiotics to try to drive PSA down further an minimize the possible infection and/or inflammation.

c. Jump in PSAgr

A jump in PSAgr may be more ambiguous than a drop. FIG. 12O Top 12000T shows smooth exponential growth in PSA over time followed by a Jump, and FIG. 12O Bottom 12000B shows the corresponding constant PSAgr followed by a jump in PSAgr. In some embodiments, a jump in PSAgr after a long period of past PSAgr stability suggests that the past increases in PSA were caused by a no-cancer condition. Sometimes a jump in PSAgr may be a natural outcome of Dynamic Analysis trying to fit successive trends to PSA increasing at an accelerating rate. A jump in PSAgr above the previous trend should be viewed with caution in a clinical setting. It is often an indication of a no-cancer condition, such as prostatitis, suddenly increasing in severity. However, it can be an indication of accelerating PSA from cancer. In response, a doctor might order another PSA test to confirm the jump in PSAgr or might order Differential Treatment for prostatitis with anti-inflammatory meds and antibiotics followed by Active Monitoring with subsequent PSA tests. Past PSA variability and past Jumps or Drops may affect the doctor's course of action. For example, substantial past variability and Jumps and Drops suggest a no-cancer condition may be the cause of the latest Jump and extra caution is warranted before considering a biopsy.

C. Dynamic Analysis of Tumor Variables

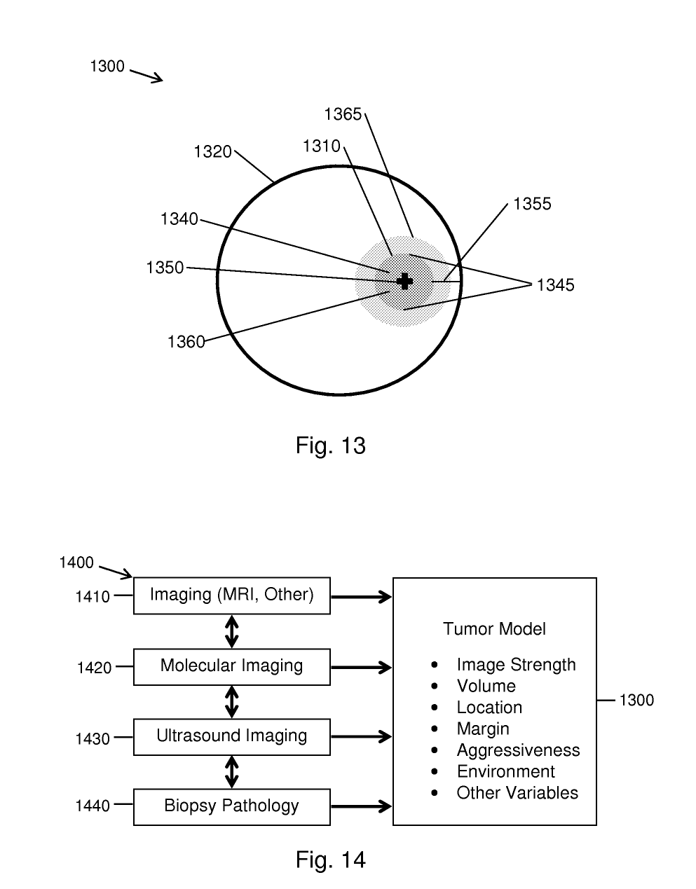

Combinations of the results of one or more methods of imaging, molecular imaging, ultrasound imaging, or biopsy pathology can be used to create a model 1300 of the cancer tumor 1310 and the prostate organ 1320 within it may exist, as shown on FIG. 13. In some embodiments, molecular imaging can be used initially to create a tumor model with variables that might include: image strength 1340, volume 1345, location 1350, margin 1355, aggressiveness 1360, and environment 1365. In an embodiment, the initial tumor model based on imaging can be enhanced by ultrasound imaging used to help guide biopsy needles (perhaps using Artemis technology) and by the pathology results, where the locations of cancer cells may be identified using ultrasound imaging.

The tumor model 1300 can be developed using input from imaging 1410, molecular imaging 1420, ultrasound imaging 1430, and biopsy pathology 1440, as shown by flow chart 1400 FIG. 14.

Two or more time dependent versions of the tumor model based on imaging and pathology allow Dynamic Analysis estimation of image-based tumor image strength, volume, location, margin, aggressiveness and environment trends. Along with PSA trends and prostate volume (trends), image-based tumor image strength, volume, location, margin, aggressiveness and environment trends can be used to help make better estimates of the probability and severity of progressing cancer and better assess possible next medical actions.

In some embodiments, Dynamic Screening incorporates the results of one or more imaging sessions over time that may encompass molecular imaging. If cancer has been discovered, molecular imaging, or imaging that is not molecular, can help locate the tumor, determine its image strength, measure tumor volume and tumor growth, determine the tumor's distance from the prostate capsule (tumor margin), estimate aggressiveness, assess the environment surrounding the tumor and, perhaps most importantly, help identify new tumors in the prostate. In some embodiments, Dynamic Screening uses a molecular image or set of molecular images taken at one time to help estimate a probability that progressing cancer is the primary cause of increasing PSA. Multiple imaging results (e.g. taken over different times) can also be incorporated into Dynamic Screening analysis. If multiple molecular imaging results are used, Dynamic Analysis can be used to estimate, for example, tumor volume, tumor margin, or aggressiveness trends.

Molecular imaging methods may be evolving rapidly and may increasingly more able to identify prostate cancer tumors and to estimate the aggressiveness of the tumor. However, molecular imaging can be expensive, often using MRI or PET scans, especially relative to other medical actions described herein. Therefore, in some embodiments, molecular imaging tests may be delayed until strongly justified by increasing prostate cancer risk. In some embodiments, molecular imaging is used in Dynamic Screening after Dynamic Analysis of other test results has identified high risk patients that might benefit from molecular imaging to decide whether to biopsy for prostate cancer.

In some embodiments, multiple biopsies can be analyzed by Dynamic Analysis. Biopsy results can be combined with imaging results to estimate Tumor Variables and their significance. For example, molecular imaging can identify what appears to be a prostate cancer tumor with estimates of Tumor Variables, such as: Image Strength, Volume, Location, Margin, Aggressiveness, Environment and Growth. For example, what appears to be tumor using molecular imaging can be confirmed or rejected by biopsy needle(s) through that region of the prostate and estimates of Tumor Variables can be refined. Multiple biopsies can be combined with multiple images and analyzed using Dynamic Analysis. For example, trends in Tumor Variables can be estimated and related to trends in biomarkers, such as PSA.

i. Tumor Image Strength

Apparent images of tumors may vary in strength, as suggested on the model 1300 shown by FIG. 13. Dynamic Screening can use measures of tumor image strength to assess the probability that what looks like a tumor is actually a tumor and not some other set of cells.

ii. Tumor Volume

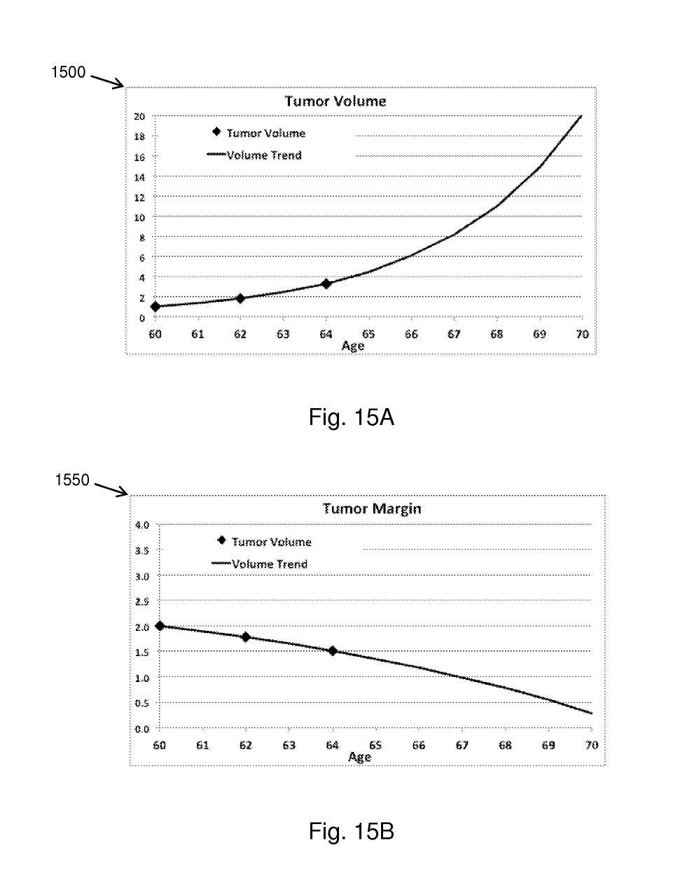

One set of molecular images can be used to estimate Image Tumor Volume, as shown by the model 1300 shown by FIG. 13. Image Tumor volume can be used by Dynamic Screening to estimate the probability of progressing cancer and the probability that it is the primary cause of increasing PSA, as shown by the graph 1500 on FIG. 15A. Image Tumor Volume can also be used to estimate the severity of the cancer and help refine the estimates of the effectiveness of treatment for prostate cancer and the risk of endpoints, such as death, metastasis, recurrence and PSA doubling time, and pathology.

Two or more sets of molecular images allow Dynamic Analysis estimation of Image Tumor Volume trends. Those trends can be used to help make better estimates of the probability of progressing cancer and better assess possible next medical actions. PSA trends, Prostate Volume (trends) and Image Tumor Volume trends and their projections provide complementary information about the likely course of cancer. Dynamic Analysis methods must be used to combine the information from these, sometimes conflicting, trends and data into useful information for Dynamic Screening analysis.

iii. Tumor Location

In some embodiments, one or more images can be used to estimate tumor location, as shown on FIG. 13. Prostate cancer deadliness varies with location in the prostate. In some embodiments, tumor location can be measured relative to the center of the prostate or its relationship to or distance from various zones or lobes of the prostate or other classifications of parts of the prostate. For example, prostate zones may be: peripheral, central, transition and anterior fibro-muscular zone (or stroma); and prostate lobes may be: anterior, posterior, lateral and median. In some embodiments, tumor location is used to estimate the severity of the cancer, estimate the effectiveness of treatment for prostate cancer, or estimate the risk of endpoints such as death, metastasis, and recurrence.

iv. Tumor Margin

In some embodiments, one or more images can be used to estimate the shortest distance from the tumor to the prostate capsule, or tumor margin, as shown on FIG. 13. Tumors that have grown or otherwise escaped outside the capsule are generally more difficult to cure. In some embodiments, tumor margin is used to calculate cancer deadliness—for example, as tumor margin decreases, an increased risk that cancer cells have escaped outside the capsule can be calculated. In some embodiments, tumor margin is used to estimate the severity of the cancer, estimate the effectiveness of treatment for prostate cancer, or estimate the risk of endpoints such as death, metastasis, and recurrence.

In some embodiments, two or more sets of images allow Dynamic Analysis estimation of Image Tumor Margin trends, as shown by the graph 1550 of FIG. 15B. Those trends can be used to help make better estimates of the probability of cancer death (and ability to cure) and better assess possible next medical actions. PSA trends, Prostate Volume (trends), Image Tumor Margin trends and Image Tumor Volume trends and their projections provide complementary information about the likely course of cancer. Dynamic Analysis methods can be used to combine the information from these, sometimes conflicting, trends and data into useful information for Dynamic Screening analysis.

v. Tumor Aggressiveness

In some embodiments, one or more images can be used to estimate tumor aggressiveness, as suggested on FIG. 13. In some embodiments, tumor aggressiveness is used to estimate the severity of the cancer, estimate the effectiveness of treatment for prostate cancer, or estimate the risk of endpoints such as death, metastasis, and recurrence.

vi. Tumor Environment

In some embodiments, imaging of the environment around the tumor including the surrounding cells can contain valuable information about the tumor itself, as shown on FIG. 13. For example, Stanford scientists have found for breast cancer that the characteristics of the cancer cells and the surrounding cells, known as the stroma, were both important in predicting patient survival. They built a model based on features of the stroma, the microenvironment between cancer cells, that was a stronger predictor of outcome than one built exclusively from features of epithelial cells. The stromal model was as predictive as the model built from both stromal and epithelial features. In the end, the Stanford findings add weight to what many scientists have been contending for some time: that cancer is an “ecosystem,” and that clinically significant information can be obtained by careful analysis of the complete tumor microenvironment.

In some embodiments, Dynamic Screening obtains information about the tumor environment from images and/or pathology from biopsies and create tumor environment variables to describe the tumor environment. In some embodiments, tumor environment variables are used to estimate the severity of the cancer, estimate the effectiveness of treatment for prostate cancer, or estimate the risk of endpoints such as death, metastasis, and recurrence.

D. Use of Dynamic Analysis in Dynamic Screening

In some embodiments, Dynamic Analysis methods are used by Dynamic Screening. See FIG. 6 for a high level description of how Dynamic Analysis is used in Dynamic Screening analysis of costs and benefits. See FIG. 8 and FIG. 9 for a more detailed description of how Dynamic Analysis is used to help estimate the costs of Active Monitoring and Active Surveillance.

i. Probability of Cancer

In some embodiments, Dynamic Screening considers the probability of cancer (P %) as part of its cost-benefit analysis of medical actions. See the right sides of FIG. 8 and FIG. 9. In some embodiments, P % can be defined as: PC %—the probability that a biopsy will detect any cancer; PS %—the probability that a biopsy will detect Strong Cancer; and PSc %—the probability that cancer detected by a biopsy will be Strong Cancer.

In some embodiments, Dynamic Screening uses the results of Dynamic Analysis to help estimate the probability of cancer. See the right sides of FIG. 8 and FIG. 9.

In some embodiments, Dynamic Screening uses the results of Dynamic Differential Analysis to help estimate the probability of cancer, where Dynamic Differential uses the results of Dynamic Analysis in conjunction with other information.

ii. Deadliness of Cancer

In some embodiments, Dynamic Screening considers the deadliness of cancer as part of its cost-benefit analysis of medical actions. See the left sides of FIG. 8 and FIG. 9. In some embodiments, Dynamic Screening uses the results of Dynamic Analysis to help estimate the deadliness of cancer. See the left sides of FIG. 8 and FIG. 9.

a. Dynamic Analysis of Biomarkers

In some embodiments, Dynamic Screening uses the results of Dynamic Analysis of biomarkers to help estimate the deadliness of cancer. See the left sides of FIG. 8 and FIG. 9. For example, Dynamic Screening can compare a man's estimated Dynamic Analysis of biomarker variables, such as PSAc and PSAgr to population data in order to estimate the man's risk of cancer-specific death. See FIG. 7A and FIG. 7B for population results, and then see FIG. 10, FIG. 10B and FIG. 10C for an example of the estimated risk of death for a man based on his Dynamic Analysis variables.

b. Dynamic Analysis of Tumor Variables

In some embodiments, Dynamic Screening uses the results of Dynamic Analysis of tumor variables to help estimate the deadliness of cancer. See the left sides of FIG. 8 and FIG. 9. For example, Dynamic Screening can compare a man's estimated Dynamic Analysis of tumor variables, such as location, volume and growth rate, margin and rate of decrease, and aggressiveness to population data in order to estimate the man's risk of cancer-specific death. See FIG. 13, FIG. 14, FIG. 15A and FIG. 15B for example tumor variables that can be measured for the man and compared to population data.

c. Combined Dynamic Analysis of Biomarkers and Tumor Variables

In some embodiments, Dynamic Screening uses the results of combined Dynamic Analysis of biomarkers and tumor variables to help estimate the deadliness of cancer. For example, Dynamic Screening can compare a man's estimated Dynamic Analysis of biomarker variables and Dynamic Analysis of tumor variables to population data in order to estimate the man's risk of cancer-specific death.

### VII. Dynamic Differential Analysis

In some embodiments, Dynamic Differential Analysis methods are used by Dynamic Screening.

In some embodiments, Dynamic Differential Analysis methods are used by Dynamic Screening to help estimate the probability of cancer.

In some embodiments, Dynamic Differential Analysis methods help identify and estimate the probability of Strong (Signal) Cancer that sends a strong PSA signal rather than No Cancer (or Weak [Signal] Cancer that produces little PSA). The methods include:
Strength of trend (PSA test span, number of PSA tests and distribution of PSA tests) provides valuable information about the trend.
Dynamic Analysis PSA consistent trend variables:
   PSAn—Estimated no cancer baseline PSA.
   PSAc—Estimated PSA from progressing cancer.
   PSAgr—Estimated annual exponential growth rate in PSAc.
   PSAvar—Past variability in PSA around the consistent trend.
   PSA Jumps and Drops—Recent or past increases or decreases in PSA from the trend.
Prostate Volume—Single volume measurement or multiple measurements that allow estimation of a trend.
Differential Treatment—Use of anti-inflammatory medication and/or antibiotic Differential Treatment for prostatitis with measurement of subsequent deceleration in the PSA trend, if any.
Tumor Variable Analysis—Static or Dynamic Analysis of tumor variables using information from imaging, biopsy and genetics.

In some embodiments, Greater PSA variability, Jumps and Drops suggest that a No Cancer cause is more likely. In some embodiments, a prostate volume measurement helps Dynamic Analysis estimate the probability of a No Cancer cause of elevated PSA and estimate PSAn. In some embodiments, deceleration in the PSA trend after Differential Treatment suggests that a No Cancer cause is more likely.

In some embodiments, the probability that a biopsy will find prostate cancer from existing risk calculators, such as the PCPT Risk Calculator, can be used as the starting point for further Dynamic Differential Analysis for use in Dynamic Screening.

A. Personal Information

Dynamic Differential Analysis may take into account personal information and history, including but not limited to PSA test history, test subject profiles, and test subject medical information, as described in co-assigned U.S. patent application Ser. No. 13/442,648.

In some embodiments, Dynamic Differential Analysis can analyze and use any personal information that increases screening effectiveness for which population data is available as a reference.

i. Age

In some embodiments, age can be input directly or calculated as a function of the man's birthdate. Age affects a man's no cancer baseline PSA through prostate volume, both of which tend to increase with age. Age can also affect a man's life expectancy, risk of prostate cancer, treatment effectiveness and health, which may limit the types of treatment considered and affect his risk preferences.

ii. Family History

In some embodiments, family history of prostate cancer and other prostate conditions may affect the man's risk of those conditions. Family history may affect estimates of the man's health and life expectancy. For example, a man may choose a longer that average life expectancy if all his near relatives lived to a very old age; or another man may choose a shorter life expectancy if all his near relatives died at a young age of heart disease.

iii. Economic Status and Health Insurance

In some embodiments, a man's economic status and health insurance coverage may affect his life expectancy and his risk preferences. In the extreme, a man who cannot afford treatment for prostate cancer if discovered may not want to screen to learn if he has prostate cancer.

iv. Race

In some embodiments, race may affect the man's risk of prostate cancer and other prostate conditions.

v. BMI

In some embodiments, BMI and other measures of obesity may affect the man's risk of prostate cancer and other prostate conditions and may affect his PSA levels through hemo-dilution (men with high BMI have more body mass and more blood to dilute PSA leaking from the prostate).

vi. Health and Other Personal Information

In some embodiments, life-style choices and health assessed by a doctor may affect the man's risk of prostate cancer and other prostate conditions and certainly will affect estimates of the man's life expectancy. Online health assessment and life expectancy calculators may be used to assist the doctor in making assessments about a man's health and the implications of life-style choices.

vii. Past Diagnosis and Treatment of Prostatitis

In some embodiments, past diagnoses of prostatitis caused by inflammation and/or infection can increase the probability that a currently increasing PSA trend is primarily caused by prostatitis rather than progressing cancer. Past treatment of prostatitis with anti-inflammatory meds and/or antibiotics combined with before and after PSA tests help assess the past impact of that treatment and forecast the potential benefit of Differential Treatment of prostatitis with PSA follow-up as part of Dynamic Screening. Input about medication, dose and dates/duration are needed.

viii. Past Diagnosis and Treatment of BPH

In some embodiments, past diagnoses of prostate enlargement caused by Benign Prostatic Hyperplasia (BPH) can increase the probability that a currently increasing PSA trend is primarily caused by BPH rather than progressing cancer. Past treatment of BPH with medication and/or medical procedures, such as a TURP, combined with before and after PSA tests help assess the past impact of that treatment and the need to establish a new no-cancer baseline PSA at a lower level.

ix. Other Medications and Treatments

In some embodiments, past treatment with anti-inflammatory meds and/or antibiotics for any reason combined with before and after PSA tests help assess the past impact of that treatment and forecast the potential benefit of Differential Treatment of prostatitis with PSA follow-up as part of Dynamic Screening. Past treatment for hair loss with medication should be considered in a similar way to past treatment of BPH with medication if the same or similar medication is used.

In some embodiments, other medications and treatments may be considered by Dynamic Screening. Input about medication, dose and dates/duration are needed.

B. Digital Rectal Exam (DRE)

In some embodiments, one or more results of a digital rectal exam (DRE) are used as part of Dynamic Analysis as part of Dynamic Differential Analysis to help Dynamic Screening assess the probability that increasing PSA is caused by cancer, progressing cancer or Strong cancer rather than a no-cancer condition. A positive DRE increases the probability that cancer will be found and that it will be progressing or Strong cancer. A negative DRE decreases the probability that cancer will be found and that it will be progressing or Strong cancer. See e.g., Example 5 discussed below.

In some embodiments, new criteria and training may be needed that only trigger a biopsy when cancer is the highly probable cause of the hard spot on the prostate. This new approach might be called a “Safety-Net DRE” that requires a strong indication of prostate cancer before a biopsy is proposed on DRE evidence alone or in conflict.

C. Prostate Volume Measurements

In some embodiments, one or more prostate volume measurements are used as part of Dynamic Analysis as part of Dynamic Differential Analysis to help Dynamic Screening assess the probability that increasing PSA is caused by cancer, progressing cancer or Strong cancer rather than a no-cancer condition. Substantially elevated PSA is typically a rare event, whether caused by progressing cancer or a no-cancer condition. The probability of elevated no-cancer PSA increases with both age and prostate volume, however prostate volume explains most of the variation in elevated PSA when both are considered together. Dynamic Differential Analysis may rely on prostate volume, primarily if available, and age to help estimate the probability that a no-cancer condition is the primary cause of increasing PSA. Age alone may be used if prostate volume is not available, and prostate volume dominates the estimate if it is available. For a given PSA trend, the probability of cancer, progressing cancer and Strong cancer increases for smaller prostate volumes and decreases for larger prostate volumes.

D. Dynamic Analysis of Biomarkers

In some embodiments, Dynamic Screening uses the results of Dynamic Analysis in Dynamic Differential Analysis.

i. Strength of PSA Evidence

In some embodiments, Dynamic Differential Analysis uses measures of strength of PSA evidence, such as test span, number of tests and their distribution from Dynamic Analysis to help assess the probability of cancer. For example, Strong (Signal) Cancer is more likely for smooth exponential growth in PSA above a baseline for more evenly distributed tests over a longer test span.

ii. PSA Variation

In some embodiments, Dynamic Differential Analysis uses measures of PSA variation from Dynamic Analysis to help assess the probability of cancer. For example, Strong (Signal) Cancer is more likely for smooth exponential growth in PSA above a baseline than it is for high PSA variation around the trend.

iii. PSA Jumps and Drops

In some embodiments, Dynamic Differential Analysis uses measures of PSA jumps and drops from Dynamic Analysis to help assess the probability of cancer. For example, Strong (Signal) Cancer is more likely for smooth exponential growth in PSA above a baseline than it is for PSA patterns with jumps or drops.

iv. PSAgr Stability

In some embodiments, Dynamic Differential Analysis uses measures of PSAgr stability from Dynamic Analysis to help assess the probability of cancer. For example, Strong (Signal) Cancer is more likely for smooth exponential growth in PSA above a baseline than it is for low PSAgr stability.

v. Other Dynamic Analysis Variables

Dynamic Analysis variables may not limited to the ones previously described. Dynamic Analysis includes other variables available to someone skilled in the art.

E. PSA Deceleration after Prostatitis Treatment

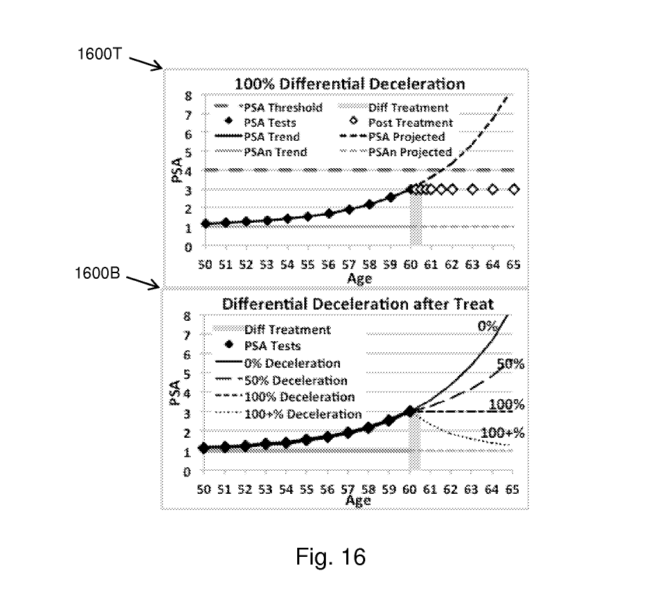

In some embodiments, Dynamic Screening incorporates the results of Differential Treatment. For example, increasing PSA can be the result of increasingly severe prostatitis caused by inflammation and/or infection. Differential Treatment with anti-inflammatory meds and/or antibiotics can reduce the severity of prostatitis and, with follow-up testing, decelerate a biomarker (e.g. PSA) trend or even decrease observed biomarker levels. An example trend is shown in FIG. 16 Top 1600T. Thus, Differential Treatment can help identify otherwise false-positive results derived from other medical actions of the invention. Although generic anti-inflammatory and antibiotic treatment may be very low cost, many doctors may be reluctant to administer antibiotics that might increase bacterial resistance unless there is strong justification. Therefore, in some embodiments, antibiotic Differential Treatment is delayed until strongly justified by increasing prostate cancer risk. However, doctors often prescribe anti-inflammatory meds and antibiotics for other conditions, such as a sinus infection. In some embodiments, Dynamic Screening considers the results of an independent treatment with an anti-inflammatory medication or an antibiotic.

In some embodiments, the results of Differential Treatment are analyzed by analysis methods as described herein. For example, the PSA levels of a patient undergoing Differential Treatment can be measured over the course of the treatment, and those PSA test values analyzed to determine whether the patient is responding to the treatment. In some embodiments, the methods described herein can be used to analyze biomarker test values during and/or after Differential Treatment to determine a probability that a non-cancer condition was the sole or primary cause of any observed biomarker trend, or to determine a probability that a cancer condition is also contributing to the observed biomarker trend (e.g. by increasing PSA values over time).

i. Differential Treatment

In some embodiments, Differential Treatment of prostatitis is used. FIG. 16 Top 1600T and Bottom 1600B show an exponentially increasing PSA trend above a no cancer baseline of 1.0 that reaches 3.0 at age 60. Differential Treatment with anti-inflammatory meds and antibiotics starts at that time, as shown by the vertical gray bar.

ii. Differential Deceleration Example

In some embodiments, Differential Deceleration analysis combines Dynamic Analysis with low-cost Differential Treatment for prostatitis. It may be powerful because even weak responses to treatment provide valuable information that can delay or avoid biopsies. Dynamic Screening uses Dynamic Analysis trends to continually project trends and PSA thresholds. On FIG. 16 Top 1600T, the PSA trend of 3.0 at age 60 is well below the man's personalized PSA threshold of 4.0. Based on the trend projection, the man has roughly 1.5 years before his PSA trend reaches his 4.0 threshold. For this man, age 60 is a great time for pre-emptive Differential Treatment before his threshold is reached. A biopsy can be avoided if his trend never reaches his threshold.

iii. Differential Deceleration (DD %) Measurement

In some embodiments, Differential Deceleration (DD %) is defined as the percentage decline below the projected trend toward the no increase (flat) trend by the PSA test with the lowest DD % in the first year after the biopsy or the first PSA test if there are none in the first year, as shown on FIG. 16 Bottom 1600B. 100% Differential Deceleration means no increase. In contrast, 0% DD % means a PSA test continues on the projected trend. The graph shows four examples: 0%; 50% half way between 0% and 100%, 100% and 100+% for PSA tests below the no increase (flat) trend.

In some embodiments, Dynamic Screening considers the magnitude of DD % in conjunction with the results of other Dynamic Analysis of range of evidence to suggest next prostate screening medical actions, including Active Monitoring with more PSA tests and a biopsy when warranted.

In some embodiments, Dynamic Differential Analysis calculates the probability of cancer, including the probability of strong cancer based on the measurement of differential deceleration and other information. For example, differential deceleration greater than 100% may cause Dynamic Screening to conclude that Strong Cancer has a low probability of being the cause of the previously increasing PSA. For example, the probability may be lower for 100% deceleration from a previously high PSAgr trend than from a previously low PSAgr trend.

F. Tumor Variables

In some embodiments, tumor variables can be used for Active Monitoring of a previously discovered tumor. Tumor variables can be measured by any method known in the art, including but not limited to biopsies, ultrasound, and imaging, including molecular imaging.

In some embodiments, tumor variables can be used by the methods described herein to estimate the probability of progressing cancer and the probability that it is the primary cause of increasing PSA. Tumor variables can also be used to estimate the severity of the cancer, refine estimates of the effectiveness of treatment for prostate cancer, and estimate risk of endpoints, such as death, metastasis, and recurrence, PSA doubling time, and pathology.

i. Imaging

In some embodiments, molecular images are used to measure tumor variables. In some embodiments, images of prostate cancer can be combined with Dynamic Analysis or PSA trends and other information to increase the effectiveness of Dynamic Screening. The low cost of PSA and Dynamic Analysis is likely to make it one of the first, early steps in mass screening. The high current cost of MRI molecular imaging, for example, is likely to make it one of the later steps in screening after Dynamic Analysis has identified high-risk patients that might benefit from molecular imaging to decide whether to biopsy for prostate cancer.

ii. Biopsy

In some embodiments, biopsy results, including pathology, genetics and images, are used to measure tumor variables. In some embodiments, pathology results can be combined with images to estimate tumor variables. The resulting estimates of tumor variables can be combined with Dynamic Analysis or PSA trends and other information to increase the effectiveness of Dynamic Screening.

G. Use of Dynamic Differential Analysis in Dynamic Screening

In some embodiments, Dynamic Differential Analysis methods are used by Dynamic Screening. Dynamic Differential Analysis is a subset of Dynamic Analysis. See FIG. 6 for a high level description of how Dynamic Analysis, and its subset of Dynamic Differential Analysis, is used in Dynamic Screening analysis of costs and benefits. See FIG. 8 and FIG. 9 for a more detailed description of how Dynamic Analysis, and its subset of Dynamic Differential Analysis, is used to help estimate the costs of Active Monitoring and Active Surveillance.

i. Probability of Cancer

In some embodiments, Dynamic Screening considers the probability of cancer (P %) as part of its cost-benefit analysis of medical actions. See the right sides of FIG. 8 and FIG. 9. In some embodiments, P % can be defined as: PC %—the probability that a biopsy will detect any cancer; PS %—the probability that a biopsy will detect Strong Cancer; and PSc %—the probability that cancer detected by a biopsy will be Strong Cancer.

In some embodiments, Dynamic Screening uses the results of Dynamic Differential Analysis, as part of Dynamic Analysis, to help estimate the probability of cancer. See the right sides of FIG. 8 and FIG. 9.

In some embodiments, Dynamic Screening uses the results of Dynamic Differential Analysis to help estimate the probability of cancer, where Dynamic Differential uses the results of Dynamic Analysis in conjunction with other information.

ii. Deadliness of Cancer

In some embodiments, Dynamic Screening considers the deadliness of cancer as part of its cost-benefit analysis of medical actions. See the left sides of FIG. 8 and FIG. 9. In some embodiments, Dynamic Screening uses the results of Dynamic Differential Analysis, as part of Dynamic Analysis, to help estimate the deadliness of cancer. See the left sides of FIG. 8 and FIG. 9.

### II. EXAMPLES

### A. Example 1

### Dynamic Screening Decision Process

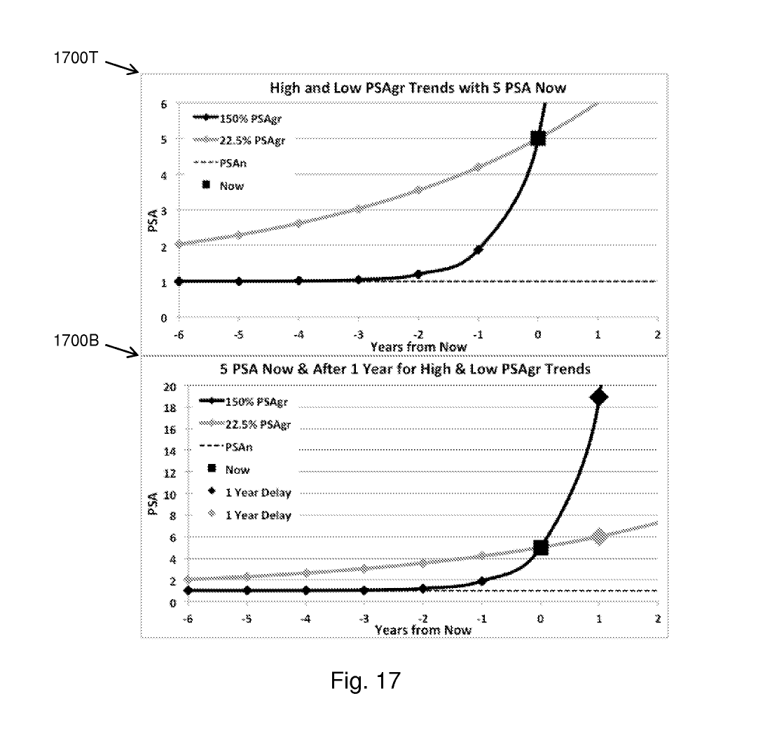

A comparison of a hypothetical high and a low-risk patient, both with a current PSA value of 5.0, is shown by the graphs 1700T, 1700B of FIG. 17. Dynamic Analysis quantitates the PSA trend for each patient to calculate PSAgr and PSAn (1.0 in these cases, also shown), which allows Dynamic Screening to recommend different medical actions for each patient, despite their having the same PSA test result. Here, the high-risk patient has a PSAgr of 150%, as shown by FIG. 17 Top 1700T; while the low-risk patient has a PSAgr of 22.5%, as shown by FIG. 17 Bottom 1700B. In this example, the Dynamic Screening process projects each PSA trend forward by a year and looks at the future PSA value, as shown in FIG. 17 Top 1700T and Bottom 1700B.

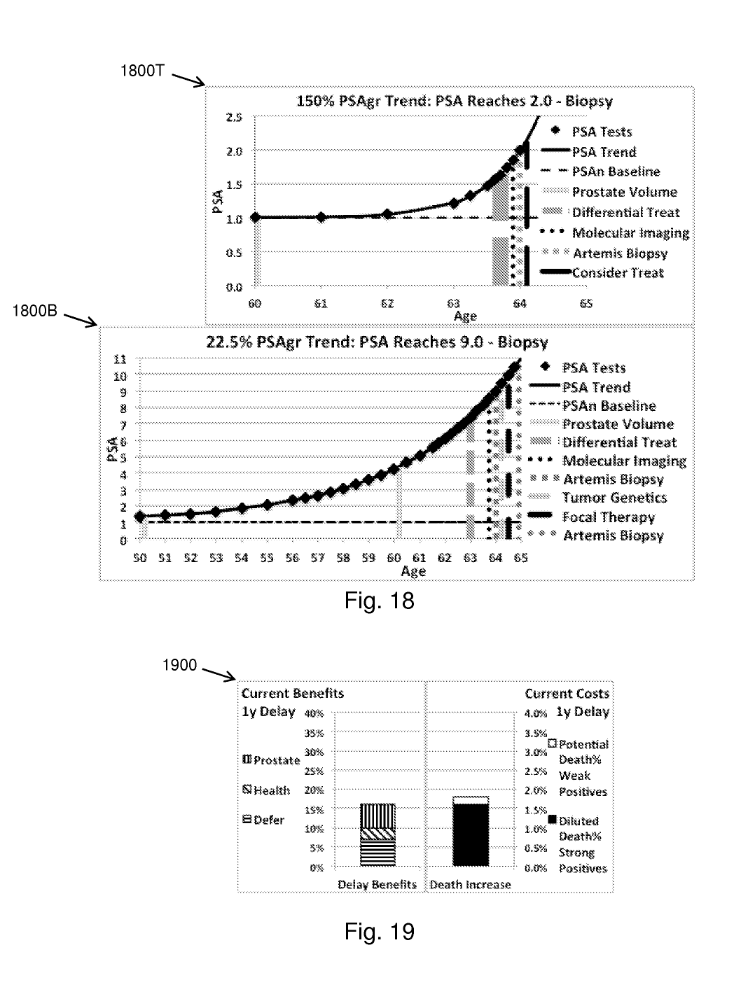

In some embodiments, Dynamic Screening will recommend different thresholds for different medical actions. FIG. 18 Top 1800T depicts an example PSA trend for the high-risk patient along with lines marking PSA thresholds for various medical actions. Depending on when a patient with that trend is screened, the Dynamic Screening method may recommend one or more different medical actions. For example, a prostate volume measurement may be recommended early on, when it can be used, for example, to adjust the PSAn and serve as a baseline for future prostate volume measurements. In this example, if the patient has reached a PSA value of approximately 1.5, Dynamic Screening may recommend Differential Treatment, e.g. treatment with antibiotics or anti-inflammatory medications to determine whether the rising PSA values are due to non-cancer conditions. If the patient reaches a PSA value of about 1.8, Dynamic Screening may recommend molecular imaging of the prostate. If the patient reaches a PSA value of about 2.0, Dynamic Screening may recommend a prostate biopsy to test for cancer. If the patient's PSA value is greater than 2.0, with a PSAgr of 150% and a PSAn of 1.0, Dynamic Screening may recommend initiating treatment for prostate cancer.

FIG. 18 Bottom 1800B depicts an example PSA trend for the low-risk patient. For a patient with this trend, a prostate volume measurement may still be recommended early on, but with a second prostate volume measurement recommended when PSA reached 4.5. Any growth in prostate volume may be incorporated into screening by Dynamic Analysis of a prostate volume trend. Differential Treatment may be recommended when PSA reaches a value of approximately 7.5, much higher than the 1.5 threshold for the patient with a higher growth rate. If the patient is screened when PSA is at approximately 8.5, molecular imaging may be recommended. A biopsy may be recommended by Dynamic Screening at a PSA of 9.0, with an escalation of medical actions through tumor-specific testing, treatment, and follow-up biopsy if a tumor is discovered.

FIG. 19 depicts a typical chart 1900 used to report the results of benefit-cost analysis. For a patient with a PSA of 2.0 and a PSA trend as depicted in FIG. 17 Top 1700T, based on a hypothetical 10 year life expectancy, the benefits of one year's delay are calculated as a sum of the benefits to health, to the prostate, and from deferral of biopsy. The costs can be calculated as an increase in risk of death from cancer from deferring a year. The system calculates both a conservative estimate that includes the risk of death from low-risk cancer (white box), and a “diluted” risk that adjusts for the possibility that the PSA trend is caused by a low-risk cancer (black box). The costs can then be adjusted for the risk tolerance of the patient. With a hypothetical risk tolerance of 10% (reflecting a patient who is willing to undergo ten treatments for one cancer removal), the diluted risk of ˜1.6% is of equal weight to the ˜16% benefits of delay. The more conservative estimate is of greater weight than the benefits of delay.

The text of a Dynamic Screening summary report to a patient with these characteristics may include, “Under the direction of Dr. Smith, Dynamic Screening analysis suggests consideration of a biopsy for prostate cancer. After evaluating diagnostic steps by Dr. Smith, the increasing cost of further Active Monitoring is projected to exceed the decreasing benefits of Active Monitoring, based on a life expectancy of 10 years and your risk preference of 10 treatments to save a life (10% reduction in death risk).”

In some embodiments, the Dynamic Screening process projects each PSA trend forward by a year and looks at the future PSA value, as shown in FIG. 17 Top 1700T and Bottom 1700B.

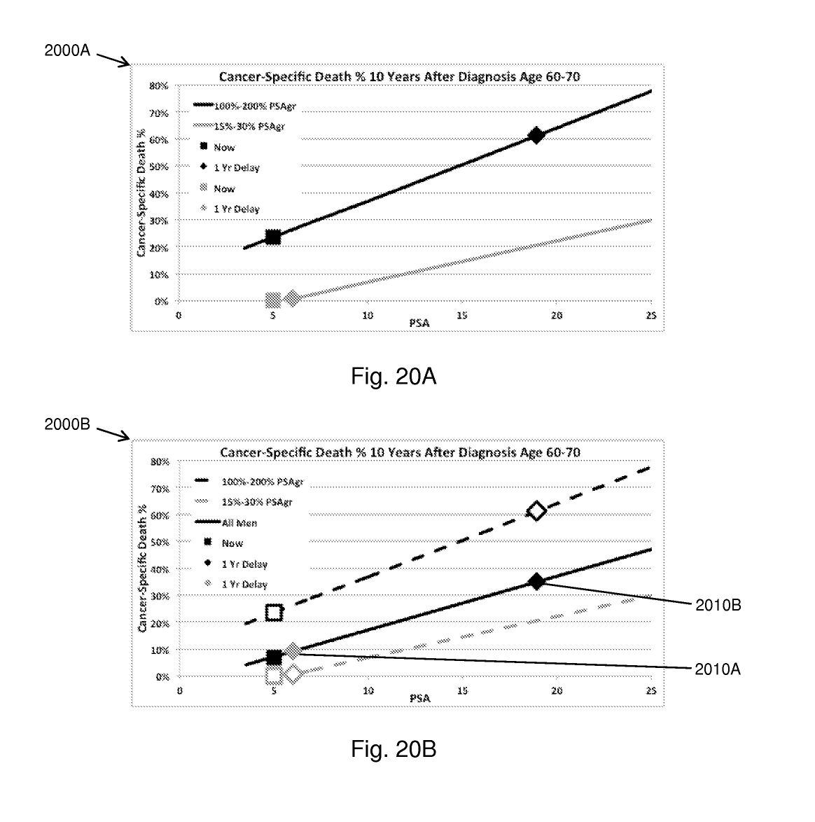

The future PSA values can then be used to calculate a death risk after one year of Active Monitoring. Based on analysis of population data, Dynamic Screening can use PSAgr to plot cancer-specific death rate as a function of PSA, based on the life expectancy of the patient (e.g 10 years). Graph 2000A FIG. 20A plots a cancer-specific death rate for a population with PSAgr of 100-200%, and median of 150%, and for a population with PSAgr of 15-30%, and median of 22.5%. The current and projected PSA values of the high and low risk patients can be marked on their respective lines. Note that with the low-risk patient, their projected PSA after a year is lower than that of the high-risk patient, and the cancer-specific death risk function also increases at a lower rate. As a result, the low-risk patient's risk of death from cancer is projected to barely increase after waiting for a year, while the high-risk patient's risk of death nearly triples over the same time, to more than 60%.

If PSAgr (and PSAV) are not directly incorporated into the calculation of cancer-specific death, the higher future PSA of the high-risk patient would still result in a higher risk of cancer-specific death, as shown by the solid diamonds 2010A, 2010B shown in the graph 2000B of FIG. 20B. For some patients, their PSA (or other Dynamic Analysis) trend projection will be the most important determinant of the increase in death risk from waiting.

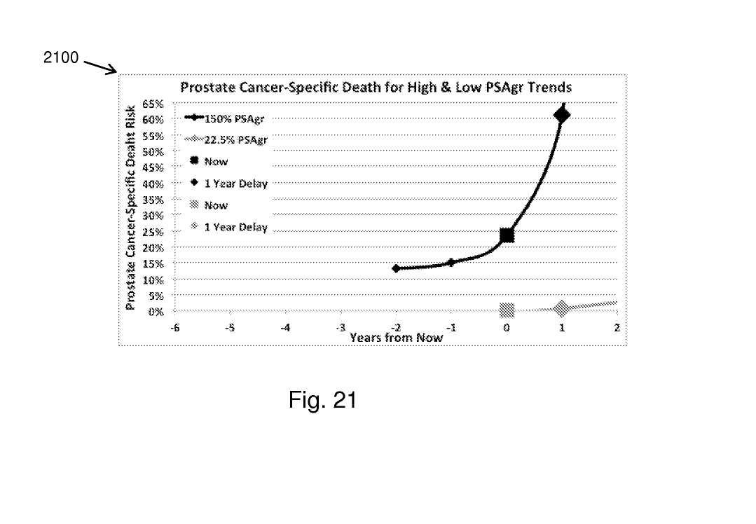

The prostate cancer-specific death risk can also be converted to a function of time spent waiting, as shown in FIG. 21. The calculation process starts with FIG. 17 that shows PSA as a function of years from now for the two men. Next, FIG. 20A is used to convert PSA at each year from now to cancer-specific death ten years after diagnosis.

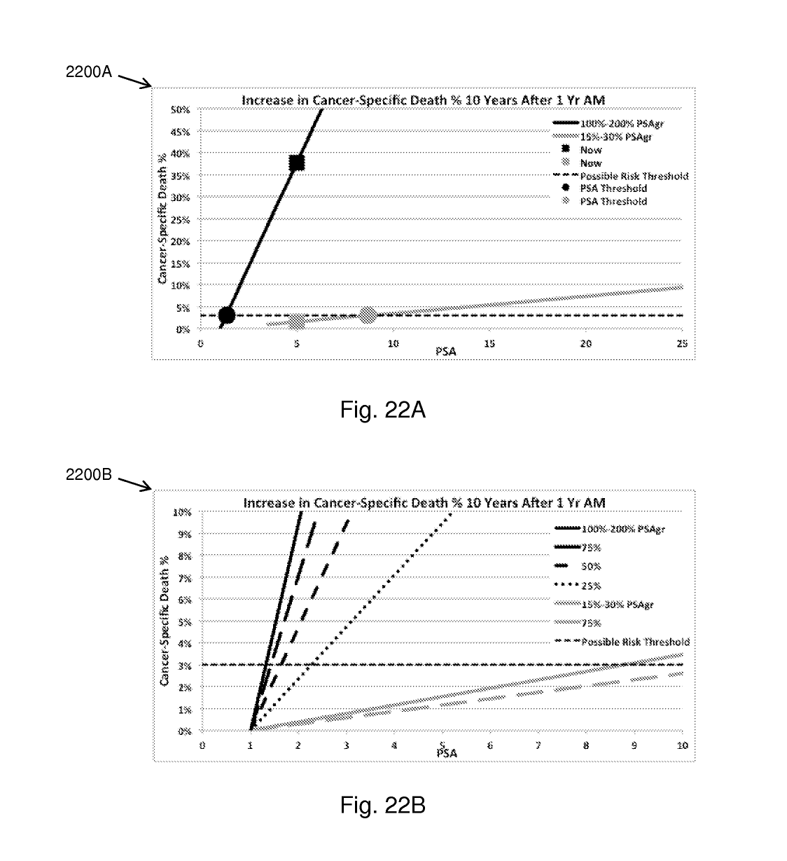

The increase in prostate cancer-specific death risk can be calculated as a function of PSA, as shown in FIG. 22A. The calculation process starts with the data depicted in graph 2100 of FIG. 21. For each time period defined by years from now for each man, cancer-specific death can be estimated for that time period and for one year later. The difference is the increase in prostate cancer-specific death as a function of the time period defined by years from now. Years from now can be translated to PSA using the methods described above with reference to FIG. 17.

The patient's projected death risk from waiting can be compared to a death risk threshold. For example, a 3% death risk can be set as the threshold for biopsy for a patient with a 10-year life expectancy, as shown by the graph 2200A of FIG. 22A. In this example, the low-risk patient has a projected death risk of less than 3%, so biopsy would not be recommended, while the high-risk patient has a projected death risk significantly higher than 3%, so biopsy would be recommended (and likely other actions as well.)

The death risk from cancer thus calculated from PSA may be higher than necessary, because each patient also has a chance that their PSA trend is not primarily caused by progressing cancer. To adjust for this probability, the cancer-specific death risk is multiplied or “diluted” by the probability that progressing cancer is the cause of the patient's PSA trend. Examples of different diluted death risks for the high and low-risk patients are shown by the graph 2200B of FIG. 22B.

### B. Example 2

### Dynamic Analysis of PSA

A central insight of Dynamic Analysis of PSA is that a man's PSA history contains valuable information about what is occurring in his prostate that can be interpreted using appropriate methods. The graph in FIG. 2 shows PSA history typical of a man who died from prostate cancer. (Source: Baltimore Longitudinal Study of Aging.) Key Dynamic Analysis findings include: 1) Smooth fast exponential growth in PSA above a no-cancer baseline is characteristic of progressing cancer; and 2) Faster exponential growth is characteristic of more deadly cancer. The implications include: 1) Smooth, fast exponential growth in PSA above a baseline can justify early detection at very low PSA levels for effective treatment; 2) Variable, slow growth in PSA to moderate levels may not be primarily caused by progressing cancer and a biopsy may not be justified; and 3) Possibly variable, moderate growth in PSA may justify a biopsy for some men if PSA eventually reaches relatively high levels. Dynamic Screening incorporates these insights, findings and implications in a clinical decision support system that will dramatically reduce the number of biopsies, treatment and costs while reducing death from prostate cancer through early detection and treatment of the most deadly cancers.

### C. Example 3

### Benefits of Dynamic Differential Analysis

Retrospective analysis of Tyrol (Austria) data suggests substantial benefits of monitoring for differential deceleration in PSA after Differential Treatment with antibiotics. Differential Treatment with antibiotics in conjunction with PSA trend analysis can reduce false positive biopsies by 90% to 97% and allows setting low PSA thresholds for High-Risk PSA trends with minimal dilution of early detection benefits.

i. Background

As part of the Tyrol Prostate Cancer Demonstration Project, PSA tests were introduced in the Tyrol region of Austria, in 1988-1989 and, since 1993, have been offered to all men aged 45-74 years. In Tyrol, where PSA testing is free of charge and is widely accepted, more than three quarters of men in this age group had at least one PSA test in the period 1993-2003, and some of them have PSA tests regularly. By 2008 the Tyrol prostrate cancer death decreased by 50% from its peak compared to a 43% reduction in the U.S., which suggest the Tyrol Prostate Cancer Demonstration project was more effective than U.S. practice.

ii. Antibiotic Treatment

Five days of antibiotic treatment to reduce the risk of new infection are part of the standard biopsy process in the Tyrol with most of the biopsies performed at the Medical University of Innsbruck. This antibiotic treatment provides a natural test of Differential Treatment for prostatitis as a possible way of reducing false positives and over-treatment of indolent cancers, although five days is shorter than the thirty days of treatment used in some studies.

iii. Risk Groups

Risk Groups based on PSAgr and PSAvar ranges have been shown in our previous Dynamic Analysis study of Baltimore Longitudinal Study of Aging data to be strong predictors of the subsequent cancer-specific risk of death. The High-Risk group has smooth, fast exponential growth above a baseline with PSAgr>25% and PSAvar<25%. See Table 1 for definitions of the other Risk Groups. Risk Groups are assigned at each biopsy for all men in the study cohort. The PSAgr range must be confirmed over two tests. For PSAgr categorization, we consider the lower of the PSAgr values at the last PSA test prior to biopsy and the test that precedes it.

TABLE 1
PSA Thresholds for Four Dynamic Screening Programs

| Risk Category | | | |
|---|---|---|---|
| High | Mod | Low | Neg |
| PSAgr > | PSAgr > | Not High, | PSAgr <= |
| 25% & | 12% & | Mod or Neg | 2% |

50% Differential Deceleration

| | | | | | |
|---|---|---|---|---|---|
| Thresholds | High | 4.0 | 7.0 | 10.0 | 15.0 |
| | Low | 3.0 | 5.0 | 7.0 | 10.0 |

100% Differential Deceleration (Flat)

| | | | | | |
|---|---|---|---|---|---|
| Thresholds | High | 4.0 | 7.0 | 10.0 | 15.0 |
| | Low | 3.0 | 5.0 | 7.0 | 10.0 |

iv. Consistent Screening Programs

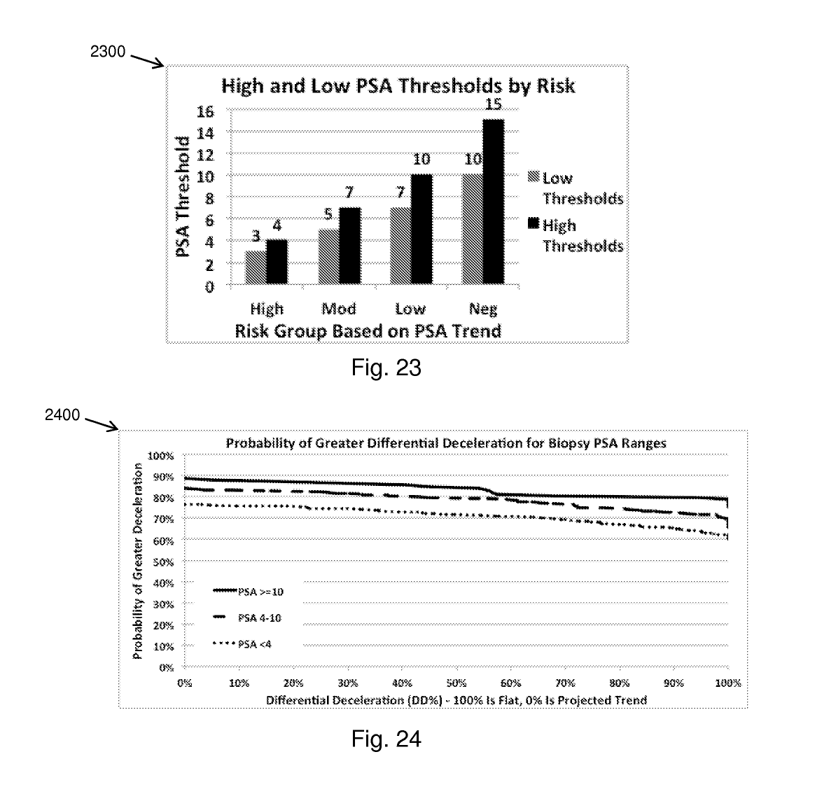

We created High Thresholds and Low Thresholds consistent screening programs with PSA thresholds for each PSA trend Risk Group, as shown by the bar chart 2300 on FIG. 23. Consistent risk of death leads to a lower PSA threshold for High-Risk trends that kill faster and a higher PSA threshold for Low-Risk trends that kill slower.

We define four Dynamic Screening programs based on: A) Two Differential Deceleration (DD %) thresholds: 50% and 100%; and, B) Two PSA threshold programs: High and Low. We use the term Dynamic Screening to describe the combined use of Dynamic Analysis of PSA trends and analysis of Differential Deceleration after treatment for prostatitis. If PSA slows by at least half (50% DD %), it is unlikely to have been caused by progressing cancer and certainly justifies a substantial delay in biopsy, which can be reconsidered later if PSA resumes rapid growth. The case for delay is even stronger if PSA flattens out (100% DD %) or decreases because future PSA is unlikely to reach higher levels.

v. Screening Results

97% of the false positive biopsies could have been avoided using risk appropriate thresholds: 50% Differential Deceleration and PSA: 4.0 ng/ml for High-Risk trends, 7.0 ng/ml for Moderate-Risk, 10.0 ng/ml for Low-Risk and 15.0 ng/ml for Negligible-Risk. (90% to 95% reductions for other screening programs.) Dilution of early detection benefits is reduced by similar percentages because less indolent cancer is found, which strengthens the case for early detection of cancers for men with High-Risk PSA trends.

The graph 2400 on FIG. 24 shows the cumulative probability of Differential Deceleration (DD %) greater than values in a range between 0% (where post antibiotic tests follow the projected trend) and 100% (where tests do not increase). Cumulative means the probability of greater deceleration (flatter follow-up trend) than the corresponding value shown on the horizontal axis. For example, for PSA>=10 there is an 84% chance of greater than (flatter than) or equal to 50% DD %, where 50% means tests that fall halfway between the projected trend and flat. It is interesting to note that for any DD % the cumulative probability increases as PSA increases. In other words, the larger the PSA before biopsy the more likely its trend will decelerate. This result might be explained by a higher probability of infection and/or inflammation treatable by antibiotics at higher levels of PSA.

Table 2 shows the reduction in the percentage of false positives using only Differential Deceleration thresholds of 50% and 100% for the three ranges of PSA before biopsy and antibiotic treatment. For example, a PSA test of 5.0 would be considered a false positive if a follow-up PSA test decelerated by a threshold amount such as 50%, or more.

TABLE 2
Reduction in False Positives (%) Using Differential Thresholds

| | PSA Range | | |
|---|---|---|---|
| Differential | >=10 | 4-10 | <4 |
| 50% Deceleration | 84% | 79% | 72% |
| 100% Deceleration | 79% | 69% | 62% |

### D. Example 4

### Effectiveness of Dynamic Analysis

The effectiveness of Dynamic Analysis methods is evaluated compared to conventional static PSA screening.

i. Materials and Methods

1,038 men from the Tyrol screening project and UCSF and CaPSURE databases were analyzed. See Table 3.

TABLE 3
ALL RP (INNSBRUCK, UCSF, AND
CAPSURE POPULATIONS)

| Group | N | Innsbruck | UCSF | CaPSURE |
|---|---|---|---|---|
| RP, adequate data | 373 | 143 | 131 | 99 |
| RP, AD, missing pathology | 5 | 5 | 0 | 0 |
| Gleason and/or stage data | | | | |
| High Gleason (4 + 3, 8-10) | 59 | 25 | 22 | 12 |
| Low Gleason (4-6, 3 + 4) | 309 | 113 | 109 | 87 |
| Low Gleason, Low Stage | 63 | 21 | 21 | 21 |
| (T1a-c, T2a) | | | | |
| Low Gleason, High Stage | 246 | 92 | 88 | 66 |
| (T2b-c, T3a-c, T4) | | | | |
| Recur | 32 | 16 | 7 | 9 |
| Innsbruck No Cancer, Adequate | 331 | | | |
| Data (up to most recent biopsy) | | | | |
| Innsbruck No Cancer, Adequate | 670 | | | |
| Data (full PSA history) | | | | |

The sources of data were the:

(1) University of California at San Francisco (UCSF) surgery database. Please see: http://www.ucsfhealth.org/clinics/prostate_cancer_center/index.html.

(2) Cancer of the Prostate Strategic Urologic Research Endeavor (CaPSURE) surgery database managed by UCSF. Please see: http://urology.ucsf.edu/capsure/overview.htm.

(3) Innsbruck Medical University managed surgery database for the Tyrol region of Austria. Please see, for example: Bartsch et. al., Tyrol Prostate Cancer Demonstration Project: early detection, treatment, outcome, incidence and mortality; Urological Oncology, in BJU International, 101, 809-816, 2008.

670 men from the Tyrol screening project had no cancer detected by biopsy and at least 5 PSA tests over 4 years with no gap more than 2 years. These men may be referred to as the full history no cancer group. 331 men with no cancer had adequate data up to their last biopsy. These men may be referred to as the truncated history no cancer group. 368 men in the University of California at San Francisco (UCSF) and CaPSURE databases and from the Tyrol underwent radial prostatectomy surgery (RP) and had pathological results and the same minimum PSA history. Men with Gleason scores of 4+3 or greater and stage T2b and greater were considered high risk.

The Tyrol Cancer Demonstration Project is a mass prostate cancer screening program in the Tyrol region of Austria started as a demonstration project in 1993. General practitioners, urologists, medical centers, labs and the Tyrol Blood Bank of the Red Cross collaborated in the screening program. Participating volunteers gave informed consent. Men with elevated PSA results, were advised to undergo further urologic exams and treatment, if necessary. For men with normal PSA test results, the protocol was to repeat the PSA test 6-12 month later.

The UCSF database contained men undergoing radical prostatectomy (RP) as a treatment for prostate cancer over several years. CaPSURE is a community database of RP patients managed by UCSF.

Consistent exponential PSA trends were fit for every man. The functional form included a constant to represent unchanging (or slowly changing) no cancer PSA plus an exponential function to represent the accelerating growth in PSA from progressing cancer. Iterative weighted least squares methods were used to estimate the parameters of the function. An iterative process was used to converge on a consistent trend where all tests included in the estimation of the trend were within 20% of the trend at the time of the test.

Trend PSA (trPSA) was calculated as the value of the trend at the time of the last PSA test. trPSAV was calculated as the slope of the exponential trend at the time of the last PSA test. trPSA from cancer, trPSA(PCa), was calculated as trPSA minus the constant in the functional form (which is a measure of the PSA not contributed by progressing cancer). Estimated growth rate in cancer PSA, PSAgr, was calculated as trPSAV/trPSA(PCa). The same methods were used for men with no cancer.

PSA variation (PSAvar) is a discounted estimate of percentage variation around the consistent trend. It resembles a coefficient of variation where the past is discounted in order to emphasize recent results. 40% was used in this analysis.

A single PSA result was used as the indicator of static PSA screening: either the last PSA test recorded or the last test before biopsy.

High-risk cancers were defined as Gleason scores of 4+3 and above and stage T2b and greater.

Risk assessment was performed using receiver operating characteristic curves (ROC). The threshold PSA was varied for static PSA screening and values for sensitivity to high-risk cancers and specificity to no cancer were calculated. Both full history and truncated history no cancer groups were evaluated. For Dynamic Analysis, a single quadratic parameter (q) was used to define a threshold for PSAgr and PSAvar (PSAvar=q*PSAgr̂2). Combinations were considered to be above the threshold for ROC purposes if PSAgr was above the threshold and PSAvar was less than the threshold.

Additional risk assessment was performed using the percentage of high PSAgr (>15%) cancers missed at a given sensitivity. 15% PSAgr was chosen because it is an integer PSAgr roughly half way between the mean PSAgr for men who died from prostate cancer in Carter's article (20% from our analysis of the data in the article) and the mean PSAgr for men with prostate cancer who did not die from it (11%). For the threshold underlying each sensitivity for a screening method, the percentage of high PSAgr cancers was determined that would have remained undetected by that threshold.

ii. Results

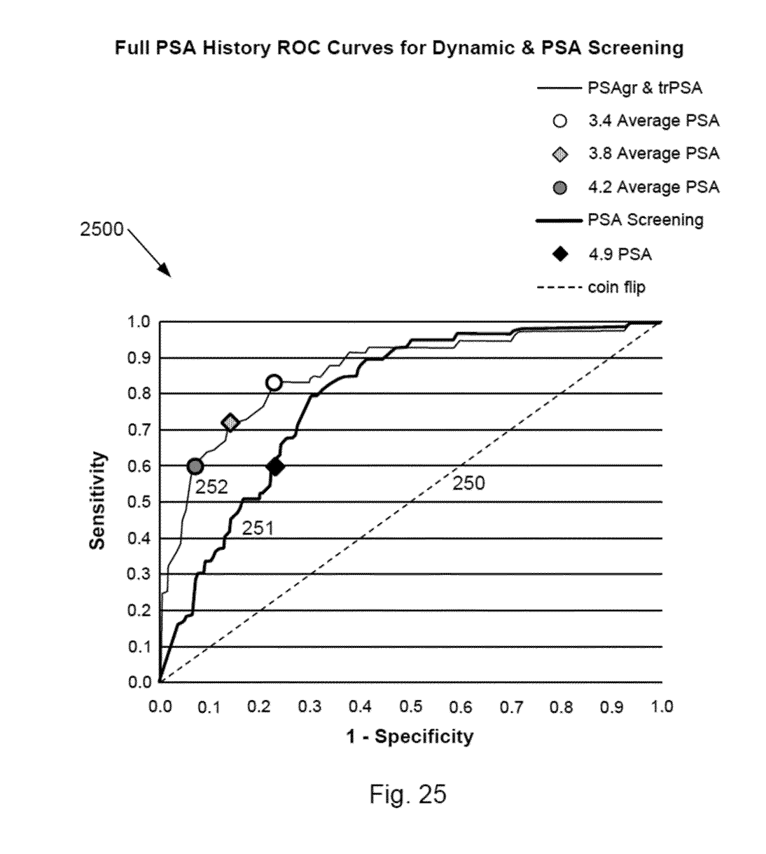

Results are depicted in the graph 2500 of FIG. 25. The AUC increases to 0.86 for Dynamic Analysis using PSAgr and PSAvar from 0.79 for a static PSA threshold for full PSA history. Dynamic Analysis offers men and their doctors the opportunity to increase sensitivity to serious cancers or increase specificity to no cancer or a preferred combination of both. The following ranges of improvements are shown in the graph 2500 of FIG. 25 for full PSA history: (1) 93% specificity instead of 77% at 60% sensitivity, (2) 83% sensitivity instead of 60% at 77% specificity, and (3) 86% specificity and 72% sensitivity instead of 77% and 60%.

For any sensitivity to serious cancers, Dynamic Analysis may miss a lower percentage of high PSAgr cancers than does static PSA screening. The following ranges of alternatives are shown in the graph 2500 of FIG. 25 for a full PSA history: (1) Static PSA Screening: 27% missed at 60% sensitivity and 77% specificity, and (2) Static PSA Screening: (a) 8% missed at 60% sensitivity and 93% specificity, (b) 2% missed at 72% sensitivity and 86% specificity, and (c) 1% missed at 83% sensitivity and 77% specificity.

iii. Discussion

Dynamic Analysis using PSAgr and PSAvar offers patients and doctors an improved range of choices for detecting high-risk cancers and distinguishing them from no cancer (AUC of 0.86 compared to 0.79 for static PSA screening for full PSA history). For example, specificity can be increased from 77% to 93% or sensitivity can be increased from 60% to 83% or some combination of increases.

Recent work has revealed that the proportion of high Gleason cancer increases for increasing PSAgr: for example, only 10% of cancers are high Gleason for low PSAgr from 0% to 10% compared to 38% for high PSAgr from 30% to 50%. Reevaluation of Carter's work shows that estimated average PSAgr is 20% for men who died of prostate cancer, 12% for men with no cancer and 11% for men who did not die from prostate cancer. These results raise the question of shifting the dominant screening focus from PSA only toward one that considers PSAgr more heavily because of its relationship with high Gleason cancers and cancers that are deadly.

iv. Conclusion

Dynamic Analysis using PSAgr and PSAvar can help improve sensitivity to the most serious cancers and specificity to no cancer found by biopsy. In addition, Dynamic Analysis misses a lower proportion of high PSAgr cancers, that may pose higher risks of death.

### E. Example 4

### Dynamic Screening Analysis of Biopsy Results

Biopsies provide valuable information to the Dynamic Screening process with widely varying implications depending on what the biopsy finds.

i. Negative Biopsy and Active Monitoring

If a biopsy is performed and finds no evidence of cancer, Dynamic Screening may decide to stop or continue screening. In one non-limiting example, a high, smooth PSA trend that resists Differential Treatment may suggest that a negative biopsy may be a false negative and recommend additional biopsies or other tests. In some embodiments, information about the biopsy is incorporated into the analysis, including but not limited to the number or distribution of needles used in the biopsy. The results from a negative biopsy can be incorporated into Dynamic Screening, with or without further analysis. A major benefit of a negative biopsy is the knowledge that large, progressed cancers are unlikely to reside in the man's prostate, because the spaces between biopsy needles is typically relatively small. For prostate cancer, a negative biopsy result will typically decrease the risk of deadly cancer for a given PSA trend. In some embodiments, a negative biopsy will cause Dynamic Screening to increase the PSA or PSAc threshold for determining cancer risk, where PSAc is an estimate of the PSA from prostate cancer using Dynamic Analysis methods.

The value of a negative biopsy in prostate cancer will have different effects depending on the results of other tests. In some embodiments, the effect of a negative biopsy on the Dynamic Screening process increases for higher levels of PSA, e.g. a PSA level of 5 or even 10. Consider a PSA level of 10, for example. If progressing cancer is the primary cause of this high PSA, then the tumor is likely to be large. A negative biopsy indicates that such a large tumor is unlikely. Therefore, the negative biopsy will decrease substantially the probability that progressing cancer is the primary cause of the high level of PSA and will increase substantially the probability that a no-cancer condition is the primary cause. In common practice, for a patient with high PSA, a follow-up biopsy is often performed after a negative biopsy because of fear that the first biopsy “missed” a prostate cancer tumor responsible for the high PSA level. In contrast, Dynamic Screening would account for the first negative biopsy by increasing resistance to suggesting another prostate biopsy in the absence of other factors (for example, if PSA levels increases substantially more at a reasonably high growth rate). A negative biopsy is thus good news that can be incorporated into Dynamic Screening if the patient continues screening for or Active Monitoring of a tumor. In some circumstances, such as for patients with short life expectancies, screening may be stopped after a negative biopsy because Dynamic Screening results in a calculated risk of deadly cancer that is sufficiently low to be ignored.

ii. Positive Biopsy and Active Surveillance

If a biopsy is performed and finds evidence of cancer, treatment may be recommended. In some embodiments, additional screening tests are recommended to evaluate the cancer, including but not limited to genetic tests to evaluate genes or expression levels in tumor cells. In some embodiments, the biopsy results and/or results of other tests are used to determine whether or when to initiate treatment of the cancer, or whether to maintain Active Surveillance of the cancer. In situations where the cancer is predicted to be slow-growing or otherwise less dangerous, where the lifespan of the patient is not expected to be sufficiently increased by treatment, or other similar circumstances, Dynamic Screening is more likely to recommend surveillance over treatment. Factors that may increase the likelihood of recommending surveillance include but are not limited to: pathology or imaging that shows the cancer is likely confined to the organ, a low Gleason score, and a small tumor size.

There may be a good chance that a small, indolent cancer found by a positive biopsy is too small and too slow growing to ever be a threat to a patient's life. The real threat may be a cell somewhere else in the prostate or other organ that mutates into an aggressive, fast-growing cancer. In some embodiments, Dynamic Screening is designed to use biomarker, e.g. PSA, trends to catch most of these cancers early enough for effective treatment. Similar to a negative biopsy, a major benefit of a biopsy that finds small indolent cancer is the knowledge that large progressed cancers are unlikely to reside in the organ (because the spaces between biopsy needles is relatively small). For prostate cancer, the risk of deadly cancer decreases somewhat for any given PSA trend. Therefore, in some embodiments, PSAc and PSA thresholds are slightly higher after a biopsy that finds small indolent cancer.

The value of a biopsy that finds a small, indolent cancer will have different effects depending on the results of other tests. In some embodiments, the effect of a biopsy that finds a small, indolent cancer on the Dynamic Screening process increases for higher levels of PSA, e.g. a PSA level of 5 or even 10. Consider a PSA level of 10, for example. If progressing cancer is the primary cause of this high PSA, then the tumor is likely to be large. A biopsy that finds only small indolent cancer indicates that such a large tumor is unlikely. Therefore, the positive biopsy that finds a small, indolent cancer will decrease substantially the probability that progressing cancer is the primary cause of the high level of PSA and will increase substantially the probability that a no-cancer condition is the primary cause. In this situation, Dynamic Screening would account for the first positive biopsy that finds a small, indolent cancer by increasing resistance to suggesting another prostate biopsy in the absence of other factors (for example, if PSA levels increase substantially more at a reasonably high growth rate). A positive biopsy that discovers only small indolent cancer is thus good news that can be incorporated into Dynamic Screening if the patient continues Active Monitoring of the cancer. In some circumstances, such as for certain patients with short life expectancies, Dynamic Screening may recommend against treatment because the risk of death from cancer is so small as to be ignored. In some circumstances, other tests may suggest a high risk even where the cancer discovered by biopsy is low risk, for example where Dynamic Analysis of PSA finds fast exponential growth of PSA above a baseline. Such high-risk results may suggest a subsequent, more extensive biopsy, or additional biopsy of nearby lymph nodes.

In some embodiments, a previously discovered cancer can be monitored by Dynamic Screening and follow-up biopsies, sometimes called Active Surveillance herein. For example, guided follow-up biopsies can help monitor tumor growth, help detect possible mutations or development of the tumor to a higher Gleason score, discover new tumors, and provide tumor tissue for other analysis steps, such as genetic analysis. Multiple biopsy pathology results can be incorporated into Dynamic Screening. There is some chance that a small indolent cancer found by biopsy will grow faster than expected, perhaps after a further mutation to a more aggressive, fast growing cancer. Ideally, the small indolent tumor can be monitored for growth and for mutation to more aggressive Gleason scores. The new Artemis device, for example, allows accurate guidance of biopsy needles to tumors found by previous biopsies, though other methods for biopsy, guided and unguided, are also suitable. The biopsy cores and results of other tests, including images, can be used to estimate tumor growth, and the pathologic evaluation of the tumor tissue in the needle cores can be used to identify increases in tumor aggression (e.g. to higher Gleason scores).

### F. Example 6

### Dynamic Screening Cost Analysis

The following example presents a way of implementing key elements of Dynamic Screening cost analysis. A simulation method may be used to estimate various risks of death from prostate cancer. Similar methods could be used for other end points, such as metastasis.

This example presents one exemplary subject with a new PSA test of 4.0. The subject is John Doe—Age 60 with 25 Year Life Expectancy and High PSAgr.

i. Pattern of PSA History

Dynamic Screening typically uses algorithms to fit consistent trends to a man's PSA history. The functional form comprises a no cancer baseline, PSAn, plus an exponential function that may reflect increasing PSA from cancer, PSAc. PSAc has a growth rate, PSAgr, that can tend to reflect the deadliness of the cancer. The higher the growth rate, the more deadly the cancer—if progressing cancer is the cause of the increasing PSA. In addition, PSA variability is measured in several ways. PSA from deadly cancers tends to grow exponentially in a smooth curve with little variation, while PSA from other causes may not grow exponentially and often varies around the trend, sometimes with jumps and drops. Consistent trends exclude anomalous jumps that are likely to have been caused by prostatitis and strongly consider lower bound tests that are most likely to reflect an underlying source of increasing PSA from cancer.

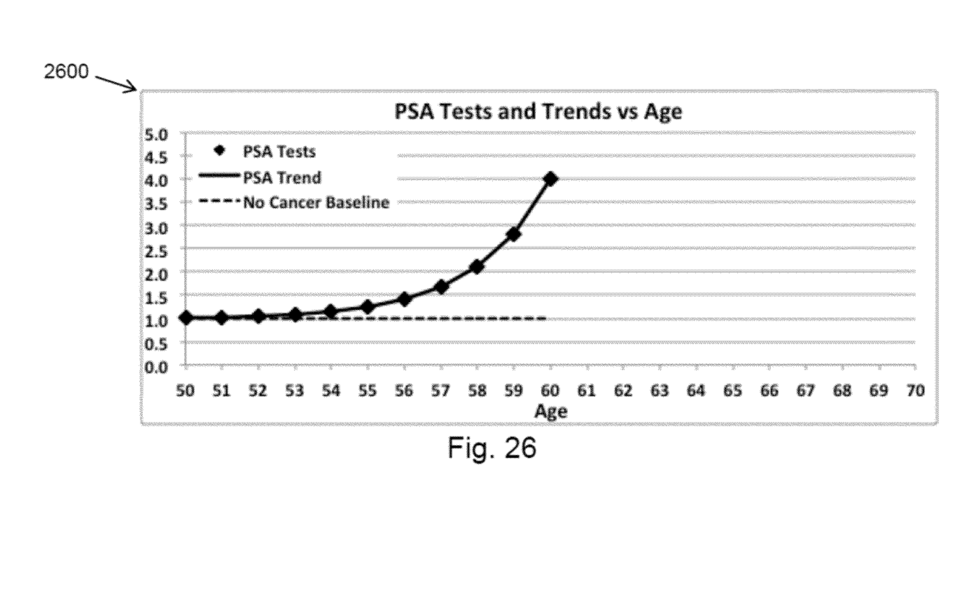

John Doe—Age 60 with 25 Year Life Expectancy and High PSAgr: In this example, John Doe has a very dangerous looking PSA history: a 50% per year growth rate in cancer PSA (PSAgr), a 3.0 cancer PSA (PSAc), a 1.0 no cancer baseline (PSAn), and a smooth PSA growth with no jump or drop (PSAvar measures). If caused by progressing cancer, the high 50% growth rate and substantial cancer PSA of 3.0 may be of significant concern because the deadliest cancers have a similar pattern. The smooth growth with minimal variation increases the odds that progressing cancer is the cause of this increasing PSA because prostatitis tends to have a lower PSAgr and/or cause jumps, drops or smaller variations around the trend. A graph of the data with estimated trends is shown in the graph 2600 of FIG. 26.

ii. Information About the Man

Typically, three key pieces of personal information are used in the Dynamic Screening analysis: (i) age—which helps establish risk factors from population data, (ii) life expectancy—which allows us to calculate risks of death over time, and (iii) treatment equivalent death risk (TEDR), or risk preference,—which is a subjective assessment by the man that reflects his relative weights of the risks of death from prostate cancer and the risks of side effects of treatment (and implicitly over-treatment).

Age is easily determined.

Life Expectancy is a function of age and the man's health. His doctor can estimate his life expectancy, or he can use an online calculator, for example: http://www.livingto100.com/.

Treatment Equivalent Death Risk (TEDR), or risk preference, reflects a subject's subjective relative concerns about the risk of death from prostate cancer and the risk of side effects from treatment. It sets the threshold needed to justify treatment his personalized analysis. It is analogous to the Number Needed to Treat (NNT) used in medical studies. Its inverse, Death Reduction Percentage (DRP), is the percentage of future life scenarios in which the man expects treatment to prevent his death from prostate cancer, as shown in the examples below.

Down the road, race, family history and more detailed medical history may be incorporated along with age, life expectancy and TEDR.

In our examples, our two subjects have the following information.

John Doe—Age 60 with 25 Year Life Expectancy and High PSAgr: (i) Age 60, (ii) 25 Year Life Expectancy, and (iii) 10 TEDR (Moderate) or 10% DRP for Balanced Concerns about Risks.

iii. Scenario Risk of Death from Prostate Cancer

In this example, Dynamic Screening evaluates 100 equal probability scenarios to calculate a man's risk of death from prostate cancer, as explained in more detail in the two example reports. It may be necessary to evaluate these scenarios because the man might live a long time when slow growing prostate cancer could kill him or live a short time when he will die of some other cause. In a similar way, prostate cancer might progress relatively quickly to death or progress very slowly to death, where the man usually dies of some other cause.

In the following section, we consider the risk of death from prostate cancer for each man for the treatment now case and the no treatment (ever) case. These are the easiest to understand cases that bound a full range of delay cases, such as Actively Monitor for one year, for example.

(iii) Scenario Simulations

Dynamic Screening evaluates 100 equal probability scenarios to calculate the risk of death from prostate cancer. Our simulation of these scenarios can be explained as follows.

a. Probabilities of Being Alive and Dead from Cancer

The simulations can be driven by probabilities of being alive and dead from prostate cancer, as shown below and explained in the following sections.

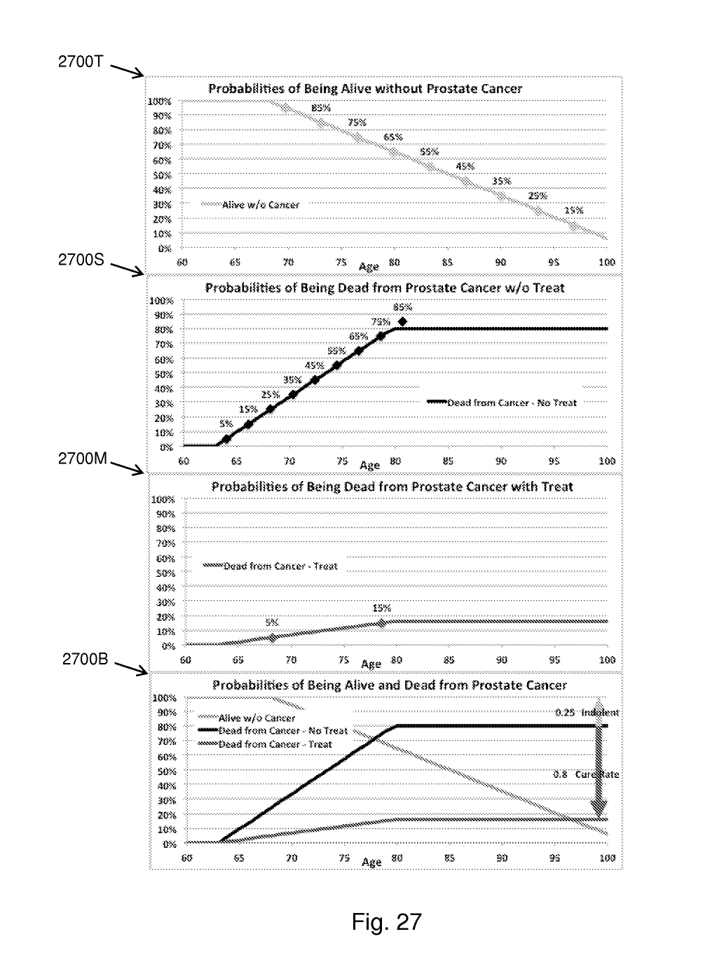

Probabilities of Being Alive without Prostate Cancer: John Doe's estimated his life expectancy of 25 years, which can be a starting point for analysis. Life expectancy may only be a best guess. He might live a longer or shorter life. Actuaries have estimated from population data the probability of living various additional years given a life expectancy. FIG. 27 Top graph 2700T shows an estimate of John Doe's probability of living to various ages given his life expectancy of 25 years. The diamonds show 10 equally likely life scenarios, each with a 10% chance of occurring. We consider these 10 life scenarios in conjunction with 10 cancer death scenarios, which are presented in the next two sections.

Probabilities of Being Dead from Prostate Cancer w/o Treatment: Dynamic Screening estimated John Doe's probability of being dead from prostate cancer without treatment by comparing his PSA history to a population of men. The first step is to estimate the probability of death over time from deadly cancer, assuming he will not die of other causes. The second step is to estimate the probability that cancer is indolent and will not be deadly over a long lifetime. This indolent cancer probability reduces the risk of death from estimates for deadly cancer.

FIG. 27 Second graph 2700S shows an estimate of John Doe′ probability of death from prostate cancer at various ages, assuming he has not died of other causes. The diamonds show the first 9 of 10 equally likely cancer death scenarios, each with a 10% chance of occurring. There is no chance of death for the remaining scenario that is not shown. We consider these 10 cancer death scenarios in conjunction with the 10 life scenarios, presented in a previous section.

Probabilities of Being Dead from Prostate Cancer with Treatment: Dynamic Screening estimated John Doe's probability of being dead from prostate cancer with treatment by comparing your PSA history to a population of men. The first step may be to estimate the probability of death over time from deadly cancer, assuming he does not die of other causes, as presented in the previous section. The second step may be to estimate the treatment reduction in the probability of death over time from deadly cancer (think cure rate). The third step may be to estimate the probability that cancer is indolent and will not be deadly over a long lifetime. This indolent cancer probability reduces the risk of death from estimates for treated deadly cancer.

FIG. 27 Third graph 2700M shows an estimate of John Doe's probability of death from prostate cancer at various ages, assuming he has not died of other causes. The green diamonds show the first 2 of 10 equally likely cancer death scenarios, each with a 10% chance of occurring. There may be no chance of death for the remaining 8 scenarios that are not shown. We consider these 10 cancer death scenarios in conjunction with the 10 life scenarios, presented in the previous section.

Summary of Death Scenarios: The three death scenarios are summarized on the graph in FIG. 27 Bottom graph 2700B. The arrow pointing upward (25% Indolent) shows the effect of indolent cancers where for every 4 chances of deadly cancer there is a chance of 1 indolent cancer. The result is a 20% reduction in the risk of death from deadly cancer alone (20%=1 Indolent/[4 deadly+1 Indolent]). The arrow pointing downward (80% Cure Rate) shows the estimated reduction in cancer death risk caused by treatment.

b. Combined Scenarios with 1% Probability

We now consider 100 combined scenarios, which is equal to 10 life scenarios times 10 cancer death scenarios. The probability of each of the 100 scenarios is 1% (1%=10% chance of each life scenario times 10% chance of each cancer death scenario). Each life scenario has an age at death from other causes, and each cancer death scenario has an age at death from prostate cancer. The years of life lost from prostate cancer for each of the 100 scenarios is simply the difference between the life age and the cancer death age. For example: (i) 5 years of life lost if life age is 90 and cancer death age is 85, and (ii) 0 years of life lost if life age is 85 and cancer death age is 90 (the man died of other causes before cancer could progress to death).

c. No Treatment Scenarios

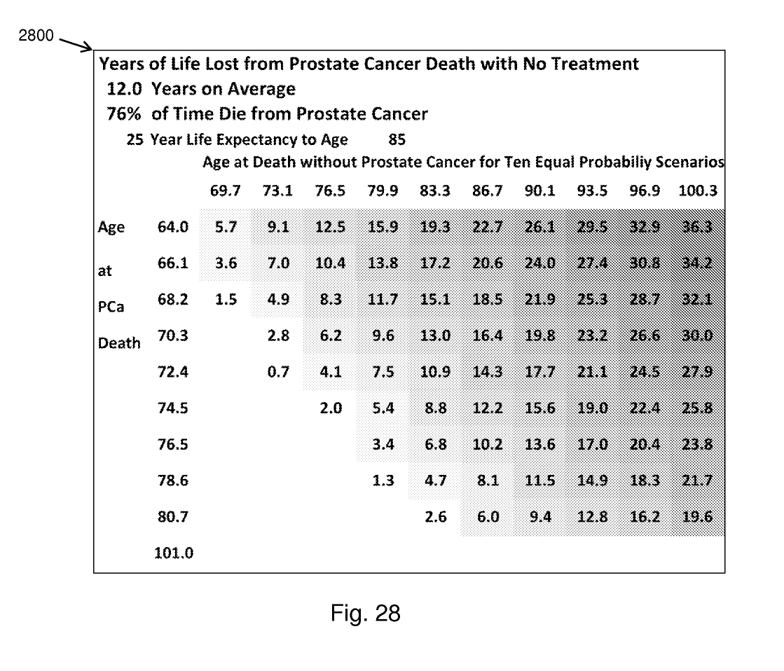

For the no treatment scenarios, the lost life map is shown in the table 2800 of FIG. 28 for 100 scenarios. For the 10 life scenarios, ages at death are shown across the top row. For the 10 cancer death scenarios, ages at death are shown down the left column. Years of lost life are shown in the 100 scenario cells, with more intense shading indicating more years lost.

d. Treatment Scenarios

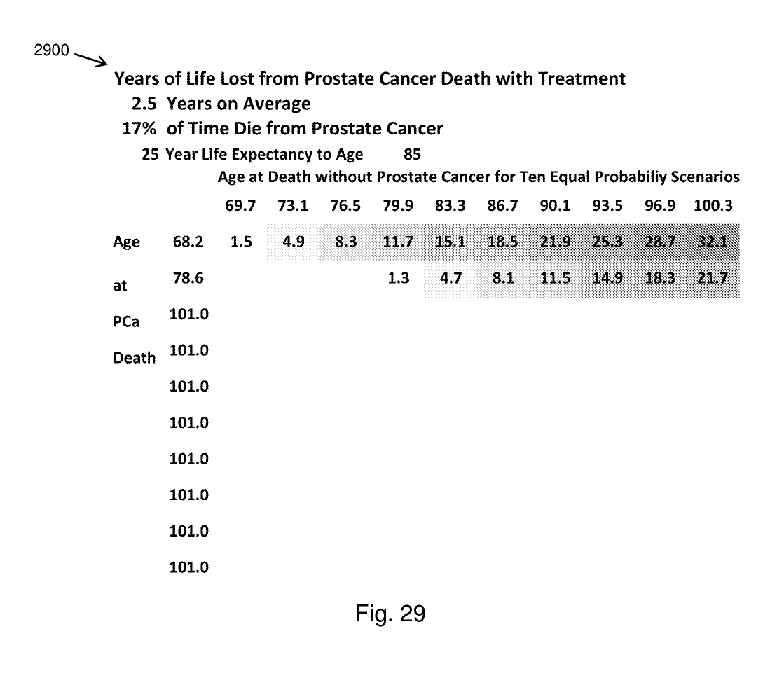

For the treatment scenarios, the lost life map is shown in the table 2900 of FIG. 29 for 100 scenarios. For the 10 life scenarios, ages at death are shown across the top row. For the 10 cancer death scenarios, ages at death are shown down the left column. Years of lost life are shown in the 100 scenario cells, with more intense shading indicating more years lost.

iv. Detailed Combined Scenarios with 1% Probability

Each bar on each graph of Fig YP2 shows three results: No Prostate Cancer, Treatment Now and No Treatment. The five longest life scenarios without prostate cancer are shown on the five graphs (graph 3000A for 0%-9% LE—100.3 years, graph 3000B for 10%-19% LE—96.9 years, graph 3000C for 20%-29% LE—93.5 years, graph 3000D for 30%-39% LE—90.1 years, graph 3000E for 40%-49% LE—86.7 years) with the five shorter life scenarios without prostate cancer not shown. Comparing No Treatment (shown by the left bars) to No Prostate Cancer (shown by the full length of the bars) shows the full potential impact of prostate cancer on death (shown by the sum of the right and middle bars).

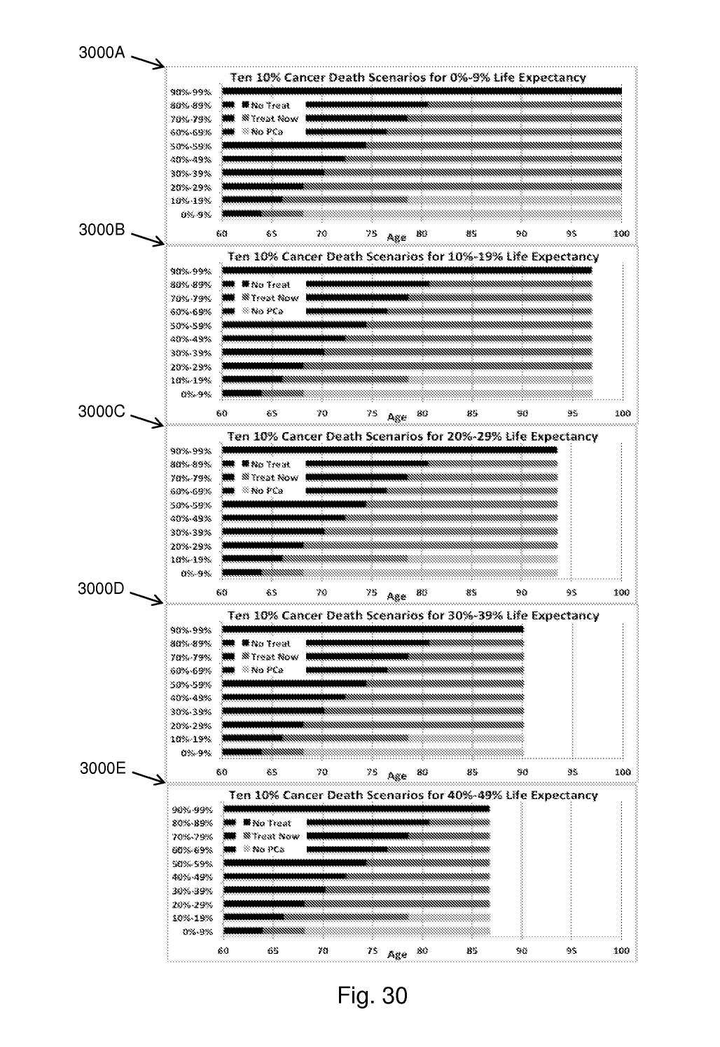

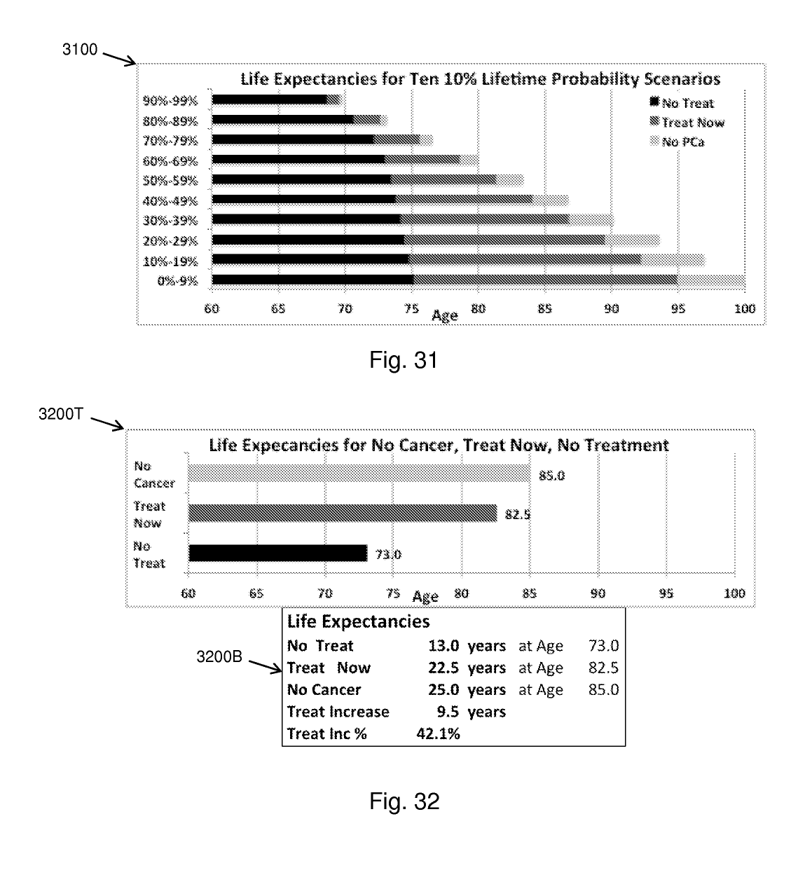

0%-9% Life Expectancy (Longest)—Ten Cancer Death Scenarios: The graph 3000A in FIG. 30 shows the 10 cancer death scenarios for the longest (0%-9%) life scenario, shown by the bottom bar on the summary graph 3100 of FIG. 31. The life scenario is death at age 100.3 for all 10 cancer death scenarios. Each bar on the graph represent a 1% combined scenario and the graph represents 10% of the 100 combined scenarios.

The bottom bar shows the worst cancer scenario. Without prostate cancer John Doe would live to age 100.3, as shown by the right end of the bottom most right bar. With prostate cancer but without treatment he would live to age 64, as shown by the right end of the bottom most left bar. With treatment, he would live to 68, as shown by the right end of the bottom most middle bar. This 1% scenario may be the one where treatment has the least benefit. The second bar from the bottom shows a less severe cancer case where treatment has a big benefit. The third bar from the bottom shows a less severe cancer case where treatment has an even bigger benefit with no loss of life, as is true for all the bars above.

10%-19% Life Expectancy—Ten Cancer Death Scenarios: The graph 3000B in FIG. 30 shows the 10 cancer death scenarios for the second longest (10%-19%) life scenario, shown by the next to last bar on the summary graph 3100. The life scenario is death at age 96.6 for all 10 cancer death scenarios. Each bar on the graph represent a 1% combined scenario and the graph represents 10% of the 100 combined scenarios.

The bottom bar shows the worst cancer scenario. Without prostate cancer John Doe would live to age 96.6, as shown by the right end of the bottom most right bar. With prostate cancer but without treatment he would live to age 64, as shown by the right end of the bottom most left bar. With treatment, he would live to 68, as shown by the right end of the bottom most middle bar. This 1% scenario may be the one where treatment has the least benefit. The second bar from the bottom shows a less severe cancer case where treatment has a big benefit. The third bar from the bottom shows a less severe cancer case where treatment has an even bigger benefit with no loss of life, as may be true for all the bars above.

20%-29% Life Expectancy—Ten Cancer Death Scenarios: The graph 3000C in FIG. 30 shows the 10 cancer death scenarios for the third longest (20%-29%) life scenario, shown by the third to last bar on the summary graph 3100. The life scenario may be death at age 93.54 for all 10 cancer death scenarios. Each bar on the graph represent a 1% combined scenario and the graph represents 10% of the 100 combined scenarios.

30%-39% Life Expectancy—Ten Cancer Death Scenarios: The graph 3000D in FIG. 30 shows the 10 cancer death scenarios for the fourth longest (30%-39%) life scenario, shown by the fourth to last bar on the summary graph 3100. The life scenario may be death at age 90.1 for all 10 cancer death scenarios. Each bar on the graph represent a 1% combined scenario and the graph represents 10% of the 100 combined scenarios.

40%-49% Life Expectancy—Ten Cancer Death Scenarios: The graph 3000E in FIG. 30 shows the 10 cancer death scenarios for the fifth longest (40%-49%) life scenario, shown by the fifth to last bar on the summary graph 3100. The life scenario may be death at age 86.7 for all 10 cancer death scenarios. Each bar on the graph represent a 1% combined scenario and the graph represents 10% of the 100 combined scenarios.

v. Summary Combined Scenarios with 10% Probability

FIG. 31 shows a chart 3100 showing that most of the increase in life expectancy from treatment, shown by the middle bar sections, occurs in scenarios when John Doe lives longer than his 25 year life expectancy, shown by the bars on the lower half of the graph. Each bar (full length) shows a life length with a 10% chance of occurring. For example, the bottom bar shows that John Doe has a 10% chance of living to 100.3 in the absence of prostate cancer. For that life length, prostate cancer with no treatment reduces his average life to 75 with no treatment (right end of left bar) and 95 with treatment (right end of middle bar).

vi. Scenario Reduction in Life Expectancy from Prostate Cancer

In this example, Dynamic Screening evaluates 100 equal probability scenarios to calculate a man's reduction in life expectancy from prostate cancer. For many men, reduction in life expectancy is easier to understand and more meaningful than reduction in the risk of death from prostate cancer. In the following section, we consider the reduction in life expectancy from prostate cancer for the treatment now case and the no treatment (ever) case, based on the simulations presented above.

John Doe—Age 60 with 25 Year Life Expectancy and High PSAgr: John Doe expects to live 25 years to age 85 and his PSA pattern looks like deadly cancer. As shown in FIG. 32 Top 3200T and Bottom 3200B, the Dynamic Screening system estimates that prostate cancer with no treatment will reduce his life expectancy by 12.0 years to age 73.0 and treatment now will reduce his life expectancy (from no cancer) by only 2.5 years to age 82.5. These results imply a 9.5 year increase in life expectancy with treatment now vs. never. This translates into a 42.1% increase in life expectancy with treatment.

vii. Scenario Reduction in Death Risk from Prostate Cancer

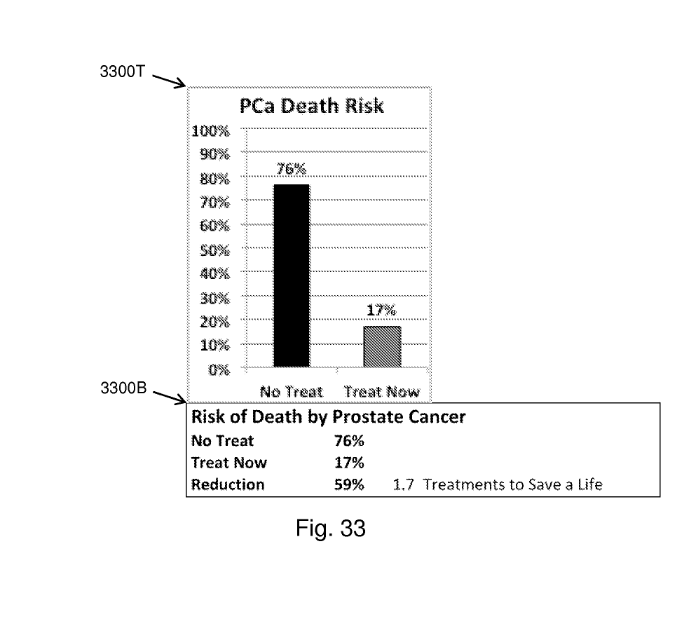

John Doe is age 65 and expects to live 25 years. His PSA pattern looks like deadly cancer. As shown in FIG. 33 Top 3300T and Bottom 3300B, the Dynamic Screening system estimates that he has a 76% chance of death from prostate cancer with no treatment and a 17% chance of death with treatment now. These results imply a 59% point reduction in the chance of death from prostate cancer with treatment now. This translates into 1.7 treatments to save a life, which may be much lower than John Doe's threshold TEDR, or risk preference, of 10.

Many of the methods and procedures described herein, including the steps and sub-steps thereof, can be implemented by a processor or a computer system comprising a processor and a tangible medium embodying machine-readable code including instructions for performing the methods and procedures described herein.

Also, although the steps of the methods and procedures are described with reference to specific embodiments herein, one skilled in the art can recognize many variations based on the teachings herein. The steps may be completed in different orders. One or more of the steps may be added or omitted. One or more of the steps may comprise one or more sub-steps. One or more of the steps may be repeated.

### EXPERIMENTAL EXAMPLES

Embodiments of the present disclosure may provide computer systems that synthesize PSA trend analysis and MRI image analysis to estimate costs (increasing death risk) as part of a cost-benefit analysis reported to a subject and his physician for making decisions about prostate cancer screening actions. While the synthesis of PSA trend and MRI analysis may be emphasized herein, other forms of analysis and targets for analysis are also contemplated.

Computer systems as described herein may perform Dynamic Analysis of PSA trends and key variables such as PSAc, PSAgr, PSAvar, and PSAV (=PSAgr*PSAc). The use of trends with PSAV and PSAvar are described in co-assigned U.S. Pat. No. 8,538,778, the contents of which are incorporated herein by reference.

Computer systems as described herein may perform one or more of static or Dynamic Analysis of MRI imaging and key variables such as prostate volume, tumor volume, location, and, distance to prostate capsule.

Computer systems as described herein may combine the Dynamic Analyses of PSA trends and MRI images.

Computer systems as described herein may regard the Cancer Tempo, or Death Risk Speed as the central cost of further screening instead of a biopsy (and treatment) now. Cancer Tempo or Death Risk Speed may be defined by the rate of increase in death risk at a given time after diagnosis/treatment or life expectance (dDR/dt). It can be useful and important because it may comprise the cost of the critical screening decision: screen more rather than biopsy now. Cancer Tempo or Death Risk Speed often cannot be estimated sensibly without Dynamic Analysis of PSA or MRI images to provide the starting rate of change for the analysis. Cancer Tempo (CT) or Death Risk Speed (DRS)

The U.S. Preventative Services Task Force (USPSTF) has asked for new methods to identify deadly cancers. Generally, there are two components to identifying deadly cancers: (i) the probability a biopsy finds cancer (that might be deadly) and (ii) the deadliness of the cancer if found by biopsy. Generally, there are two ways of thinking about deadliness: (i) static (how deadly is the cancer likely to be if diagnosed and presumably treated now) and (ii) dynamic (how fast is the cancer increasing in deadliness?).

CT/DRS may provide a quantitative answer to the latter question. For example, if CT/DRS is 0%, then the risk of death from prostate cancer may not be increasing and there may be little or no cost to further screening rather than biopsy now. Therefore, it may make sense to screen further when DRV=0%. Further, if CT/DRS is small, then the risk of death from prostate cancer may be increasing slowly and there may be little cost to further screening rather than biopsy now. Therefore, it may makes sense to screen further when CT/DRS is small. Even further, if CT/DRS is large, then the risk of death from prostate cancer may be increasing rapidly and there may be substantial cost to further screening rather than biopsy now. Therefore, it may make sense to biopsy now when DRV is large.

The use of CT/DRS may answer most of the cost side of the screening decision analysis. A biopsy is the primary prostate cancer screening action because of the potential major consequences—ranging from successful early treatment to over-treatment with subsequent side effects. Screen further or biopsy now is the critical prostate cancer screening decision. Cost-benefit is the essential analysis of that decision. The speed at which cancer is increasing in deadliness is the primary cost of further screening rather than biopsy now.

### Generating Personalized Prostate Cancer Decision Reports

Embodiments of the present disclosure may provide computer-implemented systems for generating a personalized prostate cancer decision report.

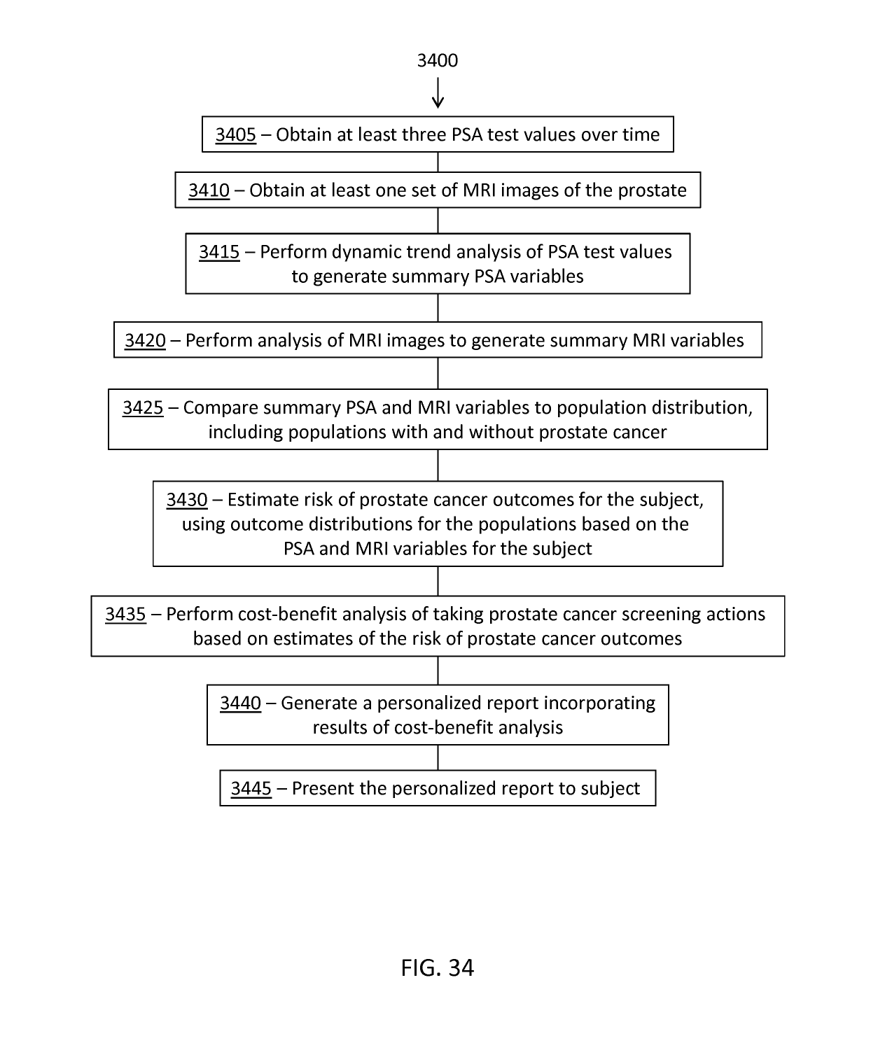

FIG. 34 shows an exemplary computer-implemented method 3400 for generating a personalized prostate cancer decision report.

In a step 3405, a computer system may obtain at least three PSA test values over time for a subject. The computer system may allow entry of the PSA values through a user interface. Alternatively or in combination, the computer system may automatically search for the PSA values within one or more databases.

In a step 3410, the computer system may obtain at least one set of MRI images of the prostate for a man. The computer system may allow entry of the MRI image(s) through a user interface. Alternatively or in combination, the computer system may automatically search for the MRI image(s) within one or more databases.

In a step 3415, the computer system may perform dynamic trend analysis of the PSA test values to generate summary PSA variables. Such dynamic analysis is described further herein.

In a step 3420, the computer system may perform analysis of the MRI images to generate summary MRI variables. Examples of MRI variables, which may be static or dynamic, may include prostate volume, tumor volume, location (including distance to the prostate capsule), and rates of change thereof. MRI image analysis is also described further herein.

In a step 3425, the computer system may compare the summary PSA and MRI variables to distributions of the same variables for populations with and without prostate cancer.

In a step 3430, the computer system may estimate the risk of prostate cancer outcomes for the subject using distributions of outcomes for the population based on the PSA and MRI variables for the subject. In some embodiments, the risk may be estimated by estimating the rate of death increase (i.e., cancer tempo, CT, or death risk speed, DRS) as the key cost outcome.

In a step 3435, the computer system may perform a cost-benefit analysis of taking prostate cancer screening actions based on estimates of the risk of prostate cancer outcomes.

In a step 3440, the computer system may generate a personalized report which incorporates the results of the cost-benefit analysis.

In a step 3445, the computer system may present the personalized report to the subject such as by displaying the report or a summary thereof through a user interface and/or display of the computer system. The subject may discuss the report with a medical professional. The subject may take or delay prostate cancer screening action based on the report.

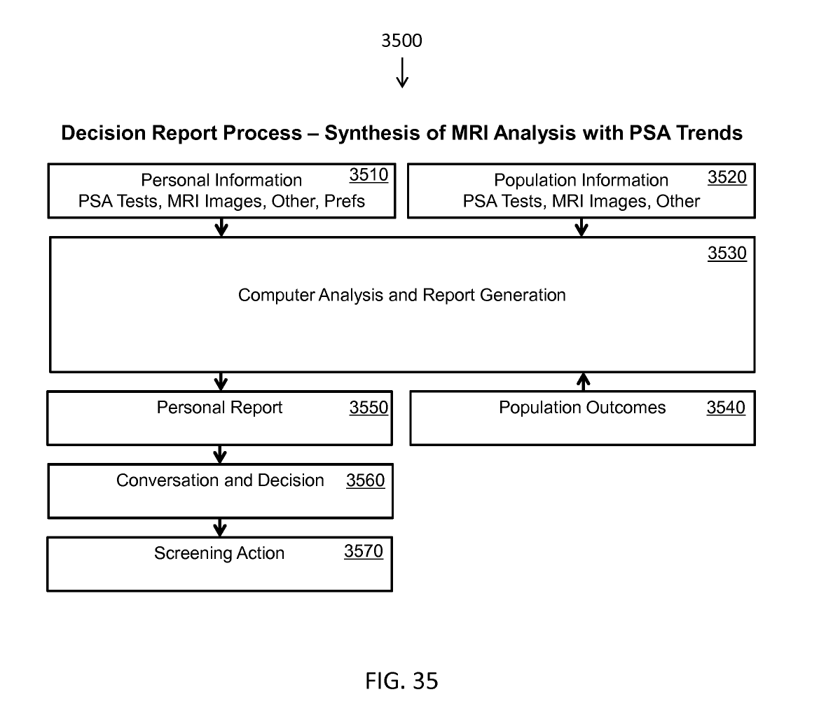

FIG. 35 shows an exemplary computer-implemented method 3500 for generating a personalized prostate cancer decision report. The methods 3400 and 3500 may be similar in many respects.

As indicated by the box 3510, personal information may be an input for the computer analysis and report generation system. For example, at least three PSA test values over time and at one set of MRI images of the prostate may be obtained for a subject. The computer system may allow entry of the PSA values and MRI images through a user interface. Alternatively or in combination, the computer system may automatically search for the PSA values and MRI images within one or more databases. The personal information, including PSA test values and MRI images, are obtained and considered by the computerized analysis and report generation. Personal preferences about risk may also be obtained from the man.

As indicated by the box 3520, population information may be an input for the computer analysis and report generation system. Personal information about many men in a population, including PSA test values and MRI images, may be obtained and considered by the computerized analysis and report generation.

As indicated by the box 3530, the computerized system may perform various analysis steps and may produce a personalized report based on the cost-benefit results. The analysis may include, for example, one or more of performing dynamic trend analysis of the PSA test values to generate summary PSA variables, performing analysis of the MRI images to generate summary MRI variables, comparing the summary PSA and MRI variables to distributions of the same variables for populations with and without prostate cancer, estimating the risk of prostate cancer outcomes for the man using distributions of outcomes for the population based on the PSA and MRI variables for the man, performing a cost-benefit analysis of taking prostate cancer screening actions based on estimates of the risk of prostate cancer outcomes, and incorporating the results of the cost-benefit analysis in a personalized report.

As indicated by the box 3540, population information may be an input for the computer analysis and report generation. Personal information about outcomes for many men in a population, including death, death from cancer and metastasis, may be obtained to be considered by the computerized analysis and report generation system.

As indicated by the box 3550, a personal report may be computer-generated. The personal report may summarize the cost-benefit tradeoffs in terms of outcomes for prostate cancers screening actions.

As indicated by the boxes 3560 and 3570, the patient may consider various options in response to the decision report and take specific screening actions after consideration. As indicated by the box 3560, a conversation and decision may occur between the subject and his medical professional. For example, the medical professional or physician may discuss the report with the subject such as about cost-benefit tradeoffs of prostate cancers screening actions. As indicated by the box 3570, the subject may make screening action(s) based on the report as well as the medical professional discussion. For example, the subject may take or delay delaying prostate cancer screening action based on the report. Alternatively or in combination, the medical professional may takes or delays prostate cancer screening actions based on the decision of the man informed by the earlier discussion.

Although the above steps show computer-implemented methods 3400 and 3500 of generating personalized prostate cancer decision reports, a person of ordinary skill in the art will recognize many variations based on the teaching described herein. The steps of the methods may be completed in a different order. Steps may be added or deleted. Some of the steps may comprise sub-steps. Many of the steps may be repeated as often as desired.

### Prophetic Example No. 1

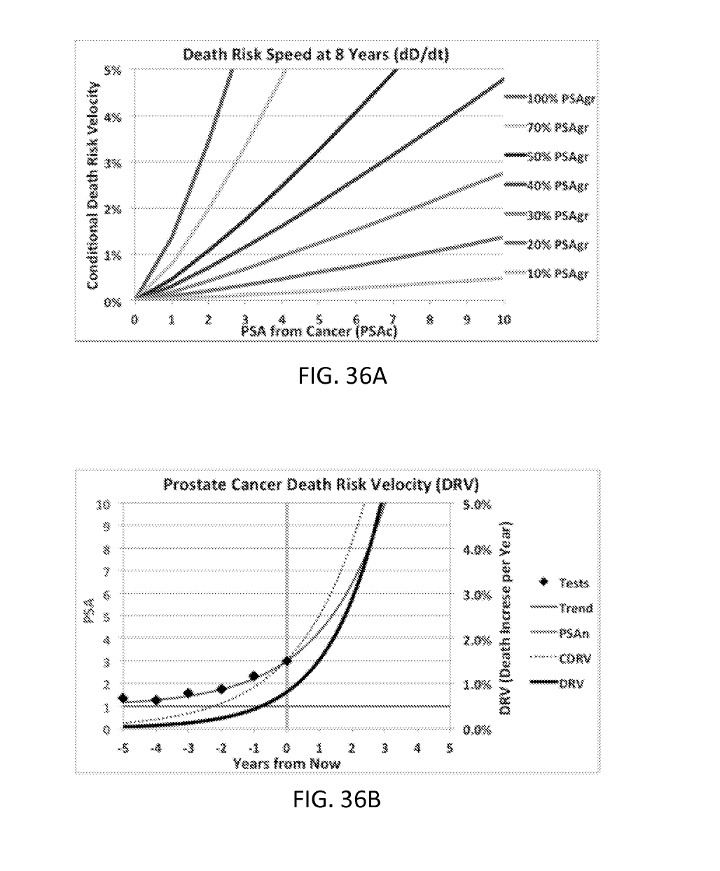

A 60-year-old man may present the computer system with the PSA tests shown on the graph in FIG. 36B (that may be analyzed to show 2.0 PSAc, 50% PSAgr, 10% PSAvar) and MRI images (that may be analyzed to show moderately strong evidence of a 1 cc organ-confined cancer). The computer system can process this information, estimate summary variables, and compare them to distributions for the population for which outcomes may be known. For example, the computer system can estimate CT/DRS at a given life expectancy or time after diagnosis/treatment as a function of a range of PSAc and PSAgr, as shown on FIG. 36A. The computer system may further perform additional steps of a cost-benefit analysis.

Generated by the computer system, the graph in FIG. 36B shows the PSA trend and the estimated and projected prostate cancer CT/DRS curve, which is the primary cost of further screening rather than a biopsy now. A CT/DRS risk threshold of 1.0% CT/DRS has been estimated based on the man's risk preferences and the computer system's analysis of the benefits of further screening rather than biopsy now.

The graph in FIG. 36B further shows that CT/DRS has nearly reached the man's 1.0% threshold. The subject decides on a biopsy soon and his physician takes that action.

### Prophetic Example No 2

A 65-year-old man presents the computer system with the PSA tests shown on the graph (that are analyzed to show 4.0 PSAc, 10% PSAgr, 80% PSAvar) and MRI images (that are analyzed to show weak evidence of a 0.2 cc organ-confined cancer). The computer system can process this information, estimate summary variables, and compare them to distributions for the population for which outcomes may be known. The computer system may further perform a cost-benefit analysis.

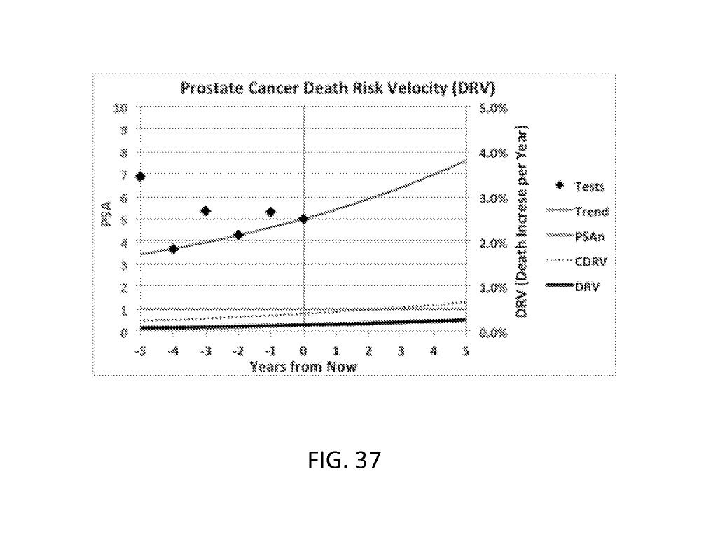

Generated by the computer system, the graph in FIG. 37 shows the PSA trend and the estimated and project prostate cancer Death Risk Velocity curve, which is the primary cost of further screening rather than a biopsy now. A DRV risk threshold of 1.5% DRV has been estimated based on the man's risk preferences and the computer system's analysis of the benefits of further screening rather than biopsy now.

The graph shows that CT/DRS of 0.2% is far below the man's 1.5% threshold. The subject decides to continue screening with a PSA test in one year and his physician schedules that action.

Synthesis of MRI Analysis with PSA Trends

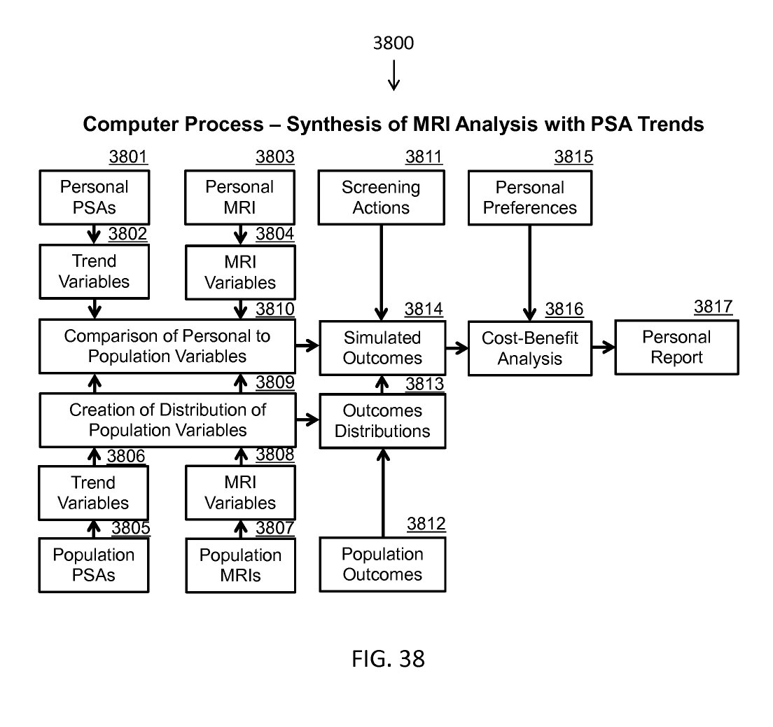

FIG. 38 shows a flowchart of a computer-implemented process 3800 of synthesizing MRI analysis with PSA trends.

Referring to the box 3801 (Personal PSAs), pre-diagnosis PSA test results may be collected for the subject and entered into the computer system, which may calibrate the PSA values to Beckman-Coulter or WHO standard.

Referring to the box 3802 (Trend Variables), the computer system may use Dynamic Analysis methods as described herein to estimate consistent PSA trends for each man using an exponential plus constant function. Descriptive variables may be calculated. Consistent PSA trends may be estimated by iteratively estimating exponential plus constant function to include data and then excluding the past test whose positive percentage deviation exceeds the tolerance region by the greatest amount. PSA trend variables that may be estimated may include PSAc, PSAgr, PSAn, PSAvar as described above with reference to FIGS. 12A, 12B, 12F, 12G, 12H, and 12K for example. The trend may be projected into the future using the functional form: PSA(t)=PSAn+PSAc(0)*EXP(PSAgr*t), for example. In some embodiments, many PSA test may be projected as described above with reference to FIG. 12J. In some embodiments, the rate of PSA increase and the projected increase in one year may be determined as described above with reference to FIG. 17.

Often, such determinations are very calculation intensive processes that can take thousands of iterations. An outer loop(s) may check for prior PSA tests that exceed the tolerance range and may successively exclude the test with the greatest percent deviation from the previously estimated trend (until all PSA tests are within the tolerance range of the final estimated trend). An inner loop(s) may fit an exponential plus constant trend to the included PSA tests subject to the constraints that the trend pass through the last PSA test, exactly, and all low test are generally included in the tolerance range. For example, a high-powered Solver from Frontline Systems may be used to estimate the parameters of the function that best fits the data and is consistent with the tolerance range constraints. Different parameter seed values often must be tried to achieve convergence. The solver often takes hundreds of iterations to converge and may take thousands of iterations.

Referring to the box 3803 (Personal MRI), MRI images of the prostate may be collected for the subject and entered into the computer system for analysis.

Referring to the box 3804 (Personal MRI Variables), for each subject, the computer system may estimate descriptive variables for the prostate and potential cancer lesions of each subject. MRI images may be interpreted for evidence of prostate cancer. MRI image variables including image tumor strength/aggressiveness, tumor volume, and tumor location (organ-confined or extra-capsular) may be estimated along with overall prostate volume. The analysis of MRI image variables is described further above, for example, with reference to FIGS. 13 and 14. Such analysis is generally calculation intensive, often taking thousands of calculations by a computer system to estimate one variable. The computer system may be augmented by human interaction or may be fully-self sufficient.

Referring to the box 3805 (Population PSAs), pre-diagnosis PSA test results may be collected for the many men in the population and may be entered into the computer system, which may calibrate the PSA values to a Beckman-Coulter or WHO standard.

Referring to the box 3806 (Trend Variables), the computer system may use Dynamic Analysis methods to estimate consistent PSA trends for the many men in the population using an exponential plus constant function. Descriptive variables may be calculated, as described for example, with reference to the Personal PSA Trend Variables section above. Often, thousands of iterations must be done for each man in sometimes very large populations. For example, for VA data, we start with 33 million PSA tests for 14 million men. Over a billion calculations may be needed to perform this analysis.

Referring to the box 3807 (Population MRIs), the computer system may collect MRI images of the prostate for the many men in the population and may be entered into the computer system for analysis.

Referring to the box 3808 (MRI Variables), the computer system may estimate descriptive variables for the prostate and potential cancer lesions of each of the many men in the population. Such estimation is described above in the Personal MRI Variables section above. Often, thousands of calculations must be done for each man in the population. For existing populations, hundreds or thousands of MRI images often must be analyzed.

Referring to the box 3809 (Creation of Distribution of Population Variables), the computer system may aggregate PSA Trend and MRI variables for the many men in the population into distributions of population variables.

Referring to the box 3810 (Comparison of Personal to Population Variables), the computer system may compare the personal PSA Trend and MRI variables of the man to the distribution of those variables for the many men that correspond to the distribution of outcome variables for the population.

Referring to the box 3811 (Screening Actions), the computer system may consider possible screening actions by the physician for the subject. These actions might include a biopsy of the prostate now or in the future, treatment (if prostate cancer is detected by biopsy) now or in the future, additional PSA or other biomarker testing now or in the future, and additional MRI or other imaging now or in the future.

Referring to the box 3812 (Population Outcomes), outcomes that correspond to pre-diagnosis PSA tests and MRI images, such as death from prostate cancer or other causes, metastasis, recurrence, probability a biopsy detects cancer and others, may be collected for the many men in the population and may be entered into the computer system for analysis.

Referring to the box 3813 (Outcome Distributions), the computer system may aggregate outcome variables for the many men in the population into distributions of population variables that correspond to distributions of pre-diagnosis PSA tests and MRI images. Generally, creating distributions outcomes related to distributions of PSA trends and MRI analysis variables requires substantial computing power. For example, for VA data, we start with 33 million PSA tests for 14 million men. Over a billion calculations may be needed to create these outcome distributions.

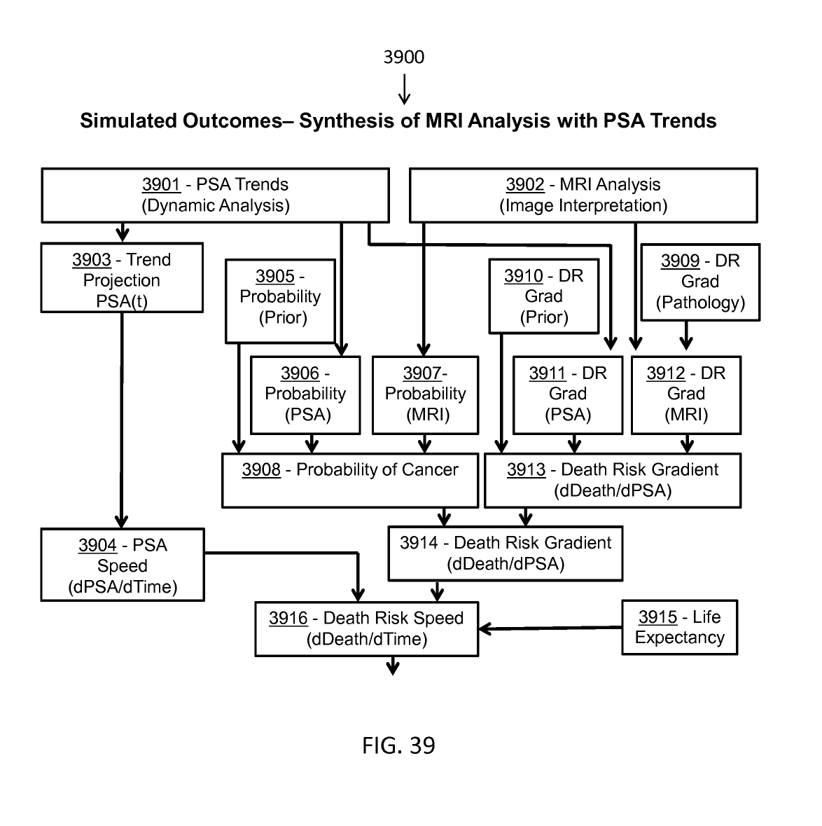

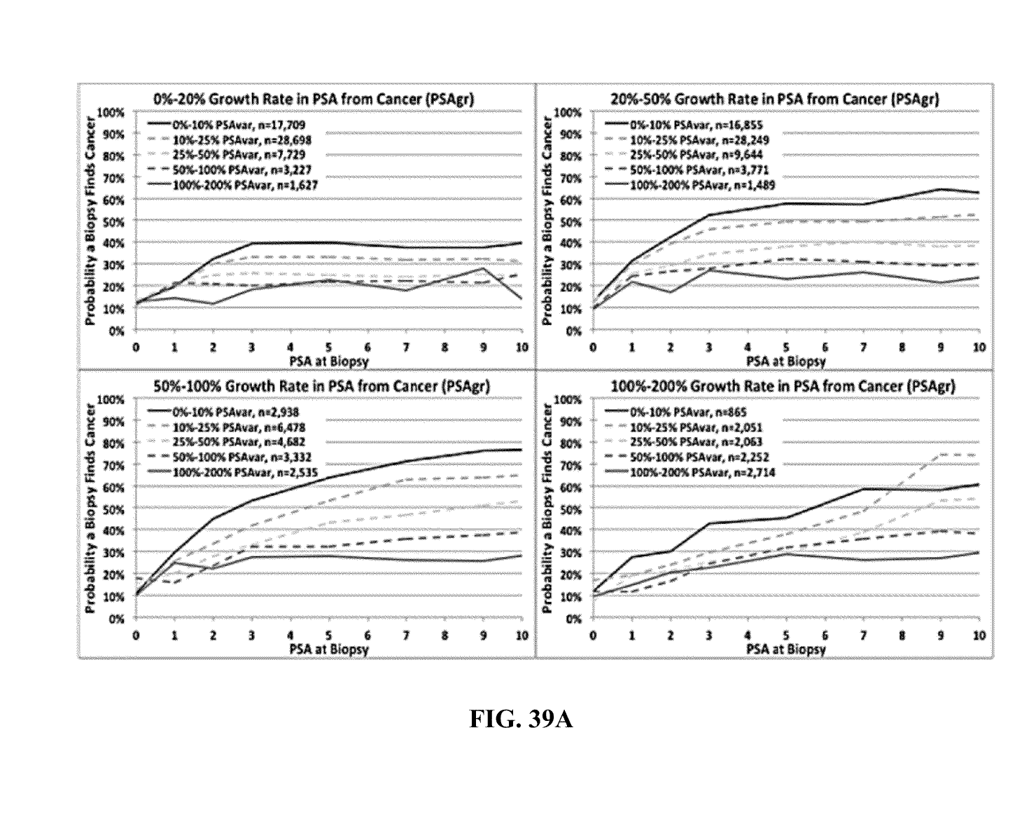

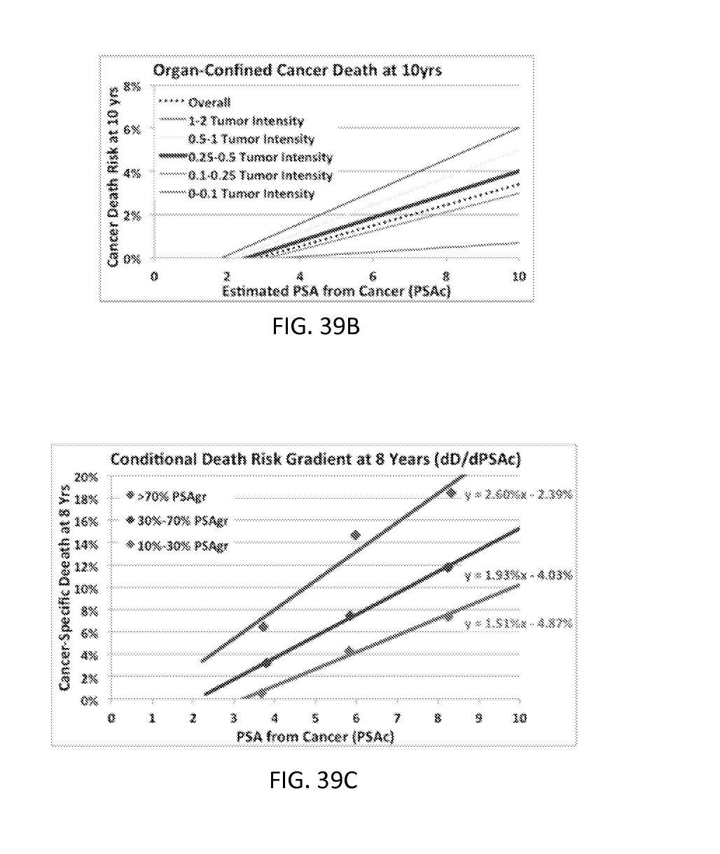

Referring to the box 3814 (Simulated Outcomes), for each screening action considered, the computer system may simulate outcomes for the man based on personal information about the man (age, race, health, life expectancy, etc.) and his pre-diagnosis PSA tests and MRI images compared to the distributions of population variables with the corresponding distributions of outcomes. The simulation of outcomes is further described below with reference to computer-implemented process 3900 as shown in FIG. 39.

Referring to the box 3815 (Personal Preferences), personal preferences of the man, such as his tradeoff between the risk of cancer death and the risks treatment side effects, can be collected for the man and entered into the computer system for analysis.

Referring to the box 3816 (Cost-Benefit Analysis), for each screening action considered and the subject's personal preferences, the computer system may calculate and compare the costs and benefits based on the simulated outcomes for each action. A primary cost may be the Cancer Tempo (CT) Death Risk Speed (DRS) defined by dDeath/dTime, that is, cost of continued active screening is the rate of increase in the risk of prostate cancer death at a given life expectancy or time after diagnosis or treatment. Cost-benefit analysis is described further above with reference to FIGS. 21, 22A, and 22B.

A subject's personal risk preferences (or risk trade-offs) may allow him to compare benefits and costs. For example, the subject may consider the risk of death ten times worse than the risk of side effects from treatment. Personal risk preferences are described further above with reference to FIG. 4.

The benefits of continued active screening may include delay of biopsy, treatment and potential side effects, and possible avoidance if the cancer signals weaken over time and/or his health deteriorates reducing his concern about prostate cancer.

The benefits of continued screening may be compared to the costs of increasing death risk using the man's risk preferences as described above with reference to FIG. 19. The computer system may produce one or more personal reports based on the results of the cost-benefit analysis as described herein.

FIG. 39 shows a computer-implemented process 3900 of simulating outcomes for the subject given an action taken.

Referring to the box 3901, PSA trends may be dynamically analyzed such as by estimating consistent PSA trends by iteratively estimating exponential plus constant function to included data and then excluding the past test whose positive percentage deviation exceeds the tolerance region by the greatest amount. In another example, PSA trend variables, including PSAc, PSAgr, PSAn, and PSAvar may be estimated. Further dynamic analyses are described above, for example, with reference to FIGS. 12A, 12B, 12F, 12G, 12H, and 12K.

Referring to the box 3902, MRI images may be interpreted for evidence of prostate cancer and MRI image variables may be estimated. Such variables may include image strength/aggressiveness, tumor volume, and tumor location (organ-confined or extra-capsular). Further MRI image analysis is described above, for example, with reference to FIGS. 13 and 14.

Referring to the box 3903, the PSA trend from the box 3901 may be projected into the future using, for example, the functional form: PSA(t)=PSAn+PSAc(0)*EXP(PSAgr*t). The projection of trends is described further above, for example, with reference to FIGS. 12J and 17.

Referring to the box 3904, the rate of PSA increase and the projected increase in one year may be calculated as dPSA/dTime of the exponential plus constant function (=PSAgr*PSAc). This rate may be determined from the PSA trend projection from the box 3904. PSA speed (dPSA/dT) calculations are further described above, for example, with reference to FIG. 17.

Referring to the box 3905, any information that might help establish a prior probability that prostate cancer would be discovered by a biopsy, including personal information and history, digital rectal exam (DRE) results, and prostate volume, may be considered to generate a prior probability. The prior probability based on these and other factors might be obtained using a Risk Calculator, such as the PCPR Risk Calculator. The generation of a prior probability is further described above, for example, with reference to FIGS. 4 and 5.

Referring to the box 3906, PSA trend analysis may be used to estimate the probability that prostate cancer would be discovered by a biopsy, either directly or updating the prior probability, such as by using Bayesian analysis. The PSA trend used may be from the dynamic analysis of PSA trends from the box 3901. The use of PSA trend analysis is described further above, for example, with reference to FIGS. 4 and 5.

Recent big data research on VA data shows that PSAvar and PSAgr can be powerful predictors of the probability that prostate cancer will be discovered by a biopsy. Over 200,000 VA men biopsied for prostate cancer with at least 4 PSA tests over at least 3 years were analyzed. The probability a biopsy finds cancer may increase with decreasing PSA variability around a consistent trend (smooth). The results may vary with growth rates in PSA from cancer with the lowest probabilities for the lowest growth rates. (Chi-squared p<0.001 for PSAvar as a predictor.) The results shown on the graphs in FIG. 39A can be used to estimate a man's probability of cancer found by biopsy based on his PSA trend variables.

Referring to the box 3907, analyzed MRI images, such as from the box 3902, may be used to estimate probability that prostate cancer would be discovered by a biopsy, either directly or updating the prior probability, such as by using Bayesian analysis. Image strength/aggressiveness, tumor volume, and location (organ confined or extra-capsular) may be determinants of the probability. The probability that a biopsy will find cancer may be calculated based on analysis of MRI images. The analysis of prostate MRI images is described further above, for example, with reference to FIGS. 4, 5, 13, and 14.

Referring to the box 3908, the probability that prostate cancer would be discovered by a biopsy may be estimated using one or more of PSA trends, analysis of MRI images, and prior information from other sources, such as from the boxes 3901, 3905, 3906, and 3907 described above. The strongest evidence can be used as the starting point to make adjustments by the other sources of evidence using Bayesian or other methods. For example, using Bayesian methods:

P(Ca|PSA)=P(PSA|Ca)*P(Ca)/P(PSA)

P(Ca|MRI)=P(MRI|Ca)*P(Ca|PSA)/P(MRI)

### Where,

Ca=Cancer diagnosed by biopsy.

PSA=PSA trend evidence, for example: PSAc, PSAgr, PSAn, PSAvar.

MRI=MRI evidence, for example: signal strength, volume, location.

P(Ca|PSA)=Probability of cancer conditional on PSA evidence.

P(PSA|Ca)=Probability of PSA evidence conditional on cancer.

P(Ca)=Probability of cancer from prior information.

P(PSA)=Probability of PSA evidence.

P(Ca|MRI)=Probability of cancer conditional on MRI evidence.

P(MRI|Ca)=Probability of MRI evidence conditional on cancer.

P(MRI)=Probability of MRI evidence.

The generation of such probabilities is discussed further above, for example, with reference to FIGS. 4 and 5.

Referring to the box 3909, a conditional death risk gradient (CDRG) based on pathology may be a generated. Conditional simply means results conditional on discovery of cancer by biopsy. MRI imaging of prostate cancer has become useful recently. A four-step process may be used to estimate the prostate cancer death risk implications of analysis of MRI imaging. One, MRI images may be analyzed to obtain summary variables. Such analysis is described further above. Two, surgery pathology may be analyzed to predict prostate cancer death risk. Such analysis is described further below. Three, MRI summary variables may be analyzed to predict surgery pathology. Four, MRI summary variables may be analyzed to predict prostate cancer death risk.

Referring back to the second step above, analysis of MRI images may help determine the location of prostate cancer tumors, including whether they are extra-capsular or organ-confined. Analysis of Conditional Death Risk Gradient (CDRG) from surgery pathology is often an intermediate step because long-term outcome data is not available for the recent use of new MRI imaging techniques.

Over 7,000 men who underwent surgical removal of their prostate (RP) at the Mayo Clinic over the last 25 years were analyzed using variables for deadly, metastatic and diagnosed cancers; PSA at diagnosis; and tumor volume.

Graphs of the distribution of deadly, metastatic and diagnosed organ-confined cancers versus PSA at diagnosis and tumor volume and location (organ-confined or extra-capsular) may be considered and analyzed by the computer system. Analysis of long-term outcomes may show that organ-confined cancers are much less deadly than extra-capsular cancers and increase in deadliness less steeply with increasing PSA. Analysis may also show that the level and steepness of deadliness with increasing PSA is increases for larger tumor volumes, as shown in FIG. 39B.

Referring to the box 3910, a conditional death risk gradient (CDRG) based on prior probabilities may be generated. PSA levels, not just PSA trends, may be provide prior probabilities about the relationship between the risk of death from prostate cancer and the PSA level at diagnosis.

Referring to the box 3911, a conditional death risk gradient (CDRG) based on PSA trends such as from the box 3901 may be generated. The relationship between the risk of prostate cancer death and PSA trends is disclosed elsewhere herein. Generally, the risk of prostate cancer death increases with increasing PSA from cancer (PSAc) and growth rate (PSAgr).

Recent studies have supported such conclusions. Over 50,000 VA men who were diagnosed with prostate cancer with at least 4 PSA tests over at least 3 years were analyzed. PSAc and PSAgr were highly significant (Log rank p<0.001) predictors of all-cause death using standard Kaplan-Meier analysis and using a Cox proportional hazards model with age as an additional variable. Cancer-specific death curves were developed using net survival methods and an estimate of no-cancer death. Results were summarized to obtain estimates of the Conditional Death Risk Gradient (CDRG), as shown on the graph in FIG. 39C. The slope of the three cancer death risk lines versus PSAc are the CDRG for three different ranges of PSAgr.

The relationship between the risk of prostate cancer death and PSA trends as well as the generation of a conditional death risk gradient are further disclosed above, for example, with reference to FIGS. 7A, 7B, 10A, 10B, 10C, 20A, and 20B.

Referring to the box 3913, a combined conditional death risk gradient (CDRG) may be generated based on one or more of the above conditional death risk gradients, such as from the boxes 3910, 3911, and 3912. Often, conditional refers to results conditional on discovery of cancer by biopsy. The probability of increasing death risk with increasing PSA (expressed in terms of dDeath/dPSA) can be estimated using one or more of PSA trends, analysis of MRI images, and prior information from other sources. The strongest evidence can be used as the starting point to make adjustments by the other sources of evidence using Bayesian or other methods. For example, using Bayesian methods:

P(DI|PSA)=P(PSA|DI)*P(DI)/P(PSA)

P(DI|MRI)=P(MRI|DI)*P(DI|PSA)/P(MRI)

### Where,

DI=Rate of death risk increase vs increasing PSA (ΔDeath/ΔPSA).

PSA=PSA trend evidence, for example: PSAc, PSAgr, PSAn, PSAvar.

MRI=MRI evidence, for example: signal strength, volume, location.

P(DI|PSA)=Probability of death risk increase conditional on PSA evidence.

P(PSA|DI)=Probability of PSA evidence conditional on death risk increase.

P(DI)=Probability of death risk increase from prior information.

P(PSA)=Probability of PSA evidence.

P(DI|MRI)=Probability of death risk increase conditional on MRI evidence.

P(MRI|DI)=Probability of MRI evidence conditional on death risk increase.

P(MRI)=Probability of MRI evidence.

Referring to the box 3914, a probability weighted death risk gradient (DRG), dDeath/dPSA may be generated, for example, based on the probability of cancer from the box 3908 and the death risk gradient from the box 3913. The weighted probability of increasing death risk with increasing PSA (expressed in terms of dDeath/dPSA) can be calculated by multiplying the probability a biopsy will find cancer, P(Ca|MRI), time the probability of increasing death risk, CDRG.

DRG=Prob(Ca)*CDRG

Referring to the box 3915, life expectancy may be estimated. Life expectancy may be estimated for the subject under consideration and may be used to select the time after diagnosis and treatment for that defines the specific Death Risk Gradient (DRG) used to calculate Cancer Tempo (CT) or Death Risk Speed (DRS) at life expectancy.

Referring to the box 3916, the CT/DRS (dDeath/dTime) may be generated. The cost of continued active screening may be the rate of increase in the risk of prostate cancer death. It may be calculated by multiplying (dPSA/dtime) from the box 3905 and DRG from the box 3914.

Cost=CT/DRS=PSAS*DRG

where PSA Speed (PSAS)=dPSA/dT for the PSA trend.

The calculation of Cancer Tempo (CT) or death risk speed (DRS) is described further above, for example, with references to FIGS. 21, 22A, and 22B.

Although the above steps show the computer-implemented processes 3800 and 3900 of synthesizing MRI analysis with PSA trends and simulating outcomes, respectively, a person of ordinary skill in the art will recognize many variations based on the teaching described herein. The steps of the processes may be completed in a different order. Steps may be added or deleted. Some of the steps may comprise sub-steps. Many of the steps may be repeated as often as desired.

While preferred embodiments of the present disclosure have been shown and described herein, it will be obvious to those skilled in the art that such embodiments are provided by way of example only. Numerous variations, changes, and substitutions will now occur to those skilled in the art without departing from the teachings of the disclosure. It should be understood that various alternatives to the embodiments described herein may be employed in practicing the teachings of the disclosure. It is intended that the following claims define the scope of the invention and that methods and structures within the scope of these claims and their equivalents be covered thereby.

What is claimed is:

1. A computer-implemented method of treating potential cancer in a patient, the method comprising:
calculating, with a computer system, a risk for a cancer for the patient in response to patient information;
determining, with the computer system, a cost of performing one or more medical actions in response to the calculated risk;
determining, with the computer system, a benefit of performing the one or more medical actions;
comparing, with the computer system, the determined cost and the determined benefit;
recommending, with the computer system, the one or more medical actions or a wait period in response to the comparison.

2. The method of claim 1, wherein the cancer comprises prostate cancer.

3. The method of claim 1, wherein calculating the risk for the cancer comprises:
obtaining, with the computer system, a series of test result values for the patient in response to a plurality of first tests; and
calculating, with the computer system, one or more fitted test result trends in response to the obtained series,
wherein one or more of the cost or benefit of performing the one or more medical actions is determined in response to the calculated fitted test result trend.

4. The method of claim 3, wherein the step of calculating one or more fitted test result trends from the obtained series comprises calculating, with the computer system, a first fitted result trend in response to the obtained series, removing, with the computer system, one or more test result values from the series of test result values to form a second series of test result values, and calculating, with the computer system, a second fitted result trend in response to the second series.

5. The method of claim 4, wherein the at least one test value is selected in response to a variance from the first fitted result of the one or more test result values.

6. The method of claim 4, wherein the removed one or more test results values is selected in response to results of one or more second tests different in type from the plurality of first tests.

7. The method of claim 3, wherein the plurality of first test results are selected from one or more of a biomarker test, a PSA test, an fPSA test, a pPSA test, a proPSA test, a tPSA test, a PAA test, a PSAV test, an EPCA test, an EPCA-2 test, an AMACR test, a methylated GSTP1 test, an imaging test or scan, an MRI scan, a CAT scan, an infrared image, an ultrasound image, a molecular image, a genetic test, a cell count, a protein test, a nucleic acid test, a prostate size measurement, a prostate volume measurement, a digital prostate exam, a biopsy, a tumor variable measurement, or a tumor volume measurement.

8. The method of claim 3, wherein determining the cost of performing the one or more medical actions in response to the calculated risk comprises determining, with the computer system, a present cost of presently performing the one or more medical actions, and wherein determining the benefit of performing the one or more medical actions in response to the calculated risk comprises determining a present benefit of presently performing the one or more medical actions.

9. The method of claim 8, further comprising:
projecting, with the computer system, the fitted test value trend through the wait period; and
calculating, with the computer system, a characteristic of the projected trend,
wherein determining the cost of performing the one or more medical actions in response to the calculated risk further comprises:
(i) determining, with the computer system, a future cost of performing the one or more medical actions in response to the calculated characteristic, and
(ii) comparing, with the computer system, the present cost with the future cost, and
wherein determining the benefit of performing the one or more medical actions in response to the calculated risk further comprises:
(i) determining, with the computer system, a future benefit of performing the one or more medical actions in response to the calculated characteristic, and
(ii) comparing, with the computer system, the present benefit with the future benefit.

10. The method of claim 9, wherein recommending the one or more medical actions or the wait period in response to the comparison comprises one or more of:
recommending, with the computer system, the one or more medical actions if the present cost is less than the future cost in comparison, or
recommending, with the computer system, the one or more medical actions if the present benefit is more than the future benefit in comparison.

11. The method of claim 9, wherein recommending the one or more medical actions or the wait period in response to the comparison comprises one or more of:
recommending, with the computer system, the wait period if the present cost is more than the future cost in comparison, or
recommending, with the computer system, the wait period if the present benefit is less than the future benefit in comparison.

12. The method of claim 1, wherein the wait period is selected from the group consisting of: 1 month, 2 months, 3 months, 6 months, 9 months, 12 months, 18 months and 24 months.

13. The method of claim 1, wherein the one or more medical actions comprise one or more of a prostate size measurement, a prostate volume measurement, digital prostate exam, biopsy, focal treatment, surgery, radiation therapy, hormone therapy, or chemotherapy.

14. The method of claim 1, wherein the recommended one or more medical actions are subsequently performed to treat the patient.

15. The method of claim 1, wherein the cost of performing one or more medical actions comprises one or more of decreased life expectancy, decreased financial outcome, increased death risk, increased cancer or cancer treatment side effects, metastasis of cancer, recurrence of cancer, lost time, or side effects of the one or more medical actions.

16. The method of claim 1, wherein the benefit of performing one or more medical actions comprises one or more of increased life expectancy, increased financial outcome, decreased death risk, decreased cancer or cancer treatment side effects, non-metastasis of cancer, non-recurrence of cancer, gained time, or lack of side effects from the one or more medical actions.

17. The method of claim 1, wherein comparing the determined cost and determined benefit comprises adjusting for a rate of progression of the cancer.

18. The method of claim 1, wherein one or more of calculating the risk for cancer, determining the cost of performing the one or more medical actions, determining the benefit of performing the one or more medical actions, comparing the determined cost and the determined benefit, or recommending the one or more medical actions or the wait period is performed by a processor of the computer system.

19. The method of claim 1, wherein recommending the one or more medical actions comprises providing the recommendation in an electronic format.

20. The method of claim 19, further comprising displaying the recommendation in the electronic format.

21. The method of claim 1, further comprising performing on a patient a series of tests useful for evaluating a risk of developing cancer to provide the patient information.

22. A system for performing the method of claim 1.

23. A method of treating potential cancer in a patient, the method comprising:
screening the patient for cancer;
selecting one or more medical actions in response to the screening;
performing the selected one or more medical actions;
obtaining one or more results of the performed one or more medical actions;
analyzing the obtained one or more results in response to one or more of personal information, personal history, or personal preferences of the patient; and
repeating one or more of the above steps in response to the analysis,
wherein the analysis comprises one or more of:
calculating, with a computer system, one or more of life expectancy changes, cancer death risk, cancer side effect risk, or financial outcome changes;
performing, with the computer system, a cost-benefit analysis of performing one or more medical actions; or
recommending, with the computer system, one or more medical actions or a wait period in response to the calculation or the performed cost-benefit analysis.

24. A method of treating potential cancer in a patient, the method comprising:
obtaining, with a computer system, one or more images of the patient;
generating, with the computer system, one or more patient image analysis variables in response to the obtained one or more images;
comparing, with the computer system, the generated one or more patient image analysis variables with one or more population image analysis variables; and
generating, with the computer system, one or more predicted patient outcomes in response to the comparison of the generated one or more patient image analysis variables with the one or more population image analysis variables.

25. The method of claim 24, wherein the one or more images of the patient comprise one or more MRI images of the patient.

26. The method of claim 24, wherein the one or more images of the patient comprises one or more images of a prostate of the patient.

27. The method of claim 26, wherein the one or more patient image analysis variables comprise one or more of tumor strength, tumor aggressiveness, tumor volume, or tumor location.

28. The method of claim 24, wherein the one or more predicted patient outcomes comprises a probability that a biopsy will find cancer or a risk for cancer.

29. The method of claim 24, further comprising:
determining, with the computer system, a cost and a benefit of performing one or more medical actions in response to the one or more predicted patient outcomes;
comparing, with the computer system, the determined cost and the determined benefit; and
recommending, with the computer system, the one or more medical actions or a wait period in response to the comparison of the determined cost and the determined benefit.
